(19) United States
(12) Patent Application Publication
(10) Pub. No.: US 2026/0367771 A1
(43) Pub. Date: Nov. 19, 2026

(54) GESTURES FOR SELECTION REFINEMENT IN A THREE-DIMENSIONAL ENVIRONMENT

(71) Applicant: Apple Inc., Cupertino, CA (US)

(72) Inventors: Daniel J. BREWER, Redwood City, CA (US); Julian K. SHUTZBERG, San Francisco, CA (US); Chase B. LORTIE, San Francisco, CA (US); David J. MEYER, Mercer Island, WA (US)

(21) Appl. No.: 19/753,876

(22) Filed: Jul. 24, 2026

Related U.S. Application Data
(63) Continuation of application No. 18/472,073, filed on Sep. 21, 2023.
(60) Provisional application No. 63/505,422, filed on May 31, 2023.
(60) Provisional application No. 63/376,572, filed on Sep. 21, 2022.

(51) Int. Cl. G06F 3/04842; G06F 3/01; G06F 3/04815; G06F 3/0485; G06F 3/0487

(52) U.S. Cl. CPC G06F 3/04842; G06F 3/017; G06F 3/04815; G06F 3/0485; G06F 3/0487

(57) ABSTRACT

In some embodiments, a computer system facilitates user input for displaying a selection refinement user interface object in an object within a three-dimensional environment, wherein the selection refinement user interface object indicates a location in the object at which the computer system performs a selection operation in response to further user input. In some embodiments, a computer system facilitates user input for activating a selection refinement mode in the three-dimensional environment during which an interaction point for a selection operation is movable based on movement of a hand of the user of the computer system.

### CROSS-REFERENCE TO RELATED APPLICATIONS

This application is a continuation of U.S. Patent Application No. 18/472,073, filed Sep. 21, 2023, published on Mar. 21, 2024 as U.S. Publication No. 2024-0094882, which claims the benefit of U.S. Provisional Application No. 63/505,422, filed May 31, 2023, and U.S. Provisional Application No. 63/376,572, filed Sep. 21, 2022, the contents of which are herein incorporated by reference in their entireties for all purposes.

### TECHNICAL FIELD

This relates generally to computer systems that provide computer-generated experiences, including, but no limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user’s eyes and hand in space relative to the GUI (and/or computer system) or the user’s body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with content in a three-dimensional environment. Such methods and interfaces may complement or replace conventional methods for interacting with content in a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates user input for displaying a selection refinement user interface object in an object within a three-dimensional environment, wherein the selection refinement user interface object indicates a location in the object at which the computer system performs a selection operation in response to further user input. In some embodiments, a computer system facilitates user input for activating a selection refinement mode in the three-dimensional environment during which an interaction point for a selection operation is movable based on movement of a hand of the user of the computer system.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7E illustrate examples of a computer system facilitating user input for displaying a selection refinement user interface object in a three-dimensional environment in accordance with some embodiments.

FIGS. 8A-8J is a flowchart illustrating an exemplary method of displaying a selection refinement user interface object in a three-dimensional environment in accordance with some embodiments.

FIGS. 9A-9E illustrate examples of a computer system facilitating user input for activating a selection refinement mode while displaying a three-dimensional environment in accordance with some embodiments.

FIGS. 10A-10J is a flowchart illustrating a method of activating a selection refinement mode while displaying a three-dimensional environment in accordance with some embodiments.

### DESCRIPTION OF EMBODIMENTS

The present disclosure relates to user interfaces for providing a computer generated (CGR) experience to a user, in accordance with some embodiments.

The systems, methods, and GUIs described herein provide improved ways for an electronic device to facilitate interaction with and manipulate objects in a three-dimensional environment.

In some embodiments, a computer system facilitates user input for displaying a selection refinement user interface object in an object within a three-dimensional environment, wherein the selection refinement user interface object indicates a location in the object at which the computer system performs a selection operation in response to further user input. In some embodiments, while displaying the object in the three-dimensional environment, the computer system detects an air gesture provided by a hand of the user. In some embodiments, if the air gesture satisfies a first set of criteria, the computer system displays the refinement user interface object in the object at a location that is based on attention of the user. In some embodiments, the first set of criteria is satisfied if the air gesture includes a first portion of a selection input, followed by a confirmation gesture, and/or if the air gesture includes a first type of gesture while the hand is in a first pose. In some embodiments, if the air gesture satisfies a second set of criteria, the computer system performs a selection operation at a location that is based on the attention of the user without displaying the refinement user interface object. In some embodiments, the second set of criteria is satisfied if the air gesture includes a first portion of a selection input, followed by a second portion of the selection input, and/or if the air gesture includes a second type of gesture while the hand is in a second pose.

In some embodiments, a computer system facilitates user input for activating a selection refinement mode in a three-dimensional environment during which an interaction point for a selection operation is movable based on movement of a hand of the user of the computer system. In some embodiments, while an object is displayed in the three-dimensional environment, the computer system detects an air gesture provided by the hand of the user. In some embodiments, in response to detecting the air gesture, the computer system activates the selection refinement mode, which includes displaying a refinement user interface object within the object at a location that is based on the attention of the user. In some embodiments, while the refinement user interface object is displayed in the object, the computer system moves the refinement user interface object in response to detecting movement of the hand of the user. In some embodiments, if the computer system detects an activation gesture provided by the hand of the user, the computer system performs a selection operation based on the location of the refinement user interface object in the object.

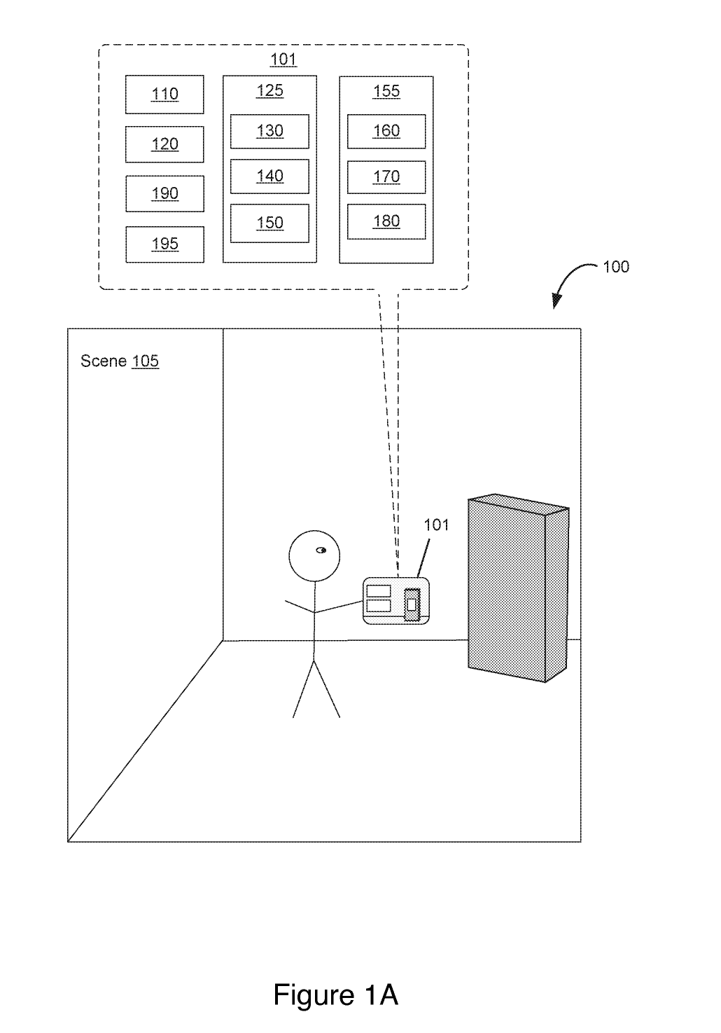

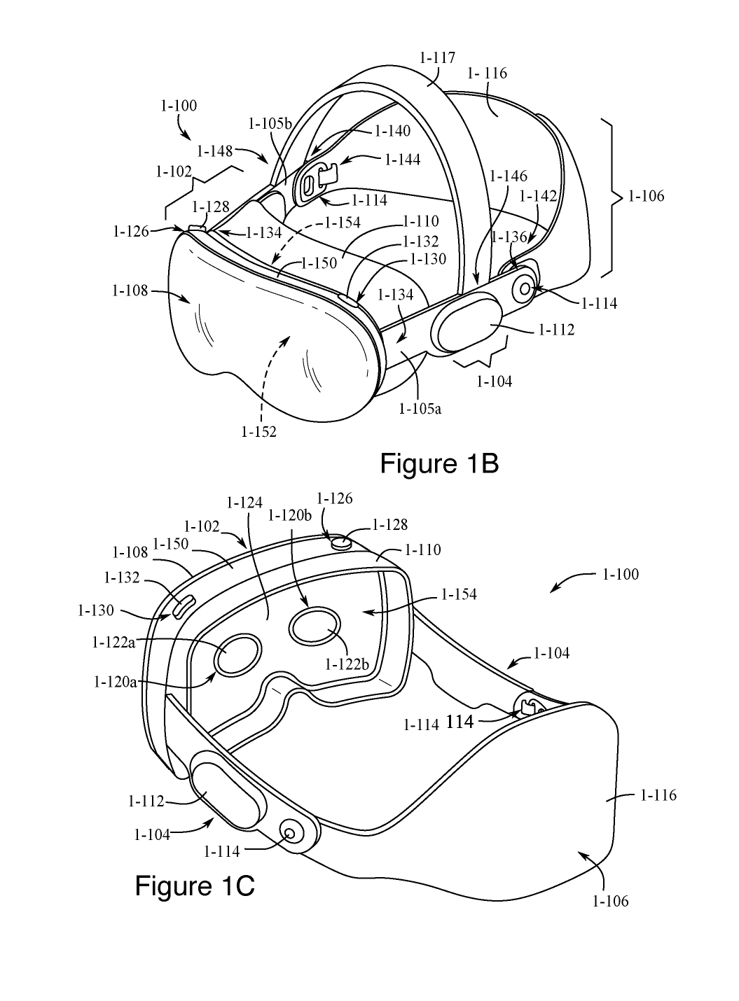

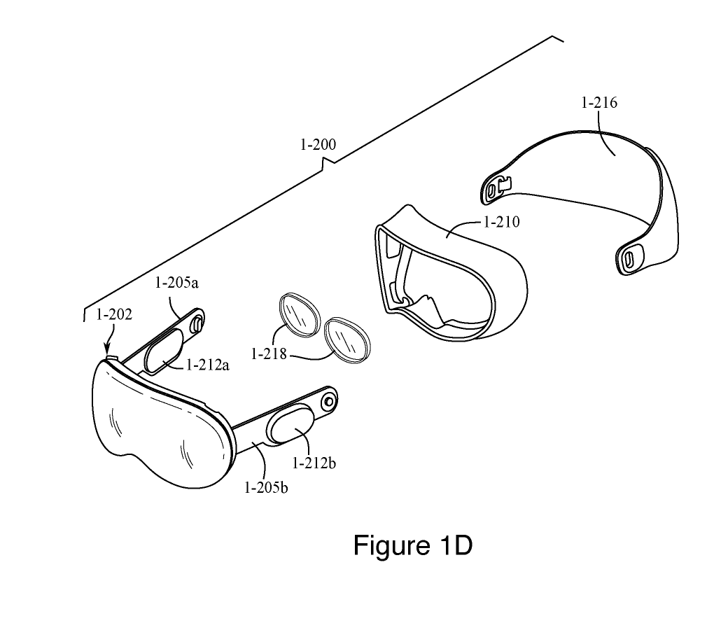

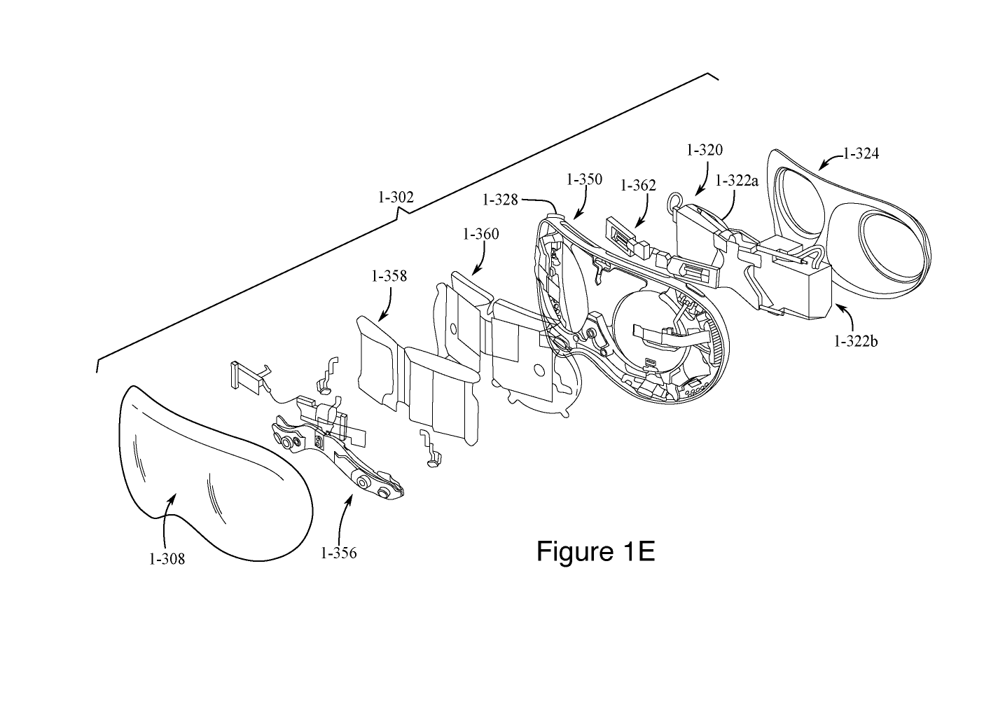

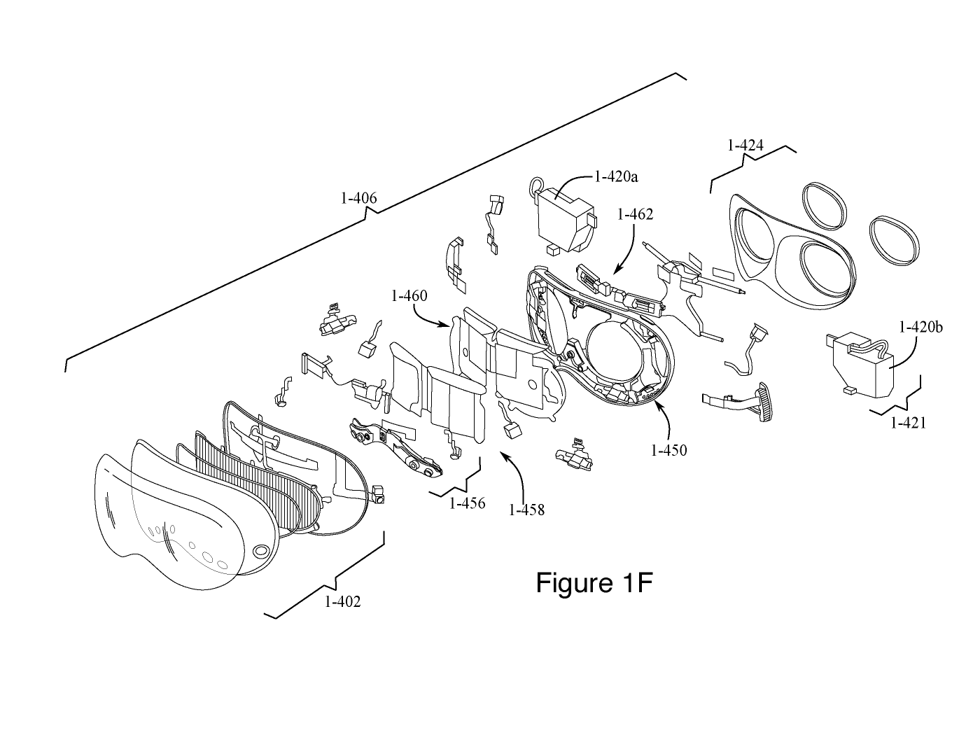

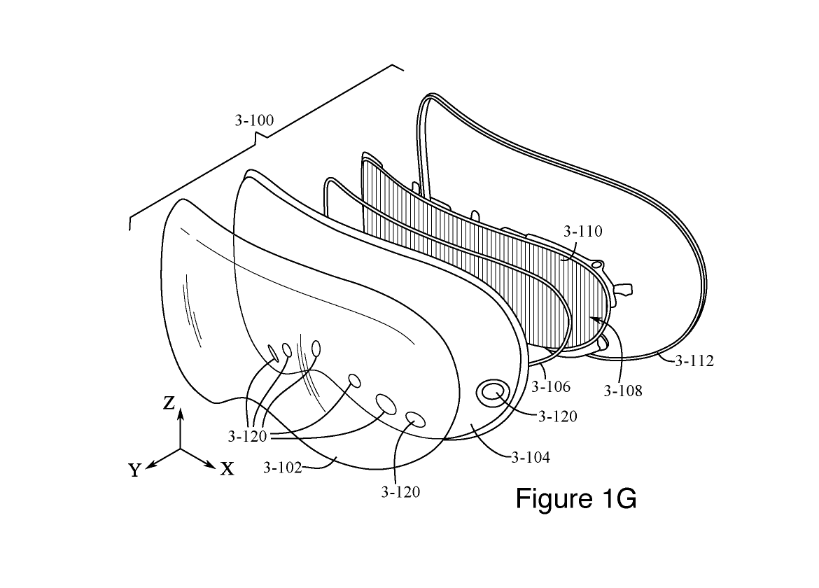

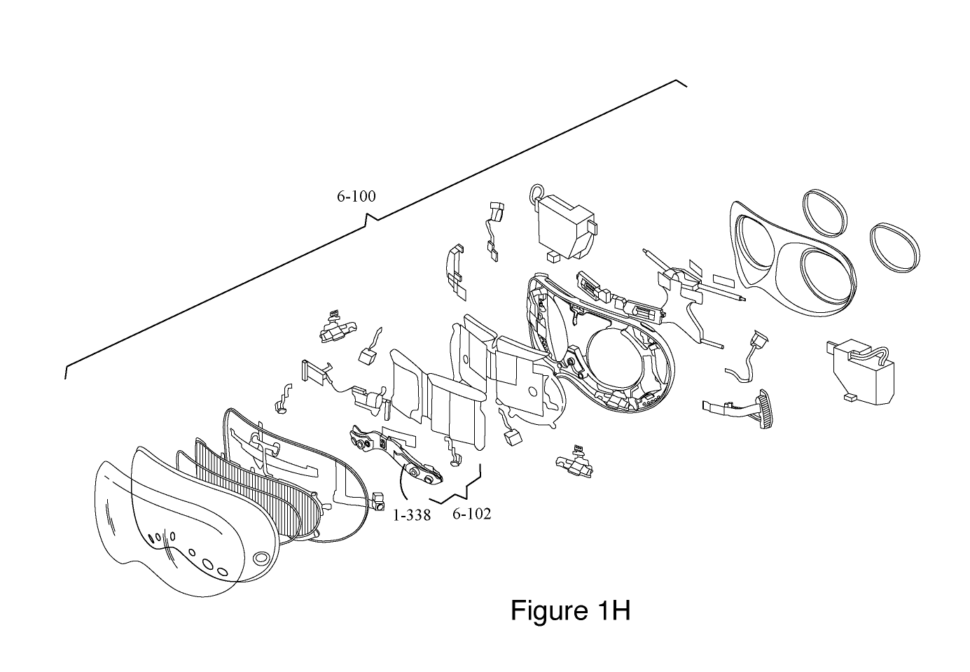

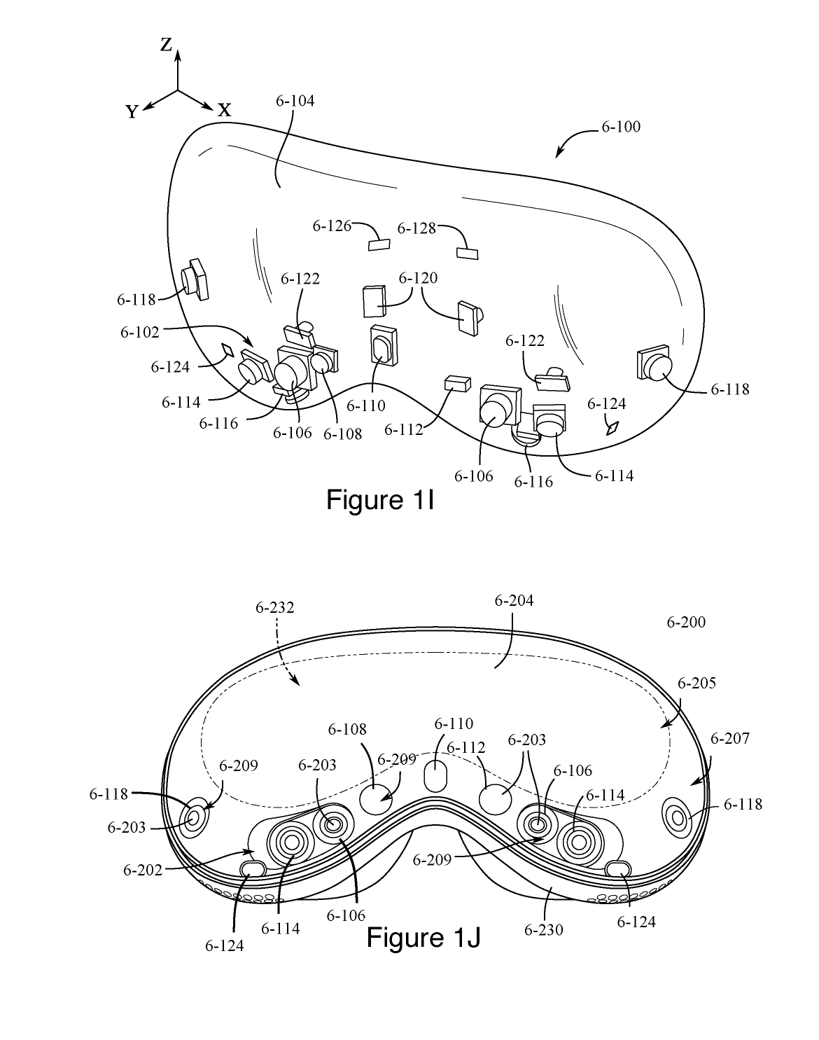

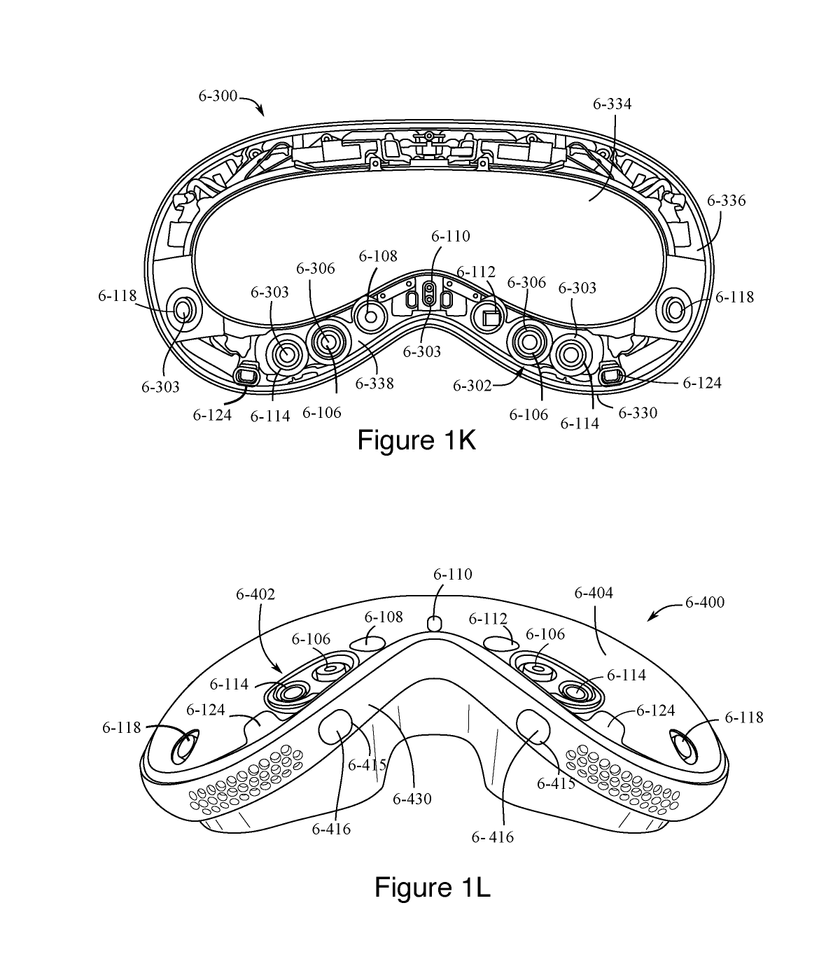

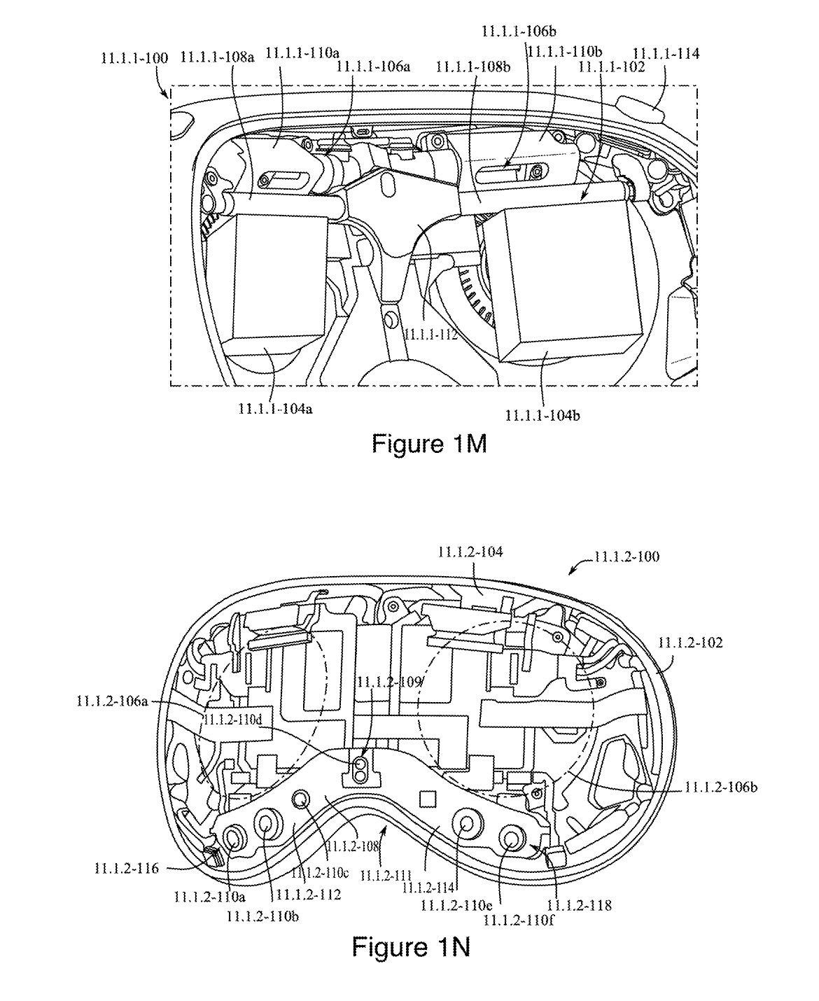

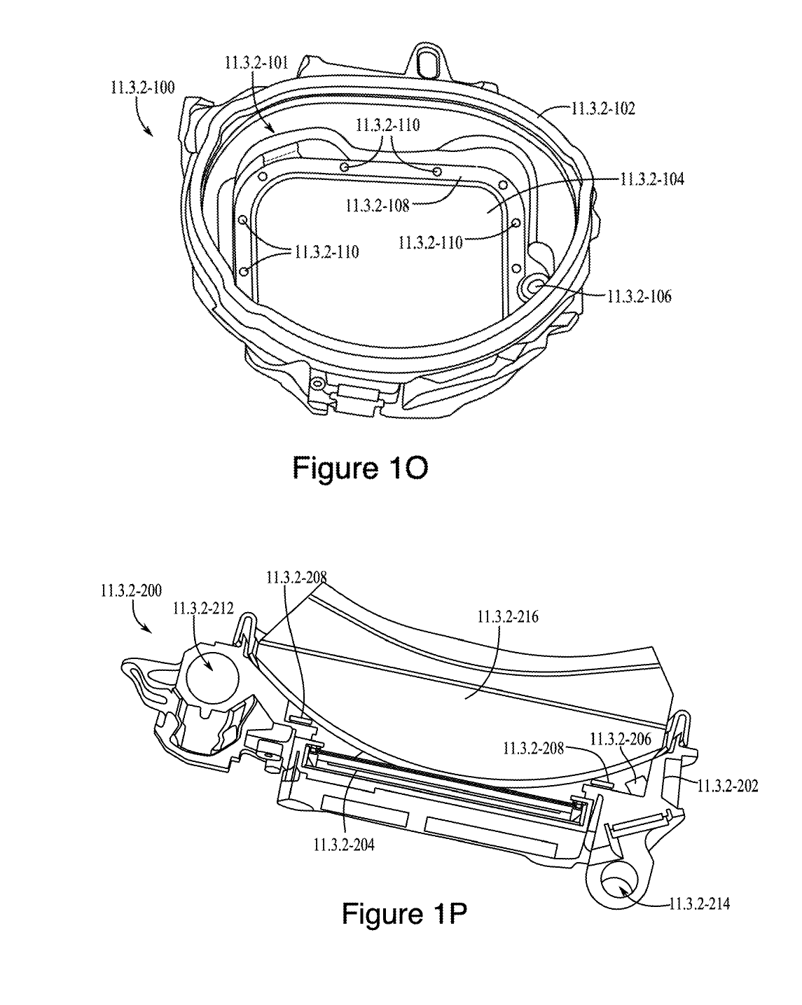

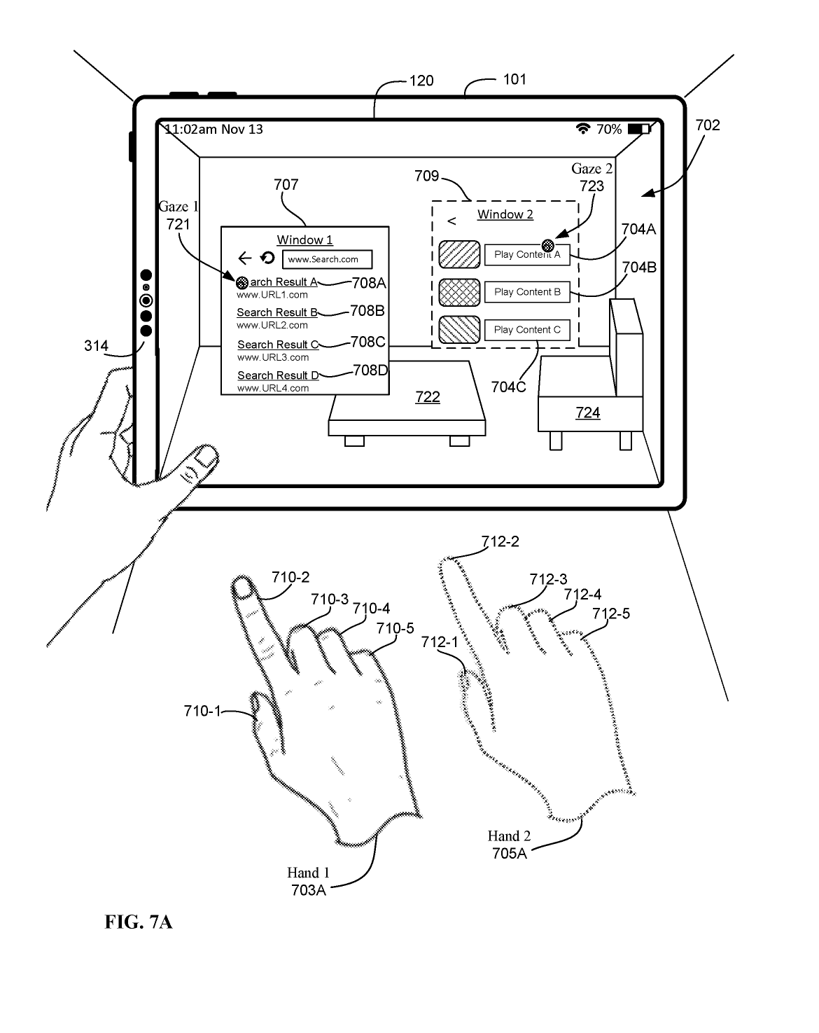

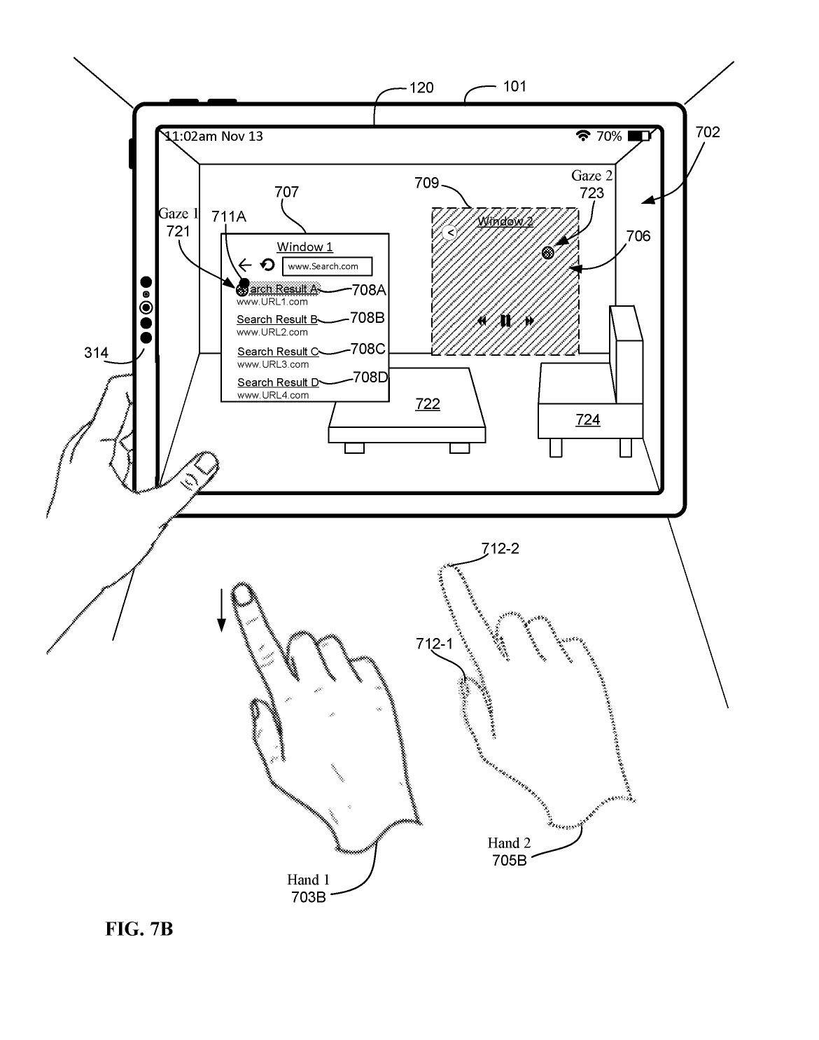

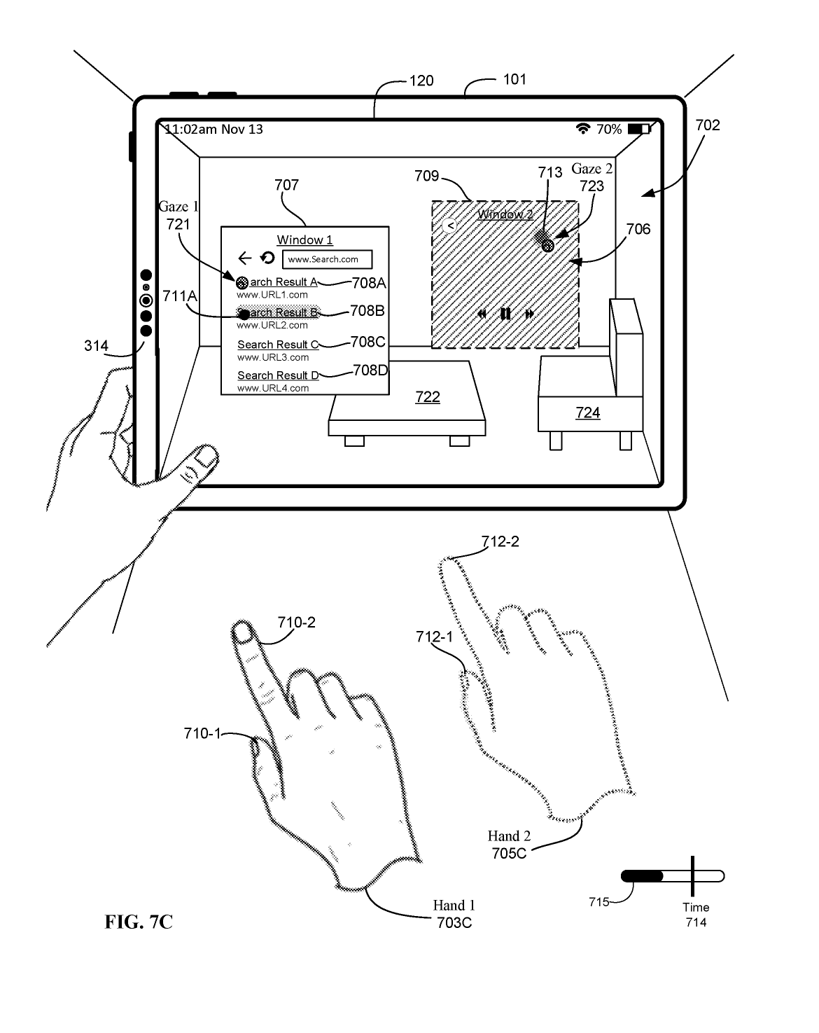

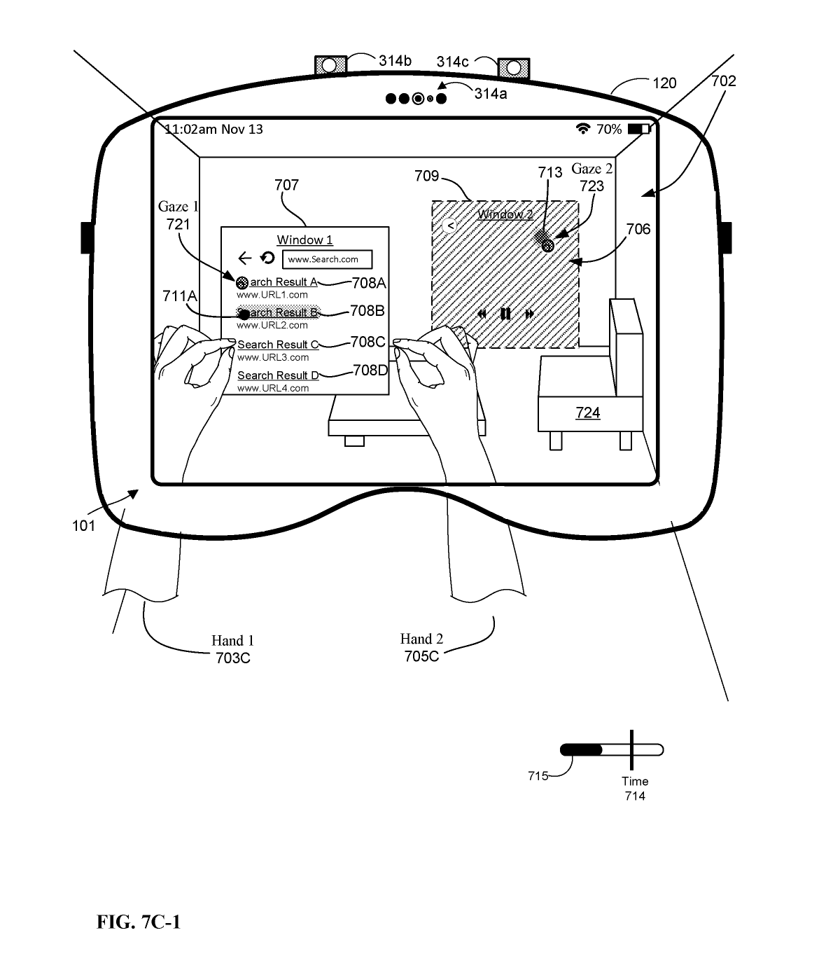

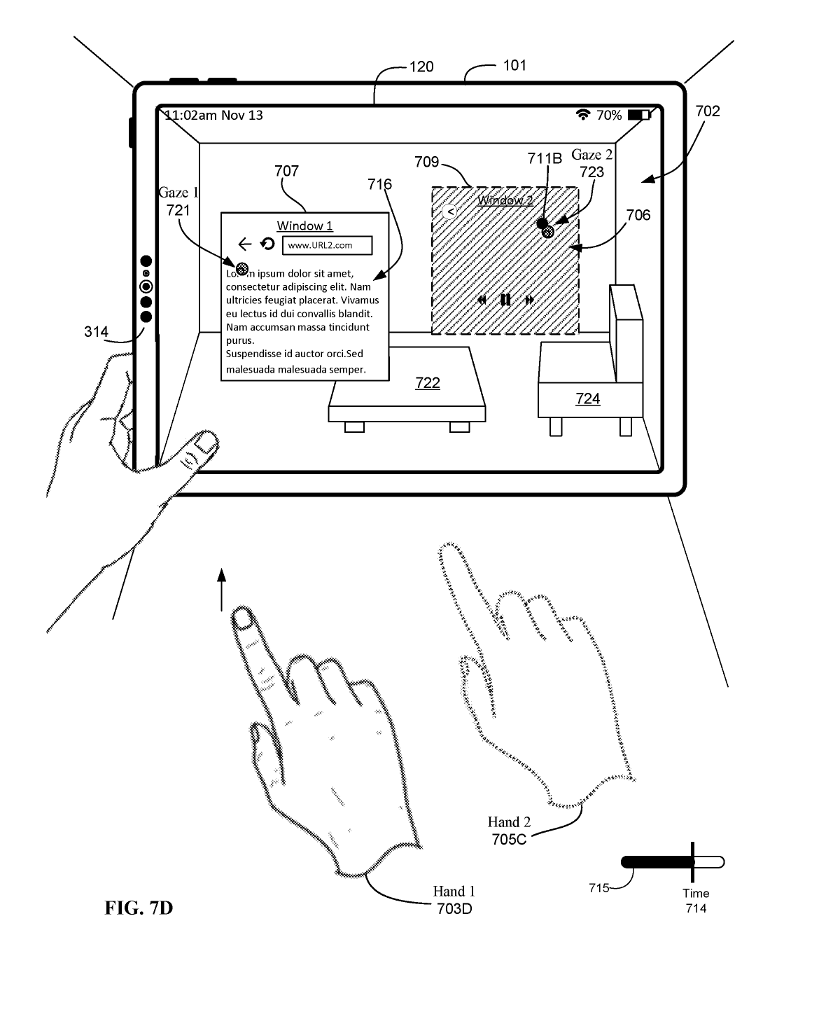

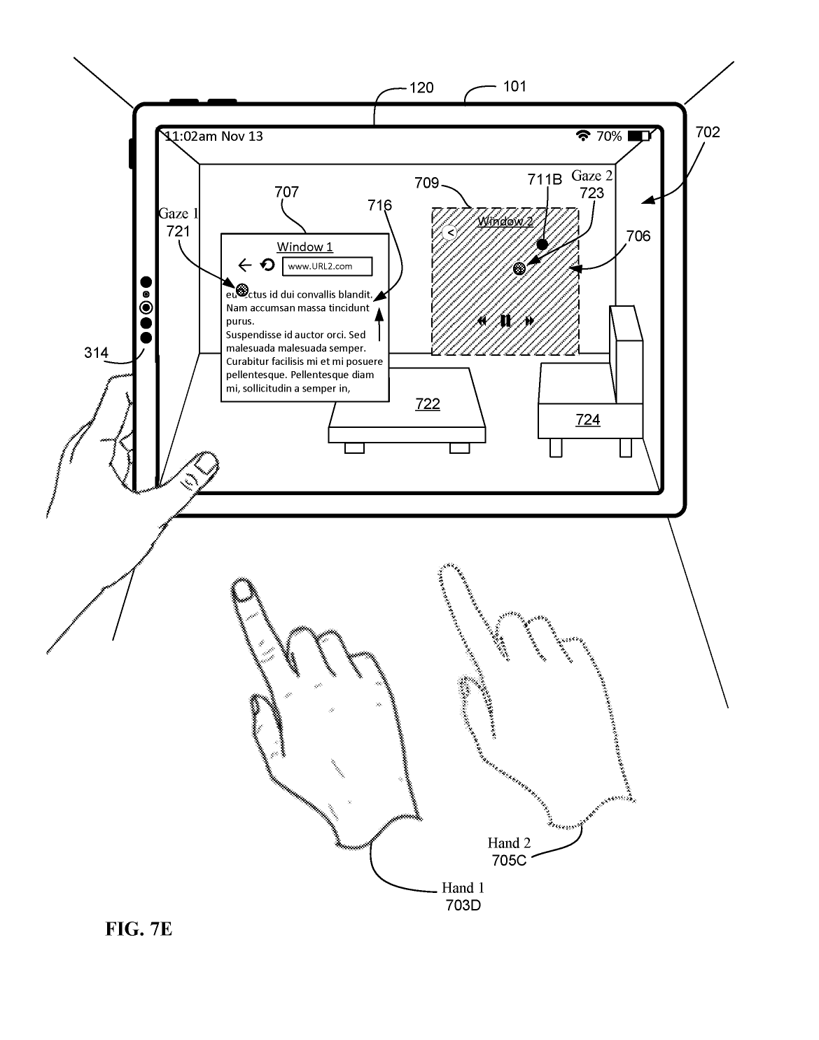

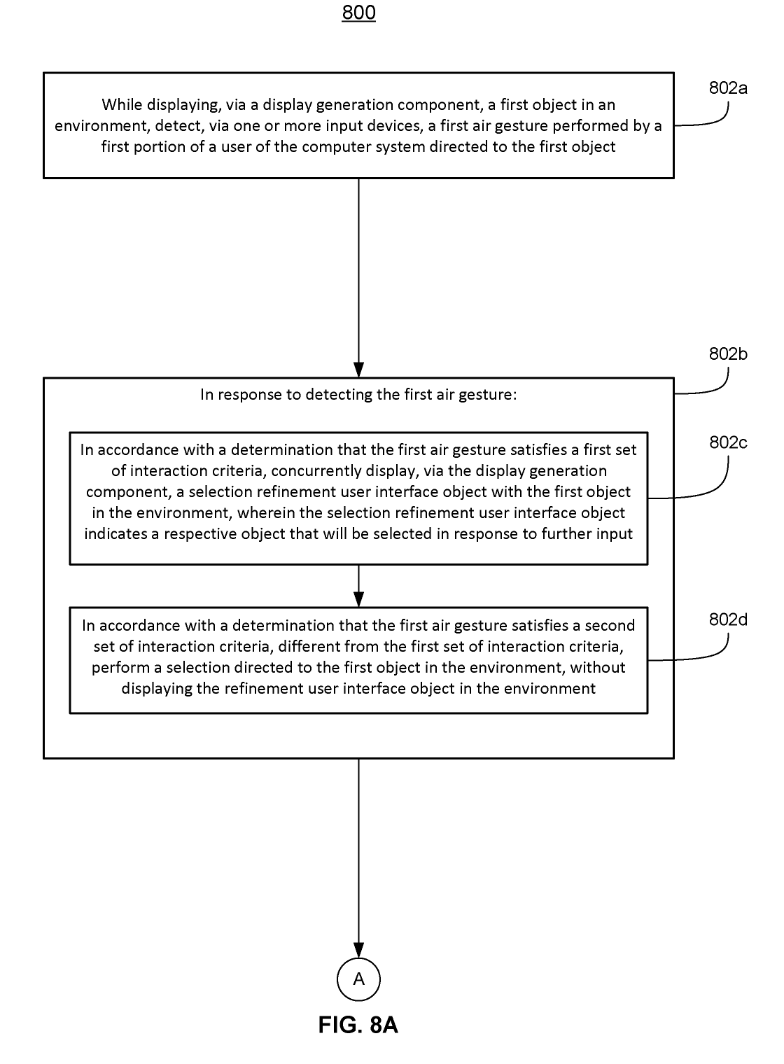

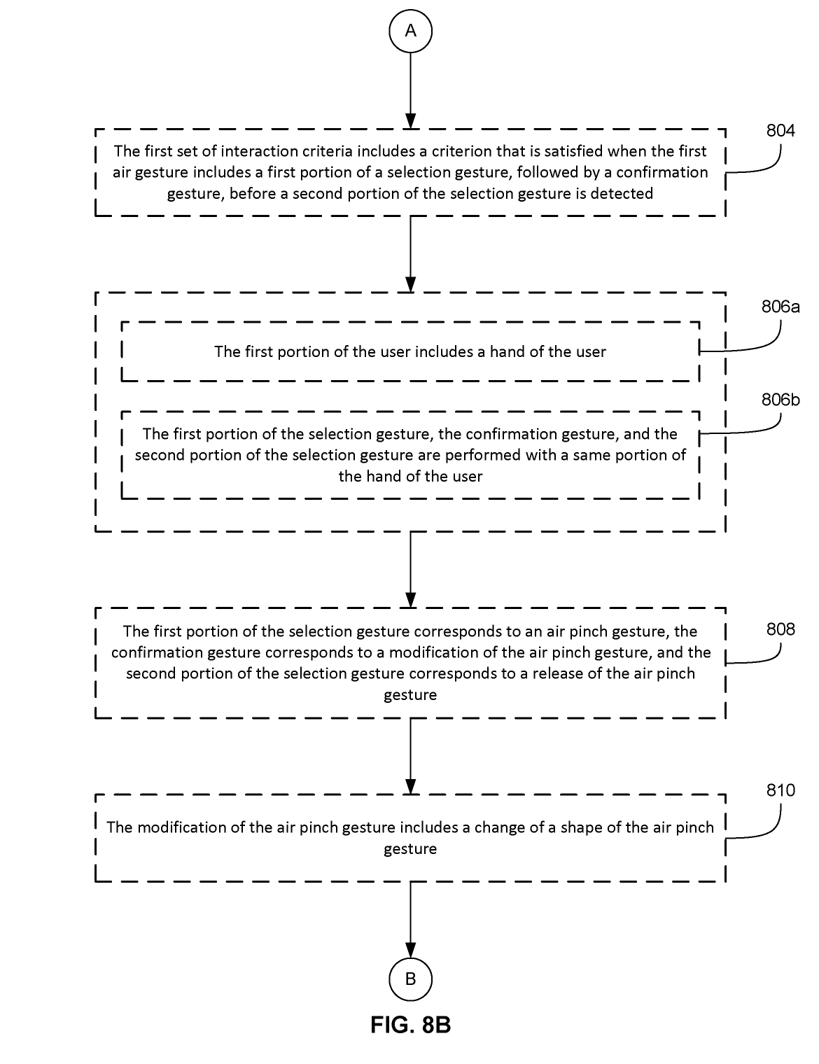

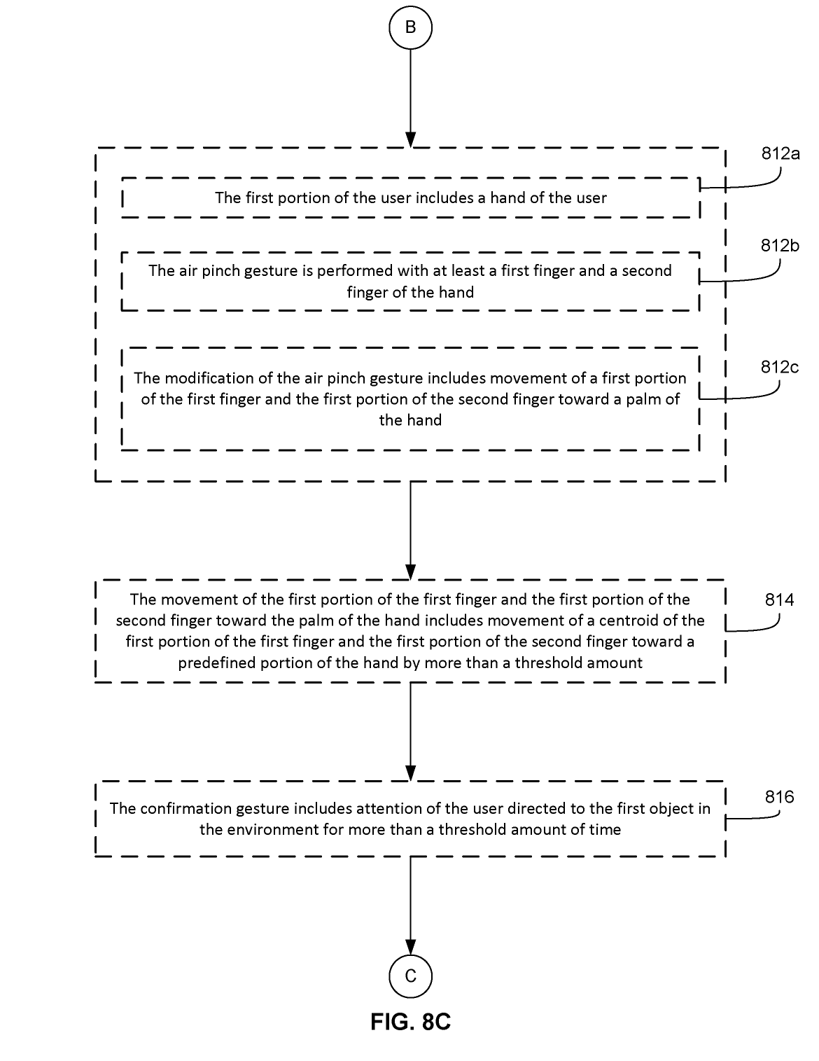

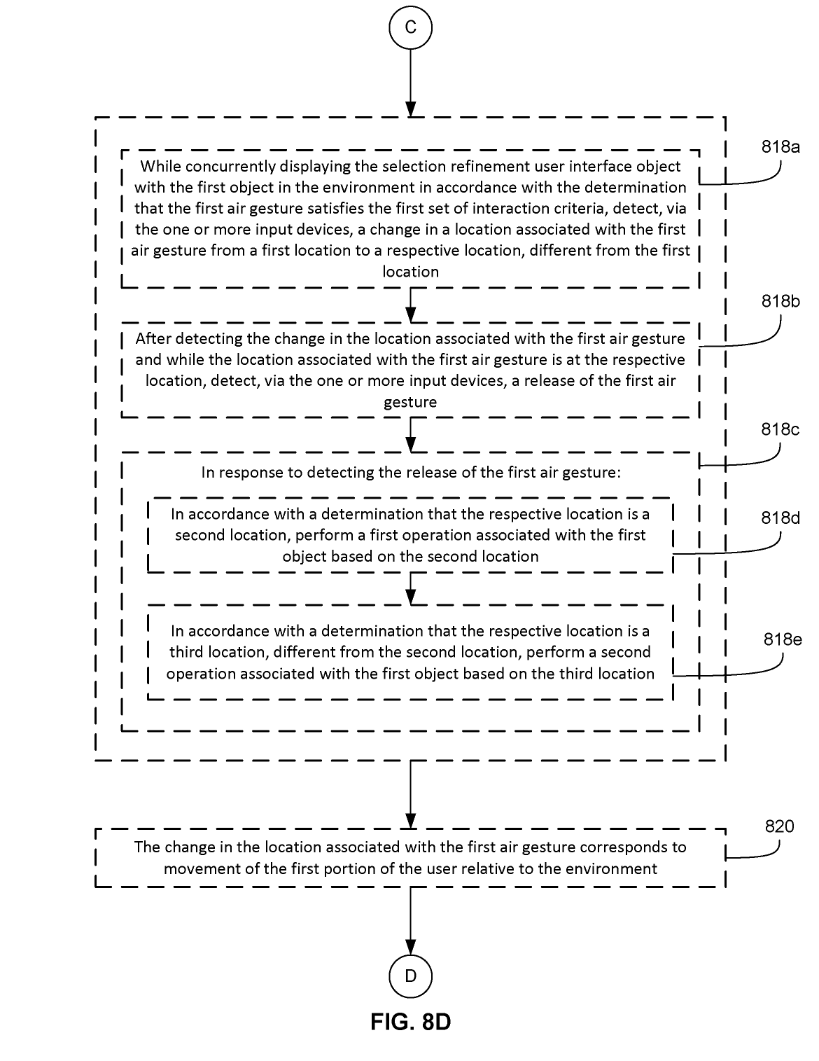

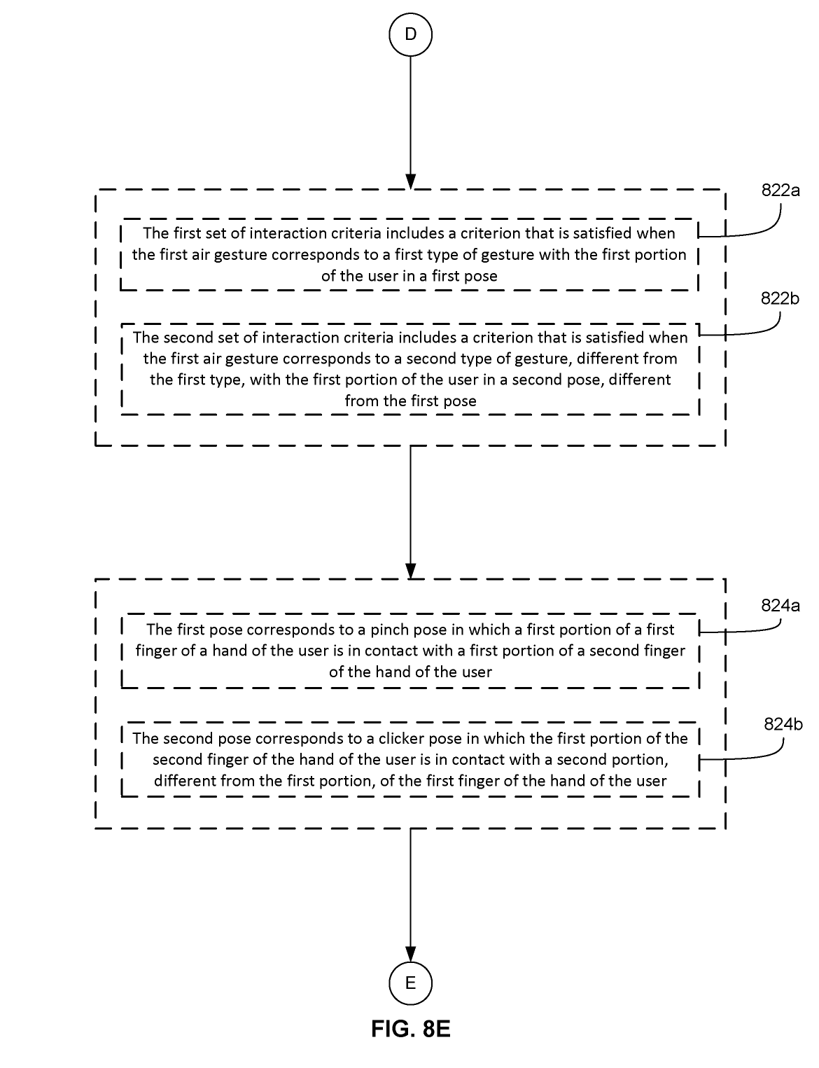

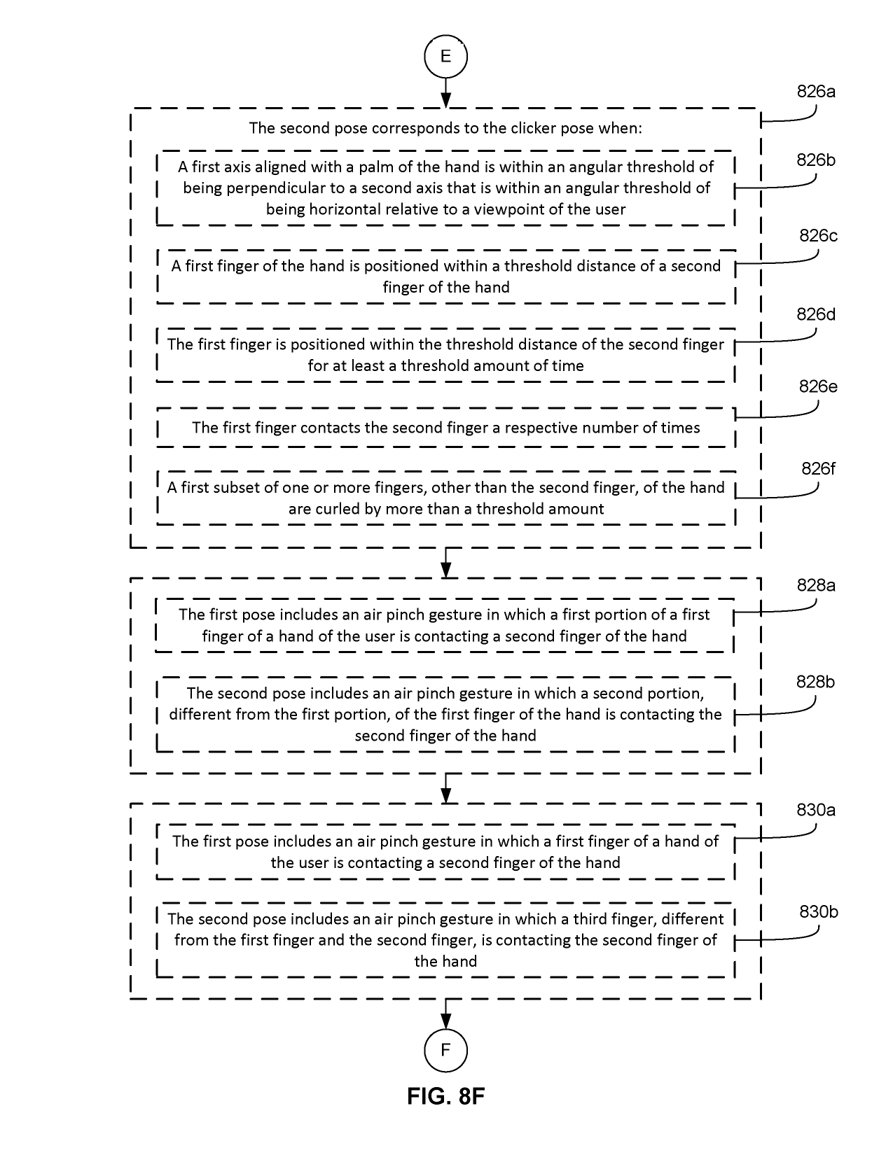

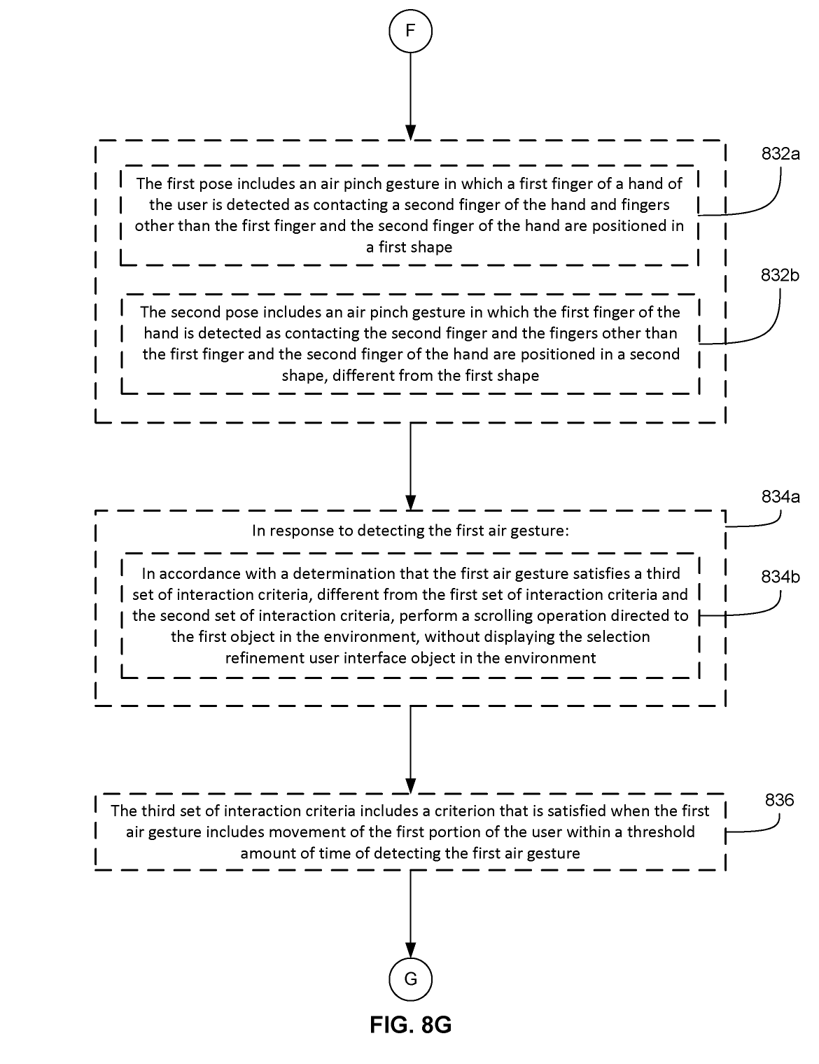

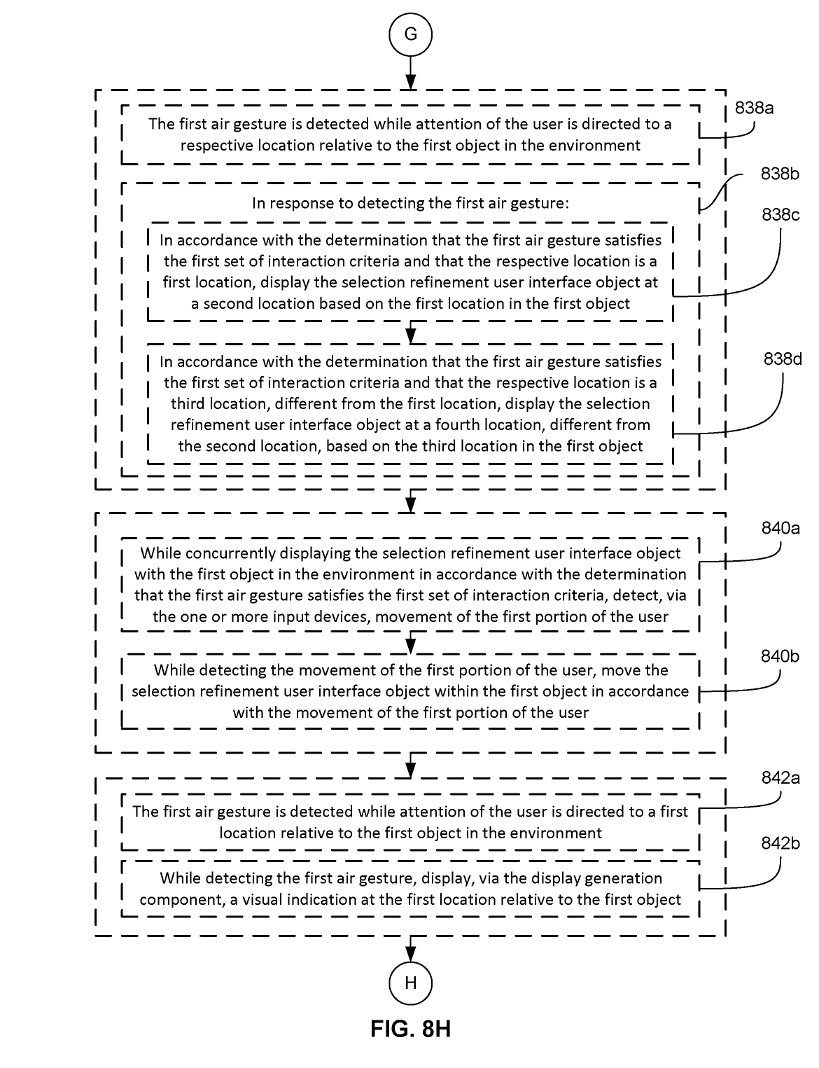

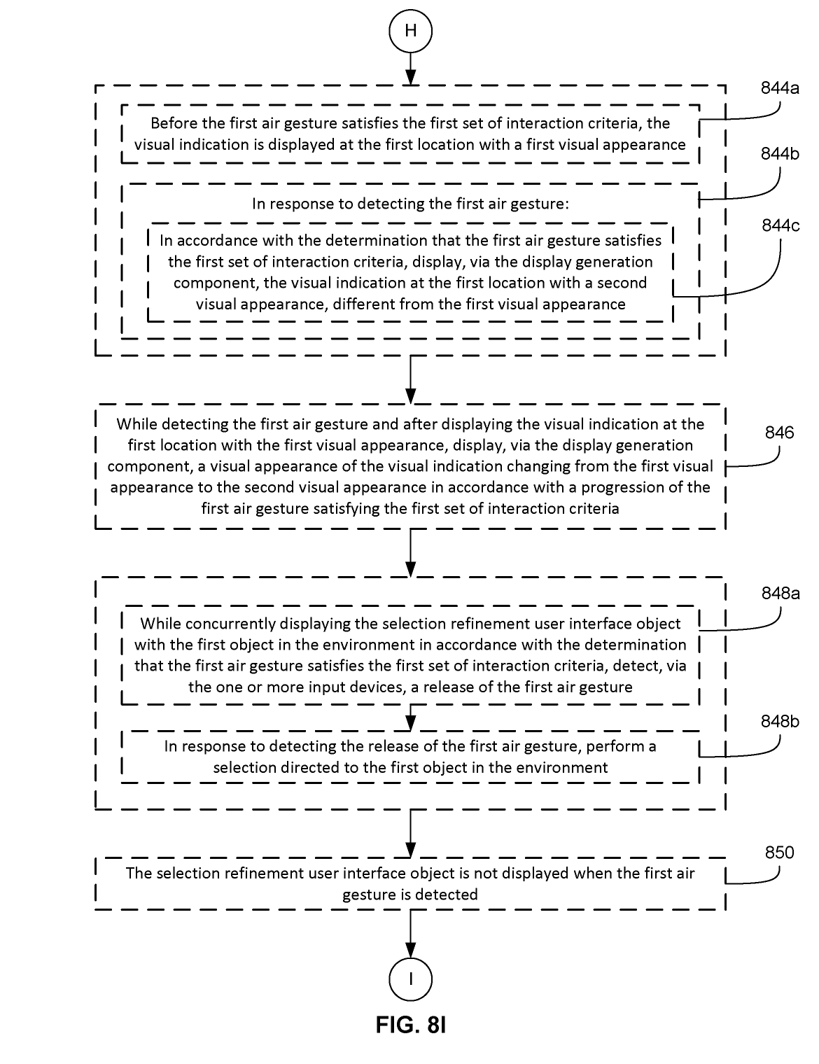

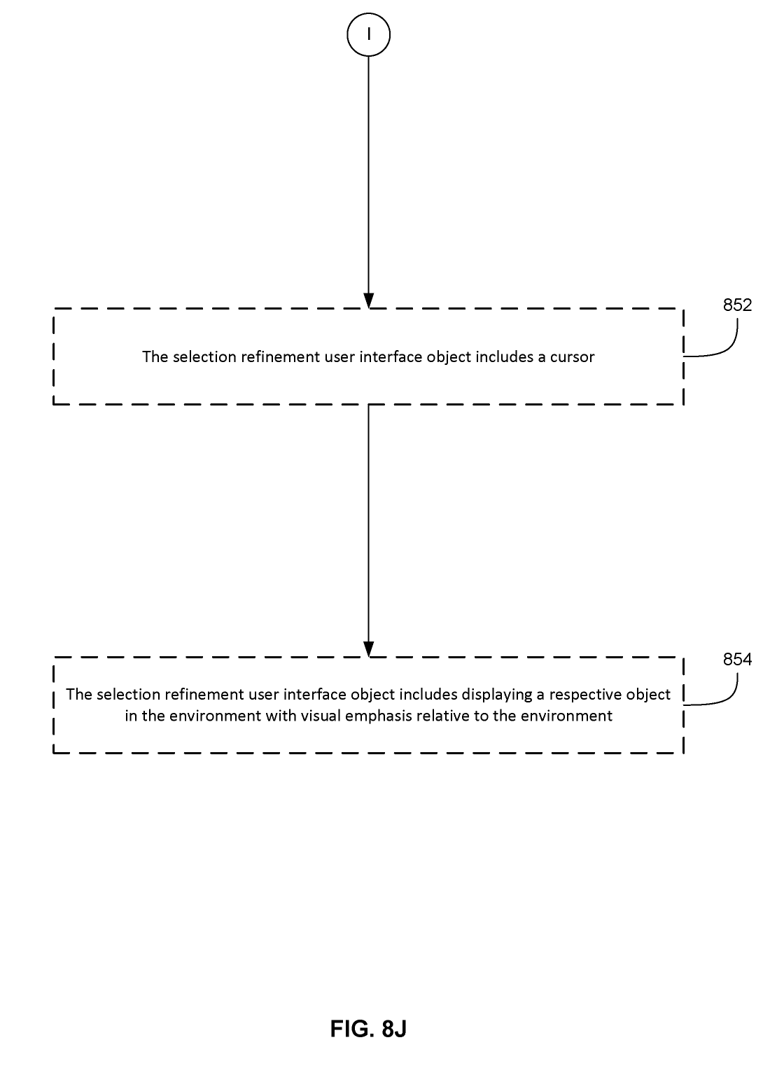

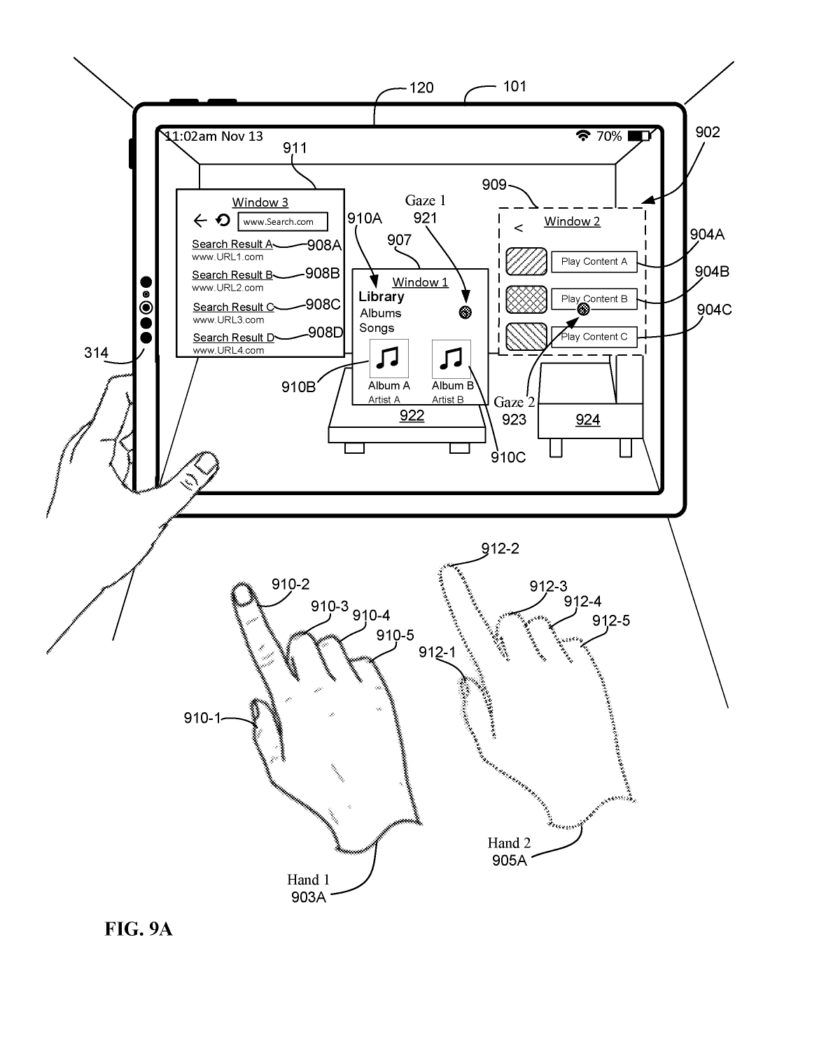

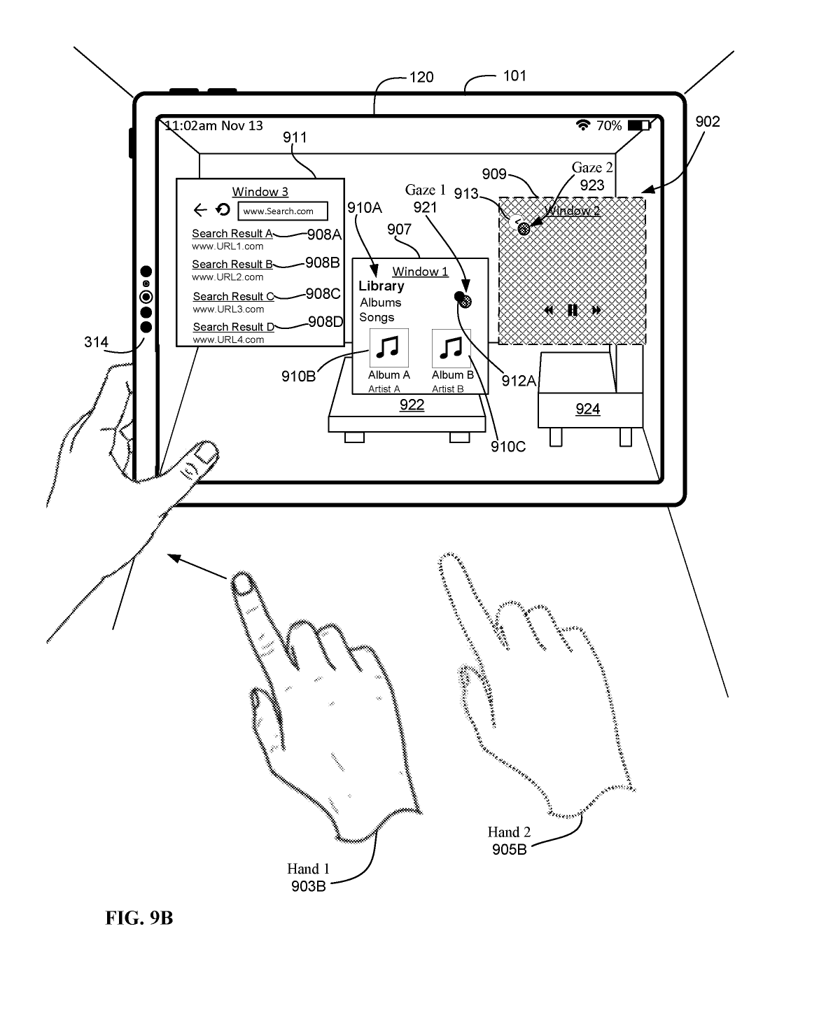

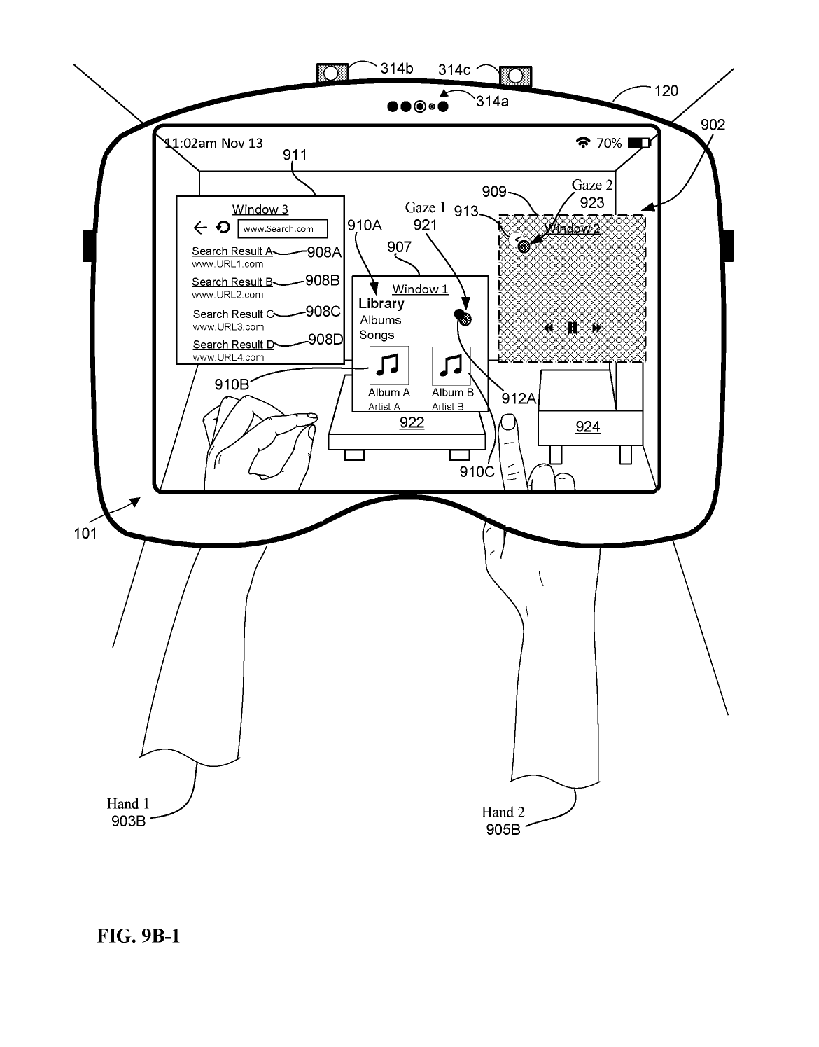

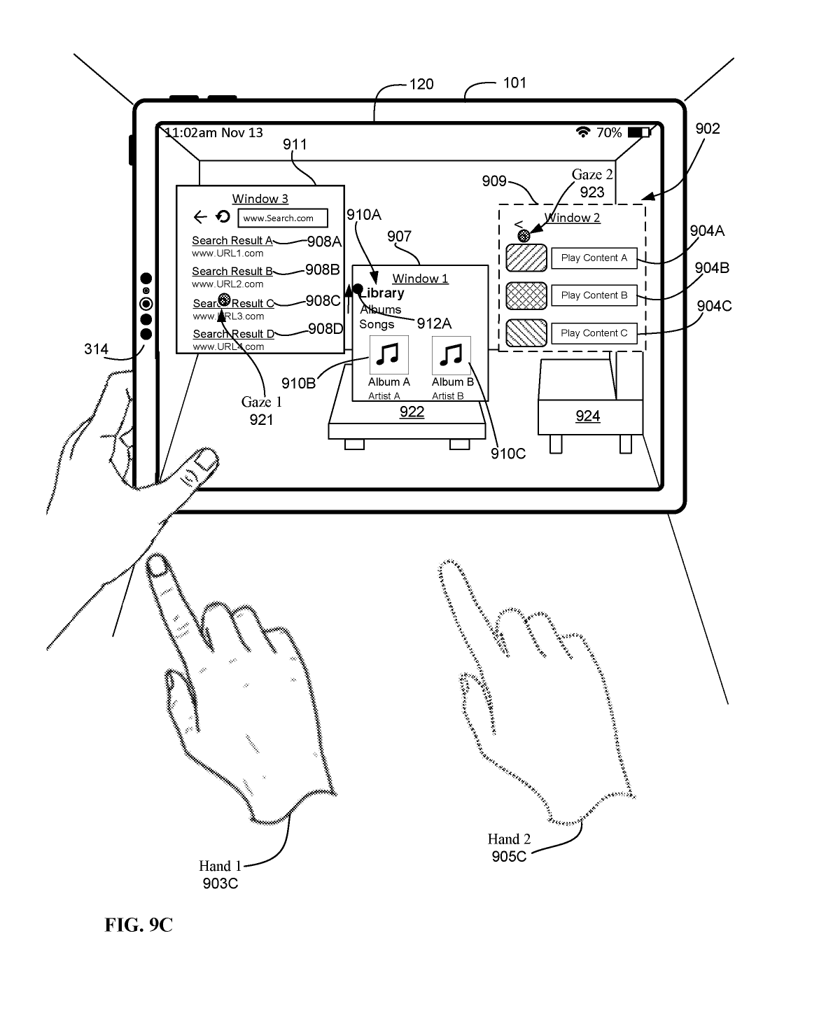

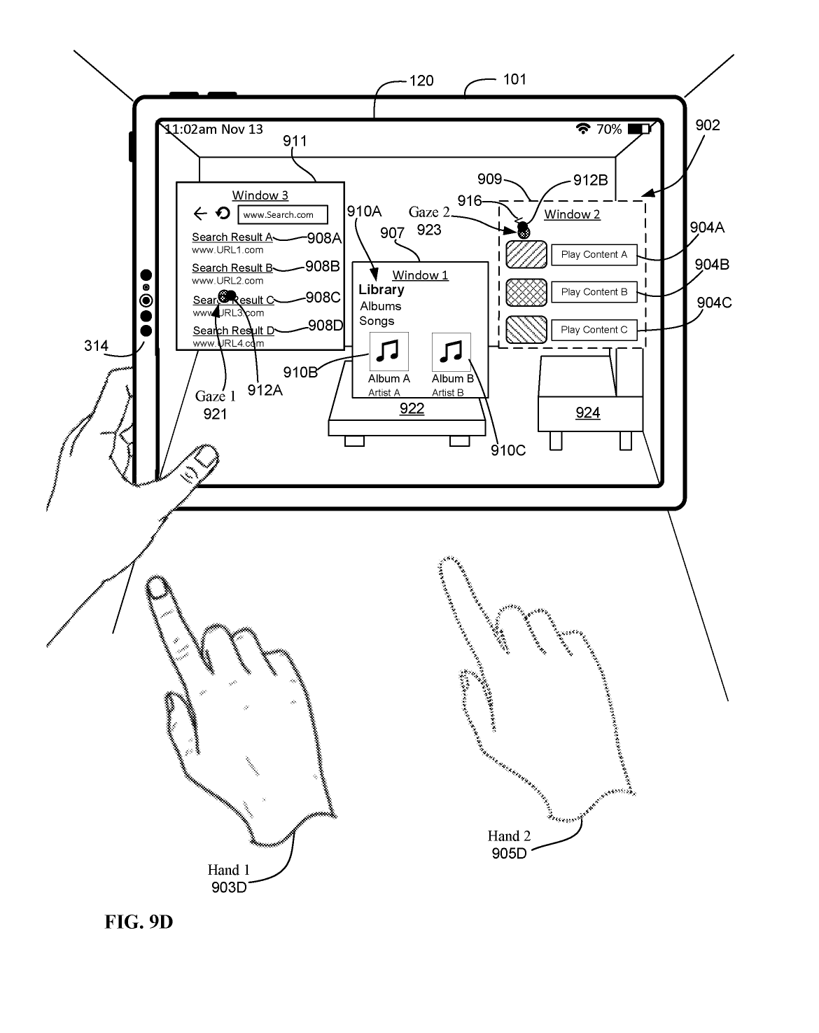

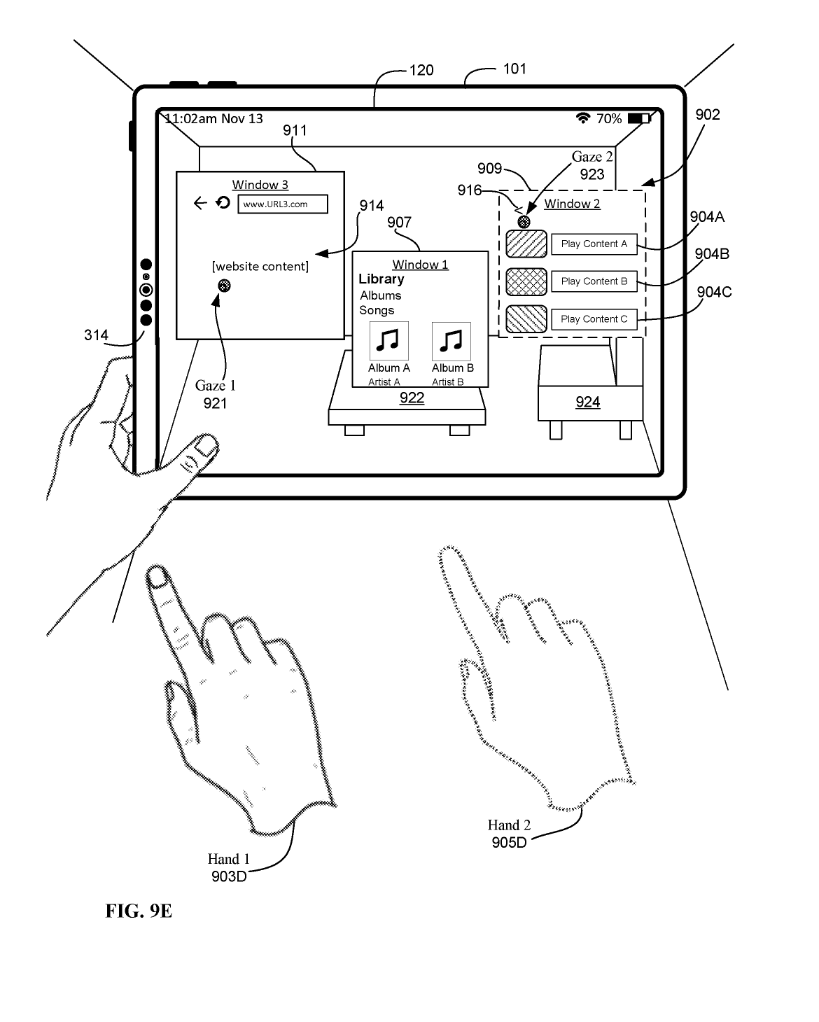

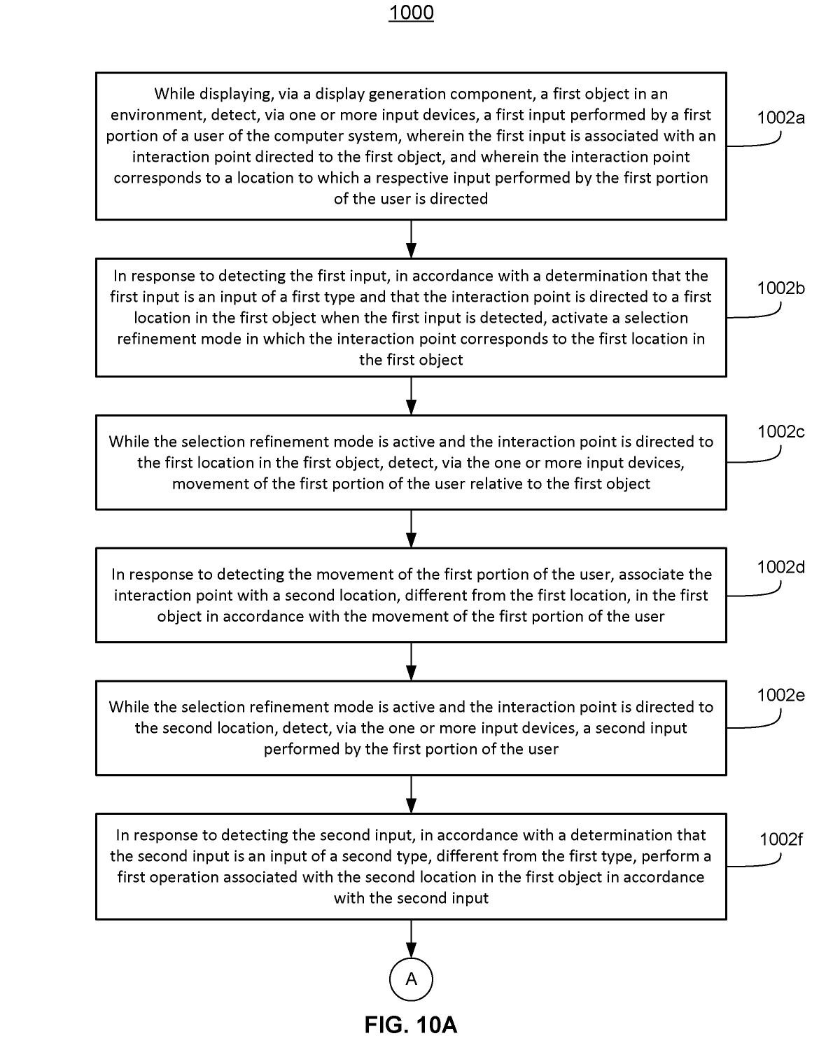

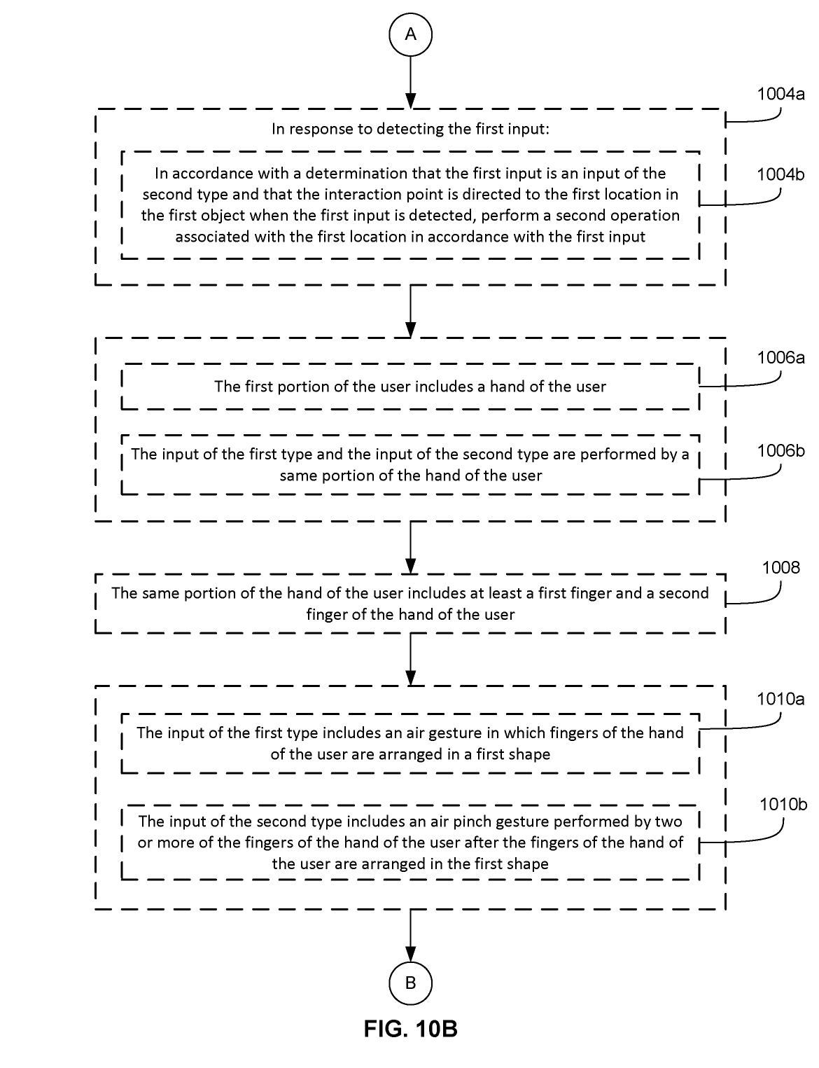

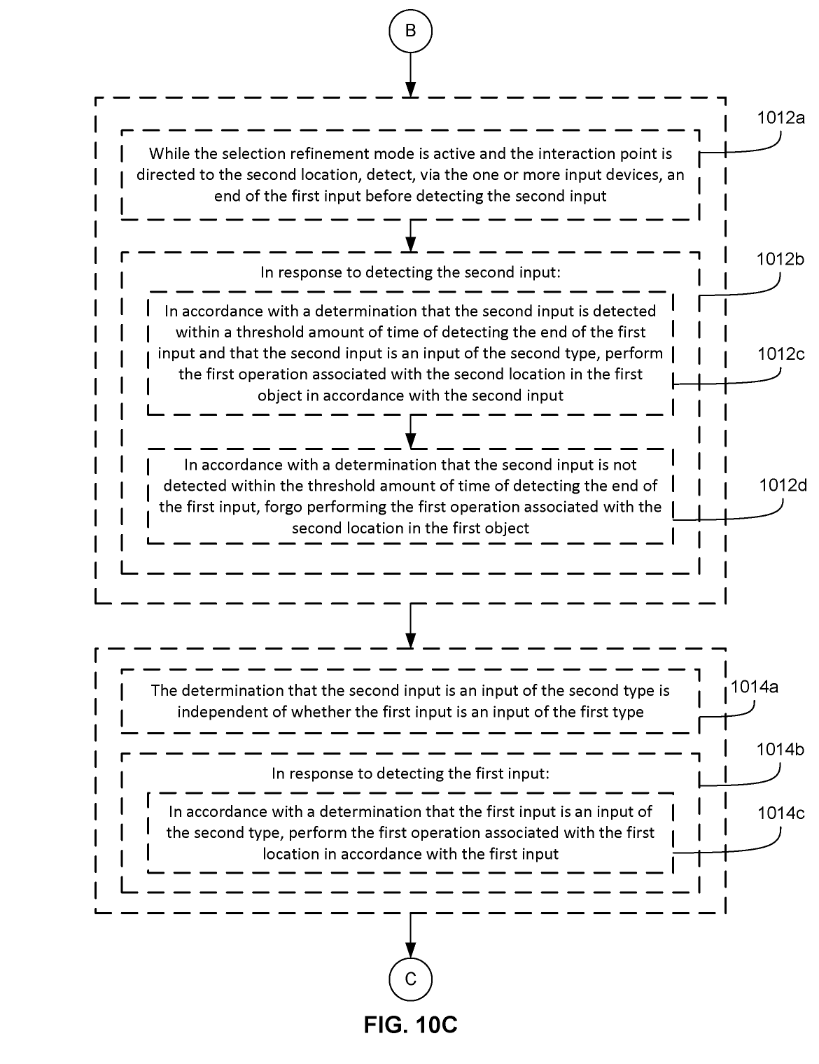

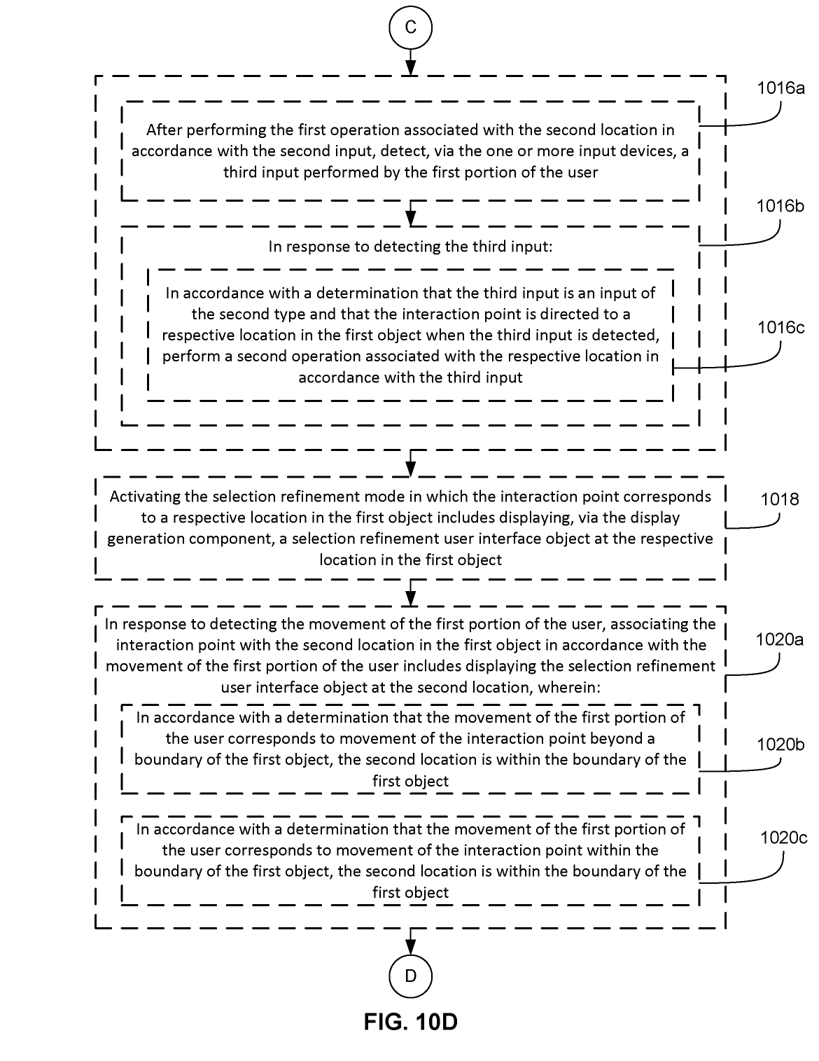

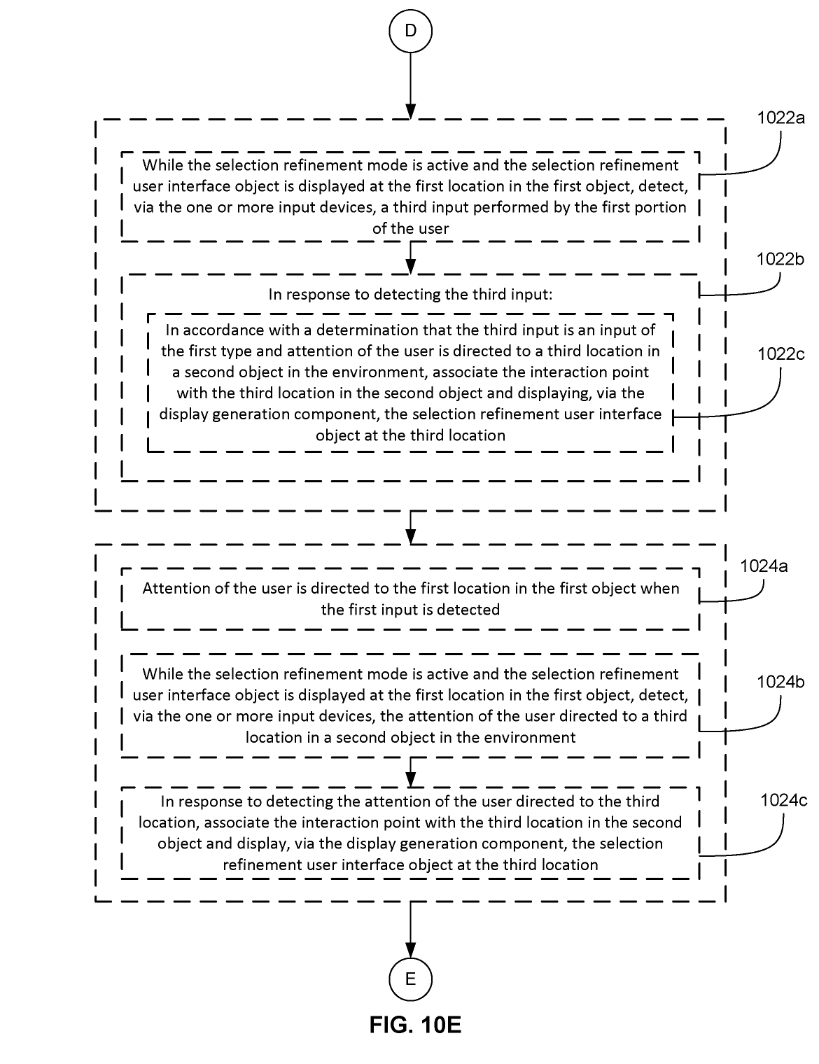

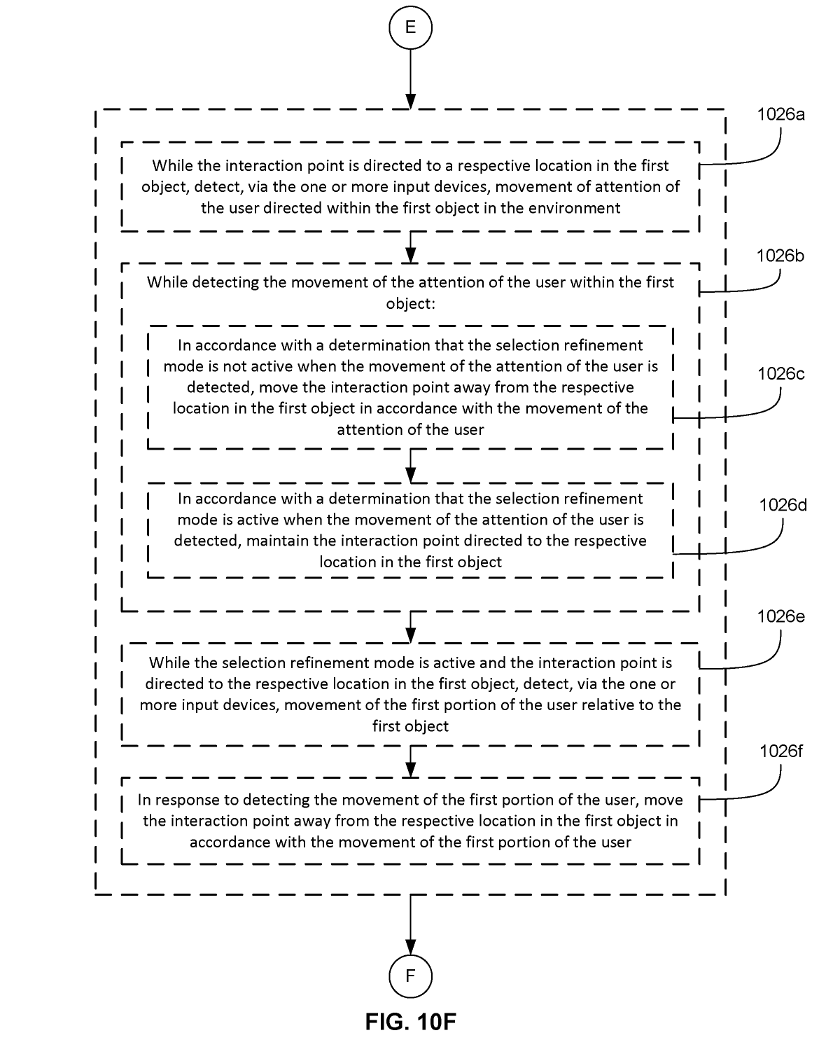

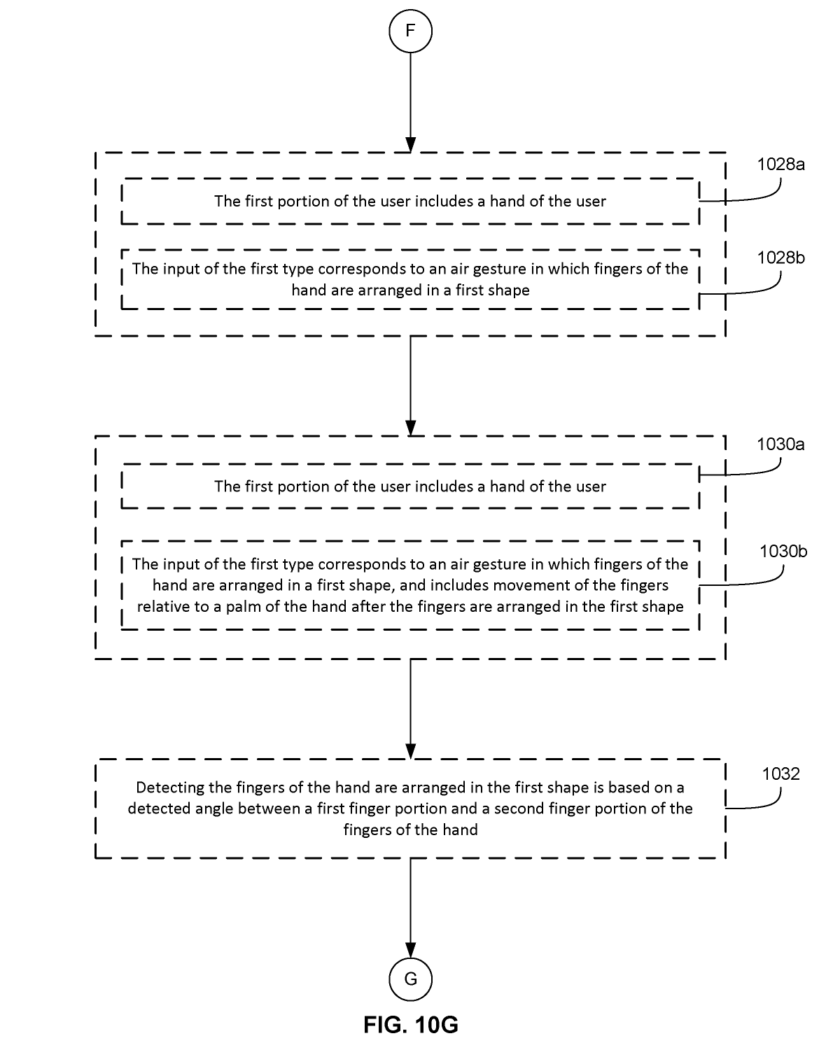

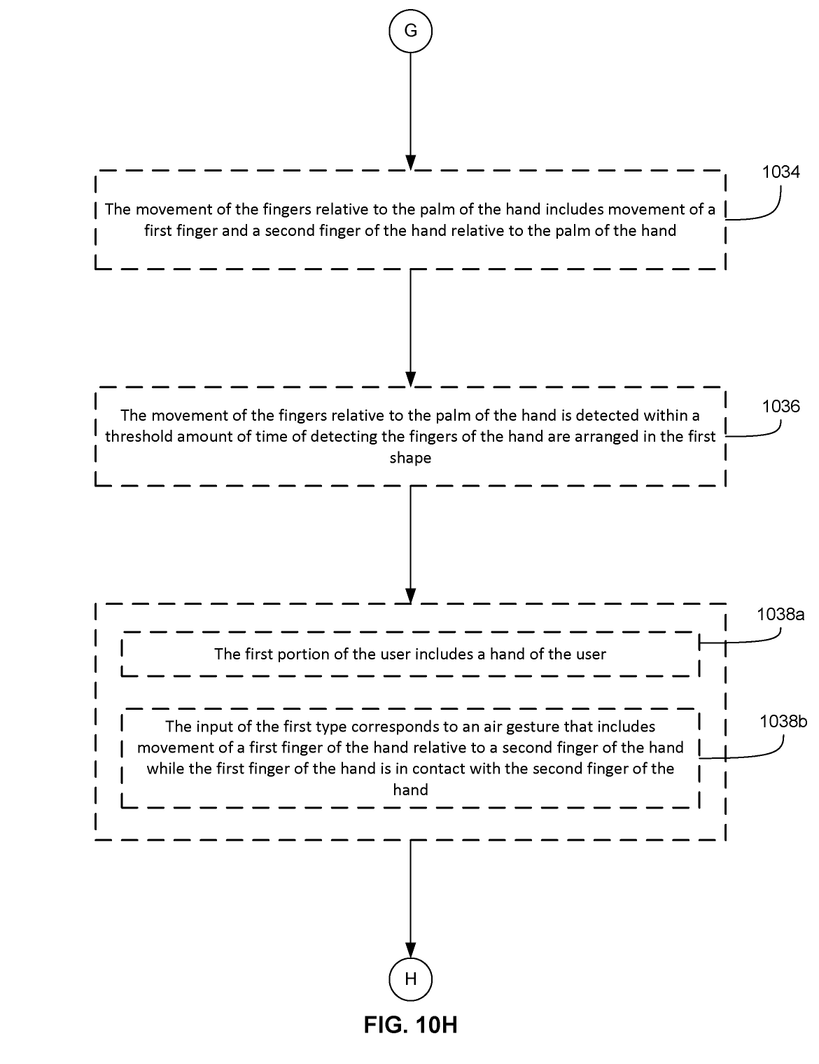

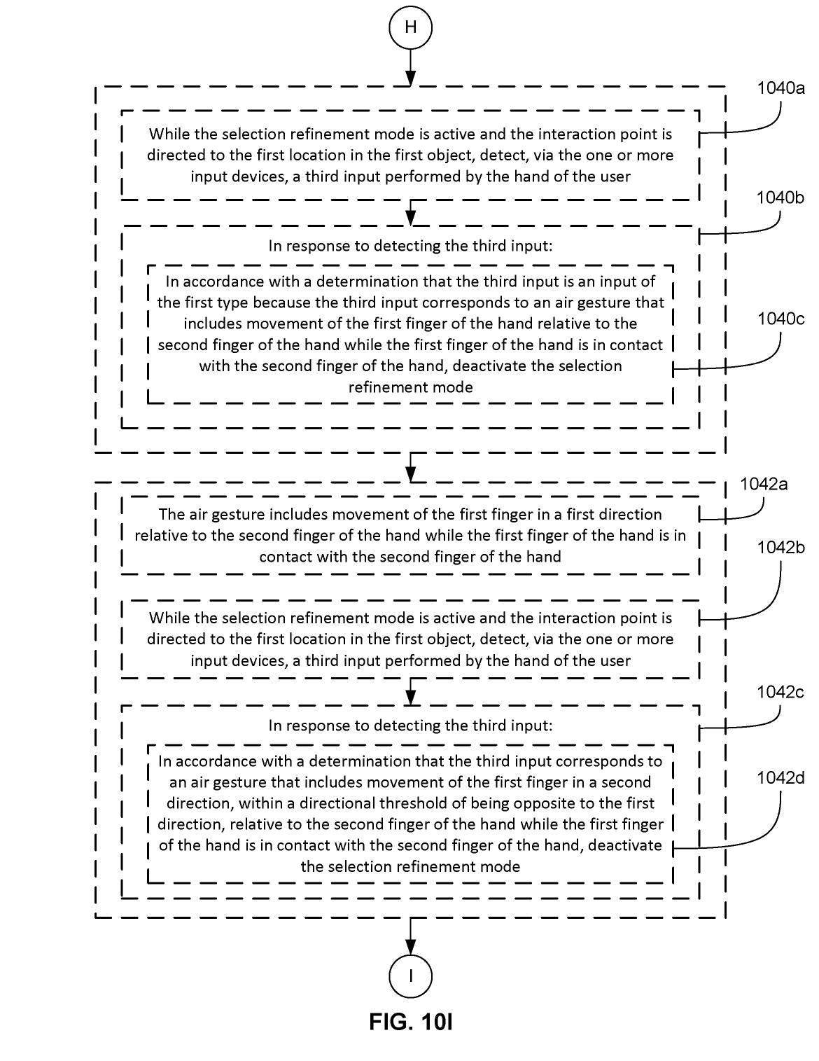

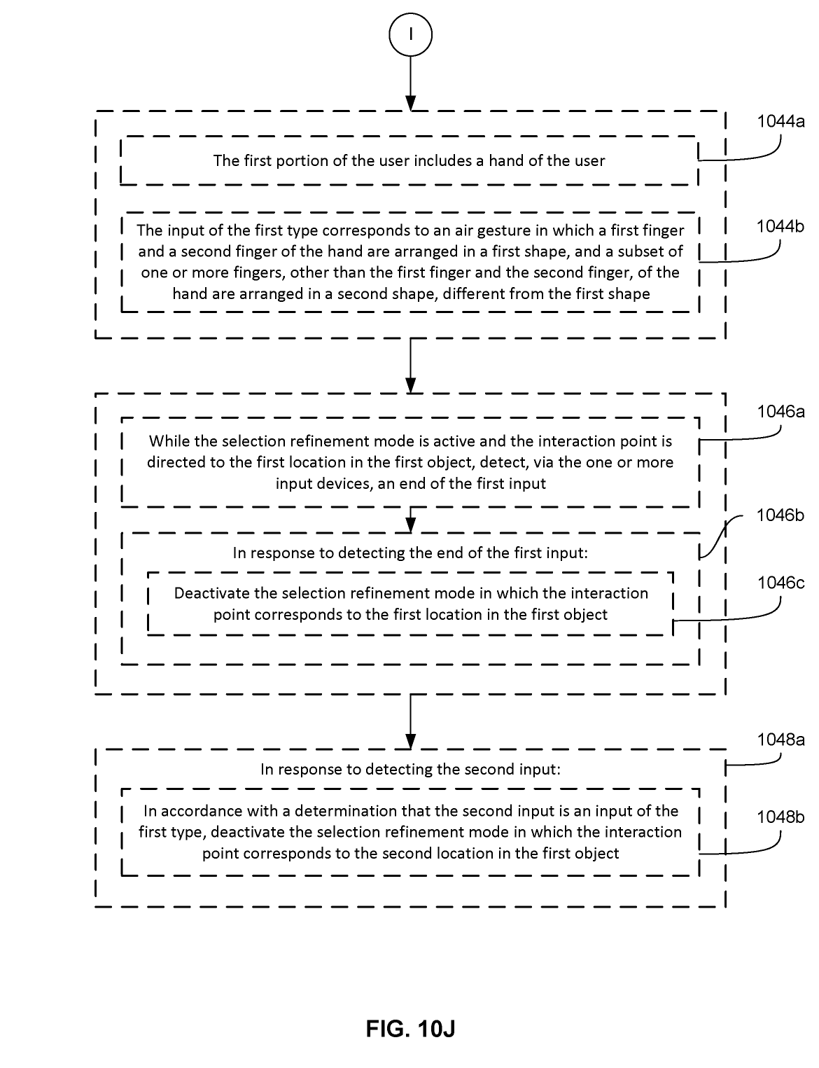

FIGS. 1A-6 provide a description of example computer systems for providing XR experiences to users (such as described below with respect to methods 800 and/or 1000). FIGS. 7A-7E illustrate example techniques for displaying a selection refinement user interface object in a three-dimensional environment, in accordance with some embodiments. FIGS. 8A-8J is a flow diagram of methods of displaying a selection refinement user interface object in a three-dimensional environment, in accordance with various embodiments. The user interfaces in FIGS. 7A-7E are used to illustrate the processes in FIGS. 8A-8J. FIGS. 9A-9E illustrate example techniques for activating a selection refinement user interface mode while displaying a three-dimensional environment, in accordance with some embodiments. FIGS. 10A-10J is a flow diagram of methods of activating a selection refinement user interface mode while displaying a three-dimensional environment, in accordance with various embodiments. The user interfaces in FIGS. 9A-9E are used to illustrate the processes in FIGS. 10A-10J.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person’s physical motions, or representations thereof, are tracked, and, in response, one or more characteristics of one or more virtual objects simulated in the XR environment are adjusted in a manner that comports with at least one law of physics. For example, a XR system may detect a person’s head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person’s presence within the computer-generated environment, and/or through a simulation of a subset of the person’s physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objets such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user’s head (e.g., the viewpoint of the user is at least a portion of the field-of-view of the user when the user is looking straight ahead); thus, the viewpoint of the user remains fixed even as the user’s gaze is shifted, without moving the user’s head. In embodiments where the computer system has a display generation component (e.g., a display screen) that can be repositioned with respect to the user’s head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user’s head facing north) continues to be displayed in the upper left corner of the viewpoint of the user, even as the viewpoint of the user changes to a second orientation (e.g., with the user’s head facing west). In other words, the location and/or position at which the viewpoint-locked virtual object is displayed in the viewpoint of the user is independent of the user’s position and/or orientation in the physical environment. In embodiments in which the computer system is a head-mounted device, the viewpoint of the user is locked to the orientation of the user’s head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user’s head is turned to the right) so that the tree is now left-of-center in the viewpoint of the user (e.g., the tree’s position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user’s hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300cm from the viewpoint) which the virtual object is following. For example, when the point of reference (e.g., the portion of the environement or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

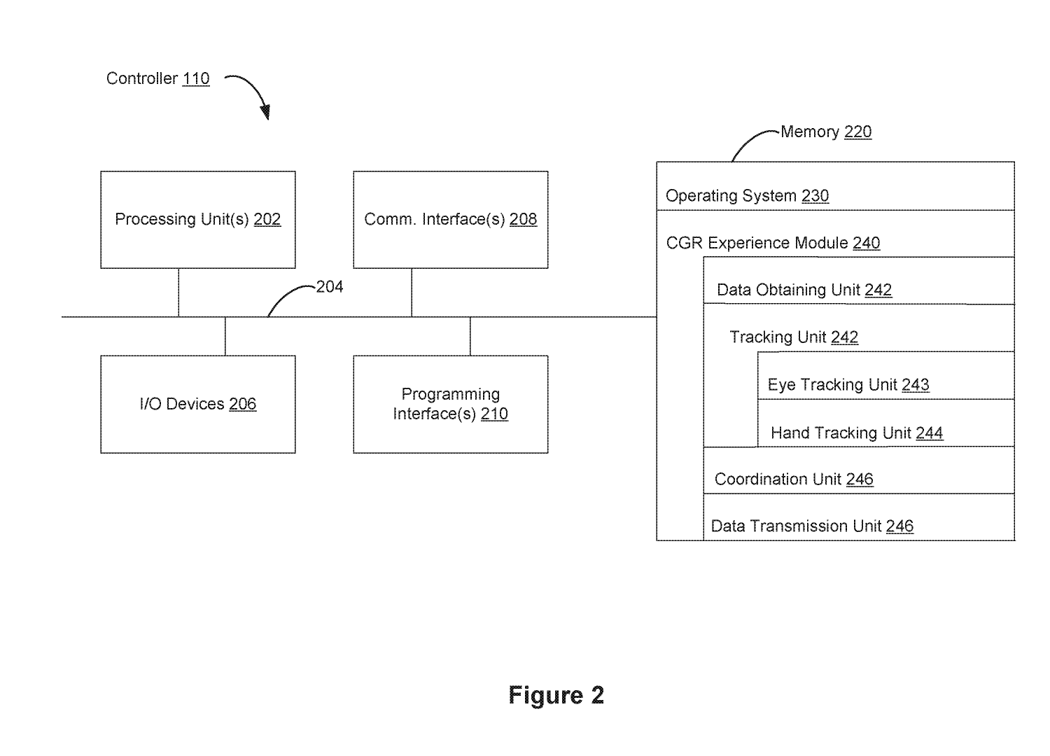

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

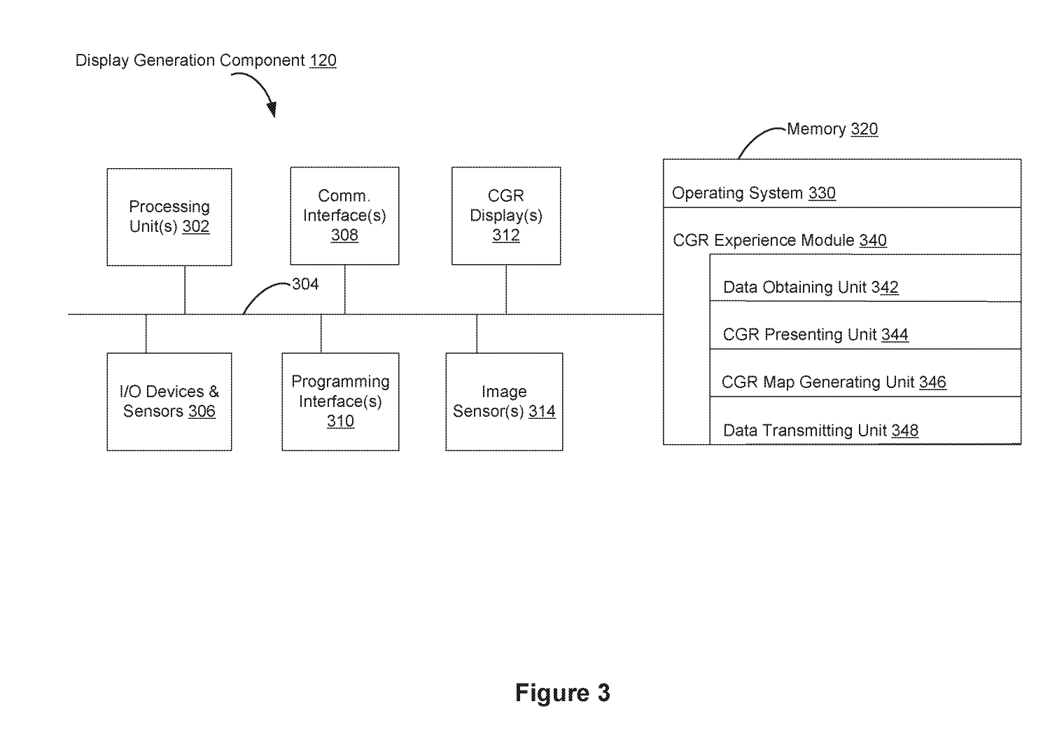

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user’s body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user’s body (e.g., the user’s eye(s), head, or hand)) could similarly be implemented with an HMD where the movement is caused by movement of the HMD relative to the physical environment (e.g., the scene 105 or a part of the user’s body (e.g., the user’s eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user’s right eye and a different one for a user’s left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114 , second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user’s head to hold the display unit 1-102 against the face of the user.

In at least one example, the band assembly 1-106 can include a first band 1-116 configured to wrap around the rear side of a user’s head and a second band 1-117 configured to extend over the top of a user’s head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user’ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user’s face. The display screen of the display assembly 1-108 can be curved as shown to compliment the user’s facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user’s face around the user’s eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user’s eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user’s eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D – 1F and described herein. Likewise, any of the features, components, and/or parts, including the arrangements and configurations thereof shown and described with reference to FIGS. 1D – 1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F, and described herein. Likewise, any of the features, components, and/or parts, including the arrangements and configurations thereof shown and described with reference to FIGS. 1B, 1C, and 1E-1F, can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user’s eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B – 1D and 1F and described herein. Likewise, any of the features, components, and/or parts, including the arrangements and configurations thereof shown and described with reference to FIGS. 1B – 1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B – 1E as well as subsequent figures referenced in the present disclosure. The display unit 1-406 shown in FIG. 1F can be assembled and integrated with the securement mechanisms shown in FIGS. 1B – 1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B – 1E and described herein. Likewise, any of the features, components, and/or parts, including the arrangements and configurations thereof shown and described with reference to FIGS. 1B – 1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user’s face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user’s face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user’s face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user’s eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user’s eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user’s jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user’s eyes during and/or before use. In at least one example, the eye/gaze tracking sensors can include nasal eye cameras 6-120 disposed on either side of the user’s nose and adjacent the user’s nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J – 1L and described herein. Likewise, any of the features, components, and/or parts, including the arrangements and configurations thereof shown and described with reference to FIGS. 1J – 1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K – 1L and described herein. Likewise, any of the features, components, and/or parts, including the arrangements and configurations thereof shown and described with reference to FIGS. 1I and 1K – 1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I – 1J and 1L and described herein. Likewise, any of the features, components, and/or parts, including the arrangements and configurations thereof shown and described with reference to FIGS. 1I – 1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I – 1K. In at least one example, the jaw cameras 6-416 can be facing downward to capture images of the user’s lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I – 1K and described herein. Likewise, any of the features, components, and/or parts, including the arrangements and configurations thereof shown and described with reference to FIGS. 1I – 1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user’s eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user’s eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user’s nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user’s nose as noted above. The nose bridge 11.1.2-111 geometry accommodates the nose in that the nose bridge 11.1.2-111 provides a curvature that curves with, above, over, and around the user’s nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user’s eye. In this way, a first optical module can project light via a display screen toward a user’s first eye and a second optical module of the same device can project light via another display screen toward the user’s second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user’s eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user’s eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user’s eye. In one example, the camera 11.3.2-106 is configured to capture one or more images of the user’s eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIGS. 1P or otherwise described herein. Likewise, any of the features, components, and/or parts, including the arrangements and configurations thereof shown and described with reference to FIGS. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user’s eyes for match the user’s interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user’s eyes when the HMD is donned. The lens 11.3.2-216 can be configured to direct light from the display assembly 11.3.2-204 to the user’s eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user’s eye through the lens 11.3.2-216 and the light strip 11.3.2-208 includes lights configured to project light through the lens 11.3.2-216 to the users’ eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

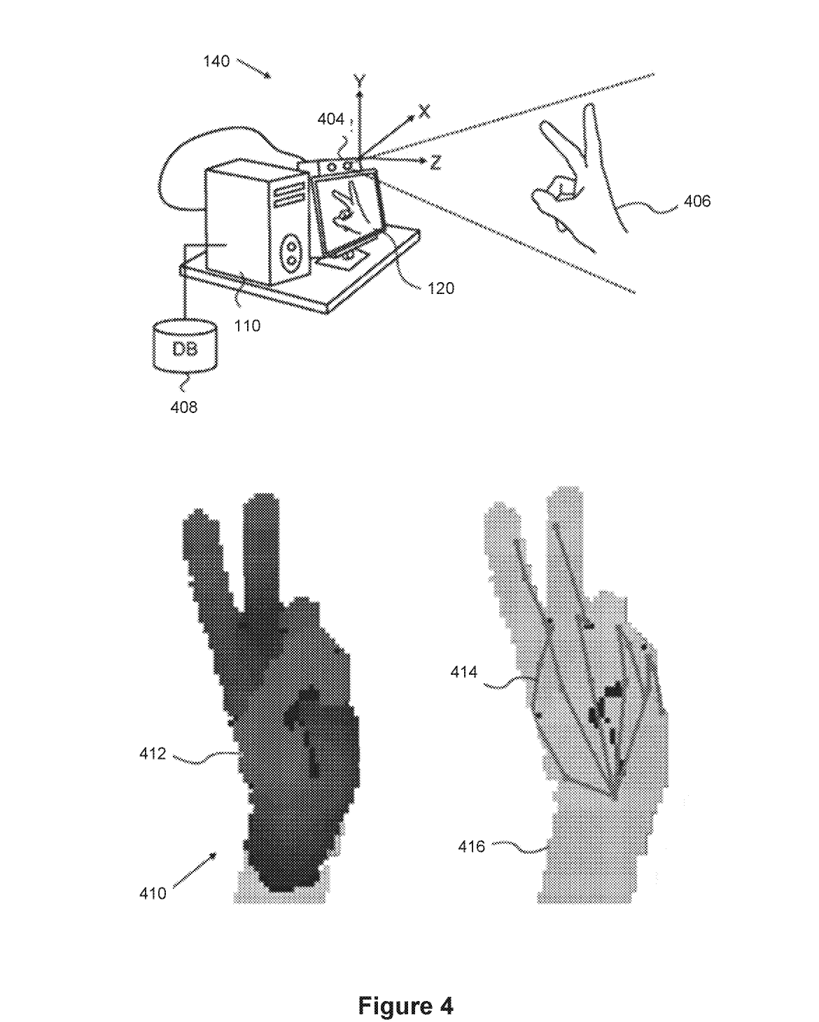

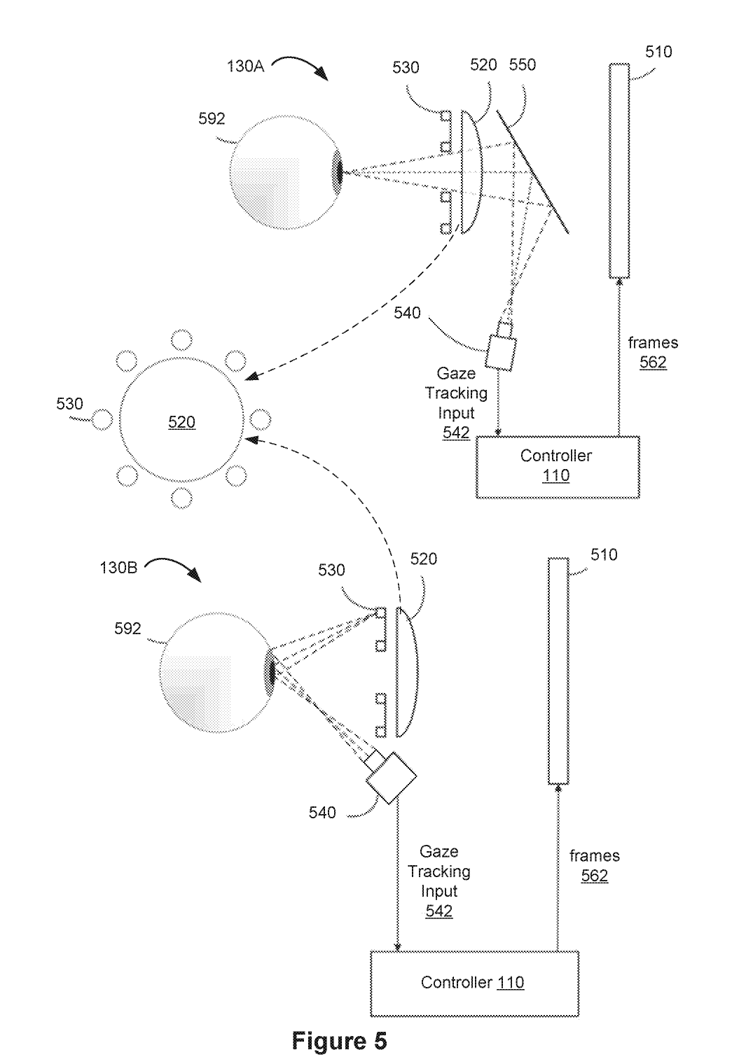

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user’s hands, and/or motions of one or more portions of the user’s hands with respect to the scene 105 of FIG. 1A, relative to the display generation component 120, and/or relative to a coordinate system defined relative to the user’s hand. The hand tracking unit 244 is described in greater detail below with respect to FIG. 4. In some embodiments, the eye tracking unit 243 is configured to track the position and movement of the user’s gaze (or more broadly, the user’s eyes, face, or head) with respect to the scene 105 (e.g., with respect to the physical environment and/or to the user (e.g., the user’s hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user’s hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user’s hands, and/or motions of one or more portions of the user’s hands with respect to the scene 105 of FIG. 1A (e.g., with respect to a portion of the physical environment surrounding the user, with respect to the display generation component 120, or with respect to a portion of the user (e.g., the user’s face, eyes, or head), and/or relative to a coordinate system defined relative to the user’s hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user’s body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user’s environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user’s hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user’s hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user’s hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

In some embodiments, input gestures used in the various examples and embodiments described herein include air gestures performed by movement of the user’s finger(s) relative to other finger(s) or part(s) of the user’s hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user’s hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user’s hand is not at the position that corresponds to the position of the user interface object in the three-dimensional environment while detecting the user’s attention (e.g., gaze) on the user interface object. For example, for direct input gesture, the user is enabled to direct the user’s input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user’s input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesure or an air swipe gesture) includes a pinch gesture (e.g., a pinch gesture or a long pinch gesture) performed in conjunction with (e.g., followed by) a drag input that changes a position of the user’s hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user’s second hand moves from the first position to the second position in the air while the user continues the pinch input with the user’s first hand. In some embodiments, an input gesture that is an air gesture includes inputs (e.g., pinch and/or tap inputs) performed using both of the user’s two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user’s two hands).

In some embodiments, a tap input (e.g., directed to a user interface element) performed as an air gesture includes movement of a user's finger(s) toward the user interface element, movement of the user's hand toward the user interface element optionally with the user’s finger(s) extended toward the user interface element, a downward motion of a user's finger (e.g., mimicking a mouse click motion or a tap on a touchscreen), or other predefined movement of the user’s hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user’s head and above the user’s waist and extended out from the body by at least 15, 20, 25, 30, or 50cm), and/or based on whether the hand has moved in a particular manner (e.g., moved toward a region in front of the user above the user’s waist and below the user’s head or moved away from the user’s body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user’s body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user’s gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user’s eyes to thus provide 3D virtual views to the user. For example, a head-mounted display generation component may include left and right optical lenses (referred to herein as eye lenses) located between the display and the user’s eyes. In some embodiments, the display generation component may include or be coupled to one or more external video cameras that capture video of the user’s environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user’s eyes. The eye tracking cameras may be pointed towards the user’s eyes to receive reflected IR or NIR light from the light sources directly from the eyes, or alternatively may be pointed towards “hot” mirrors located between the user’s eyes and the display panels that reflect IR or NIR light from the eyes to the eye tracking cameras while allowing visible light to pass. The eye tracking device 130 optionally captures images of the user’s eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device- specific calibration process may be an automated calibration process or a manual calibration process. A user-specific calibration process may include an estimation of a specific user’s eye parameters, for example the pupil location, fovea location, optical axis, visual axis, eye spacing, etc. Once the device-specific and user- specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user’s face for which eye tracking is performed, and an illumination source 530 (e.g., IR or NIR light sources such as an array or ring of NIR light-emitting diodes (LEDs)) that emit light (e.g., IR or NIR light) towards the user’s eye(s) 592. The eye tracking cameras 540 may be pointed towards mirrors 550 located between the user’s eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user’s eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user’s point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user’s current gaze direction, and is not intended to be limiting. As an example use case, the controller 110 may render virtual content differently based on the determined direction of the user’s gaze. For example, the controller 110 may generate virtual content at a higher resolution in a foveal region determined from the user’s current gaze direction than in peripheral regions. As another example, the controller may position or move virtual content in the view based at least in part on the user’s current gaze direction. As another example, the controller may display particular virtual content in the view based at least in part on the user’s current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user’s eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user’s eye(s) 592. In some embodiments, the light sources may be arranged in rings or circles around each of the lenses as shown in FIG. 5. In some embodiments, eight illumination sources 530 (e.g., LEDs) are arranged around each eye lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user’s face. In some embodiments, two or more NIR cameras 540 may be used on each side of the user’s face. In some embodiments, a camera 540 with a wider field of view (FOV) and a camera 540 with a narrower FOV may be used on each side of the user’s face. In some embodiments, a camera 540 that operates at one wavelength (e.g., 850nm) and a camera 540 that operates at a different wavelength (e.g., 940nm) may be used on each side of the user’s face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

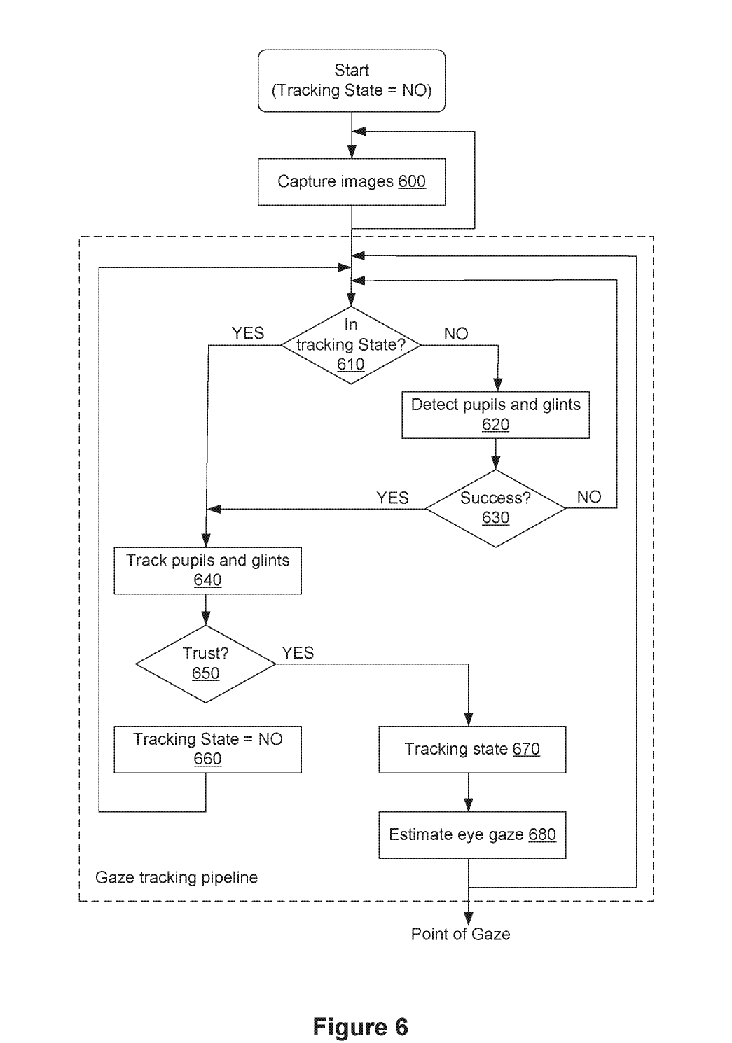

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user’s left and right eyes. The captured images are then input to a gaze tracking pipeline for processing beginning at 610. As indicated by the arrow returning to element 600, the gaze tracking system may continue to capture images of the user’s eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user’s pupils and glints in the images. At 630, if the pupils and glints are successfully detected, then the method proceeds to element 640. Otherwise, the method returns to element 610 to process next images of the user’s eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user’s eyes. At 650, if the results are trusted, then the method proceeds to element 670. At 670, the tracking state is set to YES (if not already YES), and the pupil and glint information is passed to element 680 to estimate the user’s point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that

extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one

object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user’s eye or into a field of view of the user’s eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user’s hands in the three-dimensional environment in conjunction with the movement of the user’s hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### USER INTERFACES AND ASSOCIATED PROCESSES

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7E illustrate examples of a computer system facilitating user input for displaying a selection refinement user interface object in a three-dimensional environment in accordance with some embodiments.

FIG. 7A illustrates a computer system (e.g., an electronic device) 101 displaying, via a display generation component (e.g., display generation component 120 of FIG. 1), a three-dimensional environment 702 from a viewpoint of a user (e.g., facing the back wall of the physical environment in which computer system 101 is located). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user’s hands (e.g., external sensors facing outwards from the user), and/or attention (e.g., gaze) of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 702. For example, three-dimensional environment 702 includes a representation 722 of a coffee table, which is optionally a representation of a physical coffee table in the physical environment, and three-dimensional environment 702 includes a representation 724 of sofa, which is optionally a representation of a physical sofa in the physical environment.

In FIG. 7A, three-dimensional environment 702 also includes virtual objects 707 (“Window 1”), and 709 (“Window 2”). In some embodiments, virtual objects 707 and 709 are optionally one or more of user interfaces of applications containing content (e.g., a plurality of selectable options), three-dimensional objects (e.g., virtual clocks, virtual balls, and/or virtual cars) or any other element displayed by computer system 101 that is not included in the physical environment of display generation component 120. In FIG. 7A, virtual object 707 is optionally a user interface of a web-browsing application. For example, as shown in FIG. 7A, virtual object 707 includes a plurality of selectable search results (e.g., hyperlinks) from the website “www.Search.com”. As shown in FIG. 7A as an example, the virtual object 707 includes a first search result 708a that is selectable to cause the computer system 101 to display content (e.g., text, images, video, and/or audio) associated with a first website (“www.URL1.com”), a second search result 708b that is selectable to cause the computer system 101 to display content associated with a second website (“www.URL2.com”), a third search result 708c that is selectable to cause the computer system 101 to display content associated with a third website (“www.URL3.com”), and/or a fourth search result 708d that is selectable to cause the computer system 101 to display content associated with a fourth website (“www.URL4.com”). Additionally, in FIG. 7A, virtual object 709 is optionally a user interface of a media browsing application. For example, as shown in FIG. 7A, virtual object 709 includes a plurality of selectable options corresponding to a plurality of content items (e.g., movies, episodes, podcasts, and/or music). As shown in FIG. 7A as an example, the virtual object 709 includes a first selectable option 704a that is selectable to cause the computer system 101 to initiate playback of a first content item (“Content A”), a second selectable option 704b that is selectable to cause the computer system 101 to initiate playback of a second content item (“Content B”), and/or a third selectable option 704c that is selectable to cause the computer system 101 to initiate playback of a third content item (“Content C”).

In some embodiments, as discussed herein, the computer system 101 provides for enhanced and precise selection of selectable options in three-dimensional environment 702. As discussed above, in FIG. 7A, the virtual objects 707 and 709 optionally include a plurality of selectable options. In some embodiments, the computer system 101 activates a respective selectable option in response to detecting an air gesture provided by the hand of the user while attention (e.g., gaze) of the user is directed toward the respective selectable option in the three-dimensional environment 702. In some embodiments, the respective selectable option is proximate to (e.g., 0.5, 1, 2, 3, 4, 5, 6, 8, or 10 cm from) one or more other selectable options, such as selectable options 708a-708d and/or 704a-704c in FIG. 7A, which could result in an unintentional selection of a selectable option that is different from the respective selectable option to which the air gesture is directed in the three-dimensional environment 702. Accordingly, in some embodiments, as discussed below, in response to detecting an air gesture that satisfies a first set of criteria, the computer system 101 displays a selection refinement user interface object (e.g., a cursor) that indicates a location in the three-dimensional environment 702 at which a selection operation will be performed in response to further input.

In FIG. 7A, the computer system 101 detects a first air gesture provided by hand 703a (“Hand 1”). For example, as shown in FIG. 7A, the computer system 101 detects hand 703a provide the first air gesture while a first gaze 721 of the user is directed to the virtual object 707 in the three-dimensional environment 702. Additionally, in FIG. 7A, the computer system detects a second air gesture provided by hand 705a (“Hand 2”). For example, as shown in FIG. 7A, the computer system 101 detects the hand 705a provide the second air gesture while a second gaze 723 of the user is directed to the virtual object 709 in the three-dimensional environment 702. It should be understood that while multiple hands and corresponding inputs are illustrated in FIGS. 7A-7E, such hands and inputs need not be detected by computer system 101 concurrently; rather, in some embodiments, computer system 101 independently responds to the hands and/or inputs illustrated and described in response to detecting such hands and/or inputs independently. Additionally, it should be understood that, while multiple gaze points are illustrated in FIGS. 7A-7E, such gaze points need not be detected by computer system 101 concurrently; rather, in some embodiments, computer system 101 independently responds to the gaze points illustrated and described in response to detecting such gaze points independently.

As mentioned above, in some embodiments, the computer system 101 displays a selection refinement user interface object in the three-dimensional environment 702 that facilitates precise selection of a respective selectable option in the three-dimensional environment 702 in response to detecting an air gesture that satisfies a first set of criteria. In some embodiments, the first set of criteria includes a criterion that is satisfied when the air gesture corresponds to a first type of gesture that is detected by the computer system 101 while the hand of the user is in a first pose. In some embodiments, if the computer system 101 determines that the air gesture satisfies the first set of criteria, the computer system 101 displays the selection refinement user interface object at a location in the three-dimensional environment 702 that is based on the location of the attention (e.g., gaze) of the user when the air gesture is detected, as discussed below. In some embodiments, the computer system 101 forgoes displaying the selection refinement user interface object in the three-dimensional environment 702 if the air gesture satisfies a second set of criteria (e.g., and does not satisfy the first set of criteria). Rather, the computer system 101 optionally performs a selection operation in the three-dimensional environment 702 at a location that is based on the location of the attention of the user when the air gesture is detected. As discussed in more detail below, in some embodiments, the second set of criteria includes a criterion that is satisfied when the air gesture corresponds to a second type of gesture that is detected by the computer system 101 while the hand of the user is in a second pose.

From FIGS. 7A-7B, the computer system 101 determines that the first air gesture provided by the hand 703a satisfies the first set of criteria because the first air gesture corresponds to the first type of gesture and because the first air gesture is detected while the hand 703a is in the first pose. In some embodiments, the first pose corresponds to an air pinch gesture performed by a first finger (e.g., index finger) and a thumb of the hand of the user. For example, in FIG. 7A, the computer system 101 detects index finger 710-2 and thumb 710-1 of the hand 703a of the user come together and make contact. In some embodiments, the first pose corresponds to an air pinch gesture performed by a first portion (e.g., a tip and/or upper portion) of the first finger (e.g., index finger) and a thumb of the hand of the user. For example, in FIG. 7A, the computer system 101 detects the tip of the index finger 710-2 and the thumb 710-1 of the hand 703a of the user come together and make contact. In some embodiments, the index finger 710-2 and the thumb 710-1 of the user remain in contact from FIGS. 7A-7B. In some embodiments, the first pose corresponds to an air pinch gesture performed by a first finger (e.g., index finger, middle finger, or ring finger) and a second finger (e.g., thumb) while the remaining fingers (e.g., fingers not performing the air pinch gesture) are arranged in a first shape. For example, in FIG. 7A, the computer system 101 detects the index finger 710-2, the middle finger 710-3, the ring finger 710-4, or the pinky finger 710-5 and the thumb 710-1 of the hand 703a come together and make contact. Additionally, in FIG. 7A, the computer system 101 optionally detects that the fingers of the hand 703a that are not in contact are arranged in the first shape. For example, if the index finger 710-2 and the thumb 710-1 of the hand 703a are in contact (e.g., performing the air pinch gesture), the computer system 101 detects that the middle finger 710-3, the ring finger 710-4, and the pinky finger 710-5 are in a collapsed/curled state (e.g., such that the fingers are contacting/resting on the palm of the hand 703a). Additional details regarding the first pose are provided below with reference to method 800.

Additionally, from FIGS. 7A-7B, the computer system 101 determines that the second air gesture provided by the hand 705a satisfies the second set of criteria (e.g., and does not satisfy the first set of criteria) because the second air gesture corresponds to the second type of gesture and because the second air gesture is detected while the hand 705a is in the second pose. In some embodiments, the second pose corresponds to an air pinch gesture that includes a clicker gesture performed by a first finger (e.g., index finger) and a thumb of the hand of the user. For example, the clicker gesture requires that a first axis parallel to the palm of the hand of the user is normal to a second axis that is horizontal relative to the viewpoint of the user, the tip of the thumb of the hand is positioned within a threshold distance (e.g., 0.25, 0.5, 0.75, 1, 1.5, 2, 3, 4, or 5 cm) from a medial portion (e.g., spanning the intermediate phalange) of the index finger of the hand, the thumb is positioned within the threshold distance from the medial portion of the index finger for a threshold amount of time (e.g., 0.25, 0.5, 1, 1.5, 2, 3, 4, or 5 seconds), the thumb taps the medial portion of the index finger one or more times, and/or the fingers other than the thumb (e.g., the index, middle, ring, and/or pinky fingers) are arranged in a curled shape (e.g., resembling a “C-shape”) by more than a threshold amount (e.g., axes running parallel to the intermediate phalanges of the fingers other than the thumb intersect the axis parallel to the palm of the hand by more than 90, 110, 120, 125, 130, 145, or 160 degrees). In FIG. 7A, the computer system 101 optionally detects index finger 712-2 and thumb 712-1 of the hand 705a of the user perform the clicker gesture (e.g., the thumb 712-1 taps the medial portion of the index finger 712-2 one or more times). In some embodiments, the second pose corresponds to an air pinch gesture performed by a second portion (e.g., a medial or side portion) of the first finger (e.g., index finger), different from the first portion (e.g., the tip portion) discussed above with reference to the first pose, and a thumb of the hand of the user. For example, in FIG. 7A, the computer system 101 detects the thumb 712-1 of the hand 705a contact a side portion of the index finger 712-2 (e.g., spanning the intermediate phalange and/or the proximal phalange of the index finger) of the hand 705a of the user come together and make contact.

In some embodiments, the second pose corresponds to an air pinch gesture performed by a second finger, different from the first finger discussed above with reference to the first pose, and the thumb of the hand of the user. For example, in FIG. 7A, the computer system 101 detects middle finger 712-3, ring finger 712-4, or pinky finger 712-5 contact the thumb 712-1 of the hand 705a of the user. In some embodiments, the second pose corresponds to an air pinch gesture performed by a first finger (e.g., index finger, middle finger, or ring finger) and a second finger (e.g., thumb) while the remaining fingers (e.g., fingers not performing the air pinch gesture) are arranged in a second shape, different from the first shape described above with reference to the first pose. For example, in FIG. 7A, the computer system 101 detects the index finger 712-2, the middle finger 712-3, the ring finger 712-4, or the pinky finger 712-5 and the thumb 712-1 of the hand 705a come together and make contact. Additionally, in FIG. 7A, the computer system 101 optionally detects that the fingers of the hand 705a that are not in contact are arranged in the second shape. For example, if the index finger 712-2 and the thumb 712-1 of the hand 705a are in contact (e.g., performing the air pinch gesture), the computer system 101 detects that the middle finger 712-3, the ring finger 712-4, and the pinky finger 712-5 are in an extended/pointed state (e.g., such that the fingers are not contacting/resting on the palm of the hand 705a). Additional details regarding the second pose are provided below with reference to method 800.

In some embodiments, as shown in FIG. 7B, when the computer system 101 determines that the first air gesture provided by the hand 703a in FIG. 7A satisfies the first set of criteria as described above, the computer system 101 displays a selection refinement user interface object (e.g., cursor/pointer) 711a in the three-dimensional environment 702. In some embodiments, the computer system 101 displays the selection refinement user interface object 711a at a location that is based on the location of the attention of the user when the first air gesture is detected. For example, as shown in FIG. 7B, the computer system 101 displays the selection refinement user interface object 711a at the location of the gaze 7121 in the virtual object 707. Additionally or alternatively, in some embodiments, the computer system 101 visually emphasizes a respective selectable option in the three-dimensional environment 702 if the attention of the user is directed toward the respective selectable option when the first air gesture is detected. For example, as shown in FIG. 7B, the computer system 101 highlights (e.g., and/or boldens, underlines, increases a size of) the first selectable search result 708a in the virtual object 707 in response to determining that the gaze 721 of the user is directed toward the first selectable search result 708a (e.g., is within a threshold distance (e.g., 0.25, 0.5, 0.75, 1, 2, 3, 4, or 5 cm) of the first selectable search result 708a) when the first air gesture is detected.

Additionally, in some embodiments, as shown in FIG. 7B, when the computer system 101 determines that the second air gesture provided by hand 705a in FIG. 7A satisfies the second set of criteria described above (e.g., and does not satisfy the first set of criteria), the computer system 101 performs a selection operation based on the location of the attention of the user in the three-dimensional environment 702. For example, as discussed above with reference to FIG. 7A, the gaze 723 is directed toward the selectable option 704a in the virtual object 709 when the second air gesture provided by the hand 705a is detected. Accordingly, as shown in FIG. 7B, the computer system 101 optionally activates the selectable option 704a and initiates playback of the first content item (“Content A”) 706 in the virtual object 709 in the three-dimensional environment 702. Further, as shown in FIG. 7B, the computer system 101 optionally forgoes displaying a selection refinement user interface object in the virtual object 709 in the three-dimensional environment 702. For example, as shown in FIG. 7B, the computer system 101 initiates playback of the first content item 706 in the virtual object 709 in response to detecting the second air gesture provided by the hand 705a without displaying a selection user interface object at the location of the gaze 723 in the virtual object 709.

In some embodiments, while the selection refinement user interface object is displayed in the three-dimensional environment 702, the computer system 101 moves the selection refinement user interface object based on movement of the hand of the user. In FIG. 7B, the computer system 101 detects the hand 703b move in space while the selection refinement user interface object 711a is displayed in the virtual object 707. For example, as shown in FIG. 7B, the computer system 101 detects the hand 703b move in a downward direction with a respective magnitude relative to the three-dimensional environment 702 while the fingers of the hand 703b maintain the pinch hand shape (e.g., the index finger and thumb of the hand 703b remain in contact). In some embodiments, as discussed below, the computer system 101 moves the selection refinement user interface object 711a irrespective of a location of and/or movement of the attention (e.g., gaze 721) of the user in the virtual object 707.

Additionally, in FIG. 7B, the computer system 101 detects the hand 705b provide an air pinch gesture directed to the virtual object 709 in the three-dimensional environment 702. For example, as shown in FIG. 7B, the computer system 101 detects the hand 705b perform the air pinch gesture while the gaze 723 of the user is directed to the virtual object 709 in the three-dimensional environment 702. As described previously above, in some embodiments, the computer system 101 displays a selection refinement user interface object in the three-dimensional environment 702 that facilitates precise selection of a respective selectable option in the three-dimensional environment 702 in response to detecting an air gesture that satisfies the first set of criteria. In some embodiments, the first set of criteria includes a criterion that is satisfied when the air pinch gesture includes a first portion of the selection input, followed by a confirmation gesture, before a second portion of the selection input, as discussed in more detail below. From FIGS. 7B-7C, the computer system 101 determines that the air pinch gesture corresponds to the first portion of the selection input that is directed to the virtual object 709 in the three-dimensional environment 702.

In some embodiments, the first portion of the selection input, the confirmation gesture, and the second portion of the selection input are performed with the same portions of the hand 705b of the user. For example, the first portion of the selection input, the confirmation gesture, and the second portion of the selection input are performed with the index finger 712-2 and the thumb 712-1 of the hand 705b. In some embodiments, the first portion of the selection input corresponds to an air pinch gesture. For example, in FIG. 7B, the computer system 101 detects the index finger 712-2 and the thumb 712-1 of the hand 705b come together and make contact. From FIGS. 7B-7C, the computer system 101 optionally detects that the index finger 712-2 and the thumb 712-1 remain in contact (e.g., do not separate to release the pinch).

In some embodiments, as shown in FIG. 7C, in response to detecting the movement of the hand 703b in FIG. 7B, the computer system 101 moves the selection refinement user interface object 711a within the virtual object 707 in accordance with the movement of the hand of the user. For example, as shown in FIG. 7C, the computer system 101 moves the selection refinement user interface object 711a downward in the virtual object 707 based on the downward movement of the hand 703b in FIG. 7B. Additionally or alternatively, as shown in FIG. 7C, in some embodiments, the computer system 101 visually emphasizes a respective selectable option in the three-dimensional environment 702 based on the movement of the hand 703b in FIG. 7B. For example, as shown in FIG. 7C, the computer system 101 highlights (e.g., and/or boldens, underlines, increases a size of) the second selectable search result 708b in the virtual object 707 in response to detecting the downward movement of the hand 703b in FIG. 7B. As mentioned above, in some embodiments, the computer system 101 moves the selection refinement user interface object 711a based on the movement of the hand of the user irrespective of the location of the attention of the user in the three-dimensional environment 702. For example, as shown in FIG. 7C, the computer system 101 moves the selection refinement user interface object 711a (e.g., and/or highlights the second selectable search result 708b) in accordance with the movement of the hand 703b in FIG. 7B despite the gaze 721 remaining directed toward the first selectable search result 708a in the virtual object 708.

Additionally, in some embodiments, as shown in FIG. 7C, in response to detecting the first portion of the selection input performed by the hand 705b in FIG. 7B, the computer system 101 displays a visual indication 713 of the selection refinement user interface object in the virtual object 709 in the three-dimensional environment 702. For example, as shown in FIG. 7C, the computer system 101 displays a shadow/hint of the selection refinement user interface object in the virtual object 709 that indicates a location at which the selection refinement user interface object will be displayed in response to determining that the first set of criteria discussed above is satisfied, as described in more detail below. In some embodiments, the visual indication 713 is displayed at the location of the attention of the user in the three-dimensional environment 702. For example, as shown in FIG. 7C, the computer system 101 displays the visual indication 713 at the location of the gaze 723 in the virtual object 709 in the three-dimensional environment 702. In some embodiments, the visual indication 713 indicates a progress toward satisfying the first set of criteria and thus the display of the selection refinement user interface object in the virtual object 709. For example, as discussed in more detail below, an appearance of the visual indication 713 gradually changes (e.g., darkens and/or becomes more prominent) in accordance with a progression of satisfying the first set of criteria.

In some embodiments, while the selection refinement user interface object 711a is displayed (e.g., and/or while the second selectable search result 708b is highlighted) in the virtual object 707 in the three-dimensional environment 702, the computer system 101 performs a selection operation based on a location of the selection refinement cursor in response to detecting a release of the air pinch gesture (e.g., a de-pinch) provided by the hand of the user. For example, as mentioned above, the index finger 710-2 and the thumb 710-1 of the hand 703a in FIG. 7A remain in contact after performing the air pinch gesture and during the movement of the hand 703b in FIG. 7B. In FIG. 7C, the computer system 101 detects a release of the air pinch gesture provided by the hand 703c. For example, as shown in FIG. 7C, the computer system 101 detects the index finger 710-2 and the thumb 710-1 of the hand 703c separate such that they are no longer touching while the selection refinement user interface object 711a is displayed in the virtual object 707.

Additionally, in FIG. 7C, while the visual indication 713 is displayed in the virtual object 709, the computer system 101 detects a confirmation gesture. In some embodiments, the confirmation gesture is performed by the hand 705c. In some embodiments, the confirmation gesture corresponds to a pinch modification. In some embodiments, the pinch modification includes a modification of the shape of the pinch performed by the index finger 712-2 and the thumb 712-1 of the hand 705c. For example, in FIG. 7C, while the index finger 712-2 and the thumb 712-1 of the hand 705c are touching, the computer system 101 detects the index finger 712-2 and the thumb 712-1 expand (e.g., stretch) or contract (e.g., curl). In some embodiments, the pinch modification includes movement of a portion of the index finger 712-2 and the thumb 712-1 of the hand 705c toward the palm of the hand 705c. For example, in FIG. 7C, the computer system 101 detects the tips of the index finger 712-2 and thumb 712-1 curl toward the palm of the hand 705c while the index finger 712-2 and the thumb 712-1 are touching. In some embodiments, the confirmation gesture corresponds to a dwell of the attention of the user. For example, in FIG. 7C, the computer system detects the gaze 723 of the user directed toward the virtual object 709 for a threshold amount of time (e.g., 0.5, 0.75, 1, 2, 3, 5, 8, or 10 seconds), as indicated by time marker 714 in timeline 715, while the visual indication 713 is displayed in the virtual object 709. Additional details regarding the confirmation gesture are provided below with reference to method 800.

In some embodiments, as shown in FIG. 7D, in response to detecting the release of the air pinch gesture (e.g., de-pinch) provided by the hand 703c in FIG. 7C, the computer system 101 performs a selection operation in the three-dimensional environment 702 based on the location of the selection refinement user interface object 711a. For example, in FIG. 7C, the selection refinement user interface object 711a is displayed over the second selectable search result 708b when the de-pinch of the hand 703c is detected. Accordingly, as shown in FIG. 7D, the computer system 101 optionally activates the second selectable search result 708b and displays content associated with the second website (“www.URL2.com”) in the virtual object 707. For example, as shown in FIG. 7D, the computer system 101 navigates to the second website that contains scrollable text 716. In some embodiments, as shown in FIG. 7D, when the computer system 101 performs the selection operation in the three-dimensional environment 702, the computer system 101 ceases display of the selection refinement user interface object 711a. For example, as shown in FIG. 7D, the selection refinement user interface object is no longer displayed in the virtual object 707 in the three-dimensional environment 702.

In some embodiments, as described previously above, the computer system 101 displays the selection refinement user interface object in the three-dimensional environment 702 in response to detecting that the first set of criteria is satisfied. As described above, the first set of criteria includes a criterion that is satisfied when the computer system 101 detects a first portion of a selection input, such as the air pinch gesture provided by the hand 705c in FIG. 7C, followed by a confirmation gesture, such as the pinch modification provided by the hand 705d and/or the dwell of gaze 723 for the threshold amount of time, as indicated by the timeline 715 in FIG. 7D. As shown in FIG. 7D, in response to detecting the confirmation gesture in FIG. 7C and that the first set of criteria is satisfied, the computer system 101 optionally displays the selection refinement user interface object 711b in the virtual object 709 in the three-dimensional environment 702. In some embodiments, the first set of criteria is satisfied because the computer system 101 does not detect a second portion of the selection input (e.g., a de-pinch of the index finger and thumb of the hand 705c) after detecting the confirmation gesture. In some embodiments, as similarly described above, the computer system 101 displays the selection refinement user interface object 711b based on the attention of the user. For example, as shown in FIG. 7D, the computer system 101 displays the selection refinement user interface object 711b at the location of the gaze 723 in the virtual object 709 when the confirmation gesture in FIG. 7C is detected.

In some embodiments, as mentioned above, the computer system 101 gradually changes an appearance of the visual indication 713 in FIG. 7C to indicate a progress toward meeting the first set of criteria and the display of the selection refinement user interface object 711b in FIG. 7D. For example, from FIGS. 7C-7D, while detecting the confirmation gesture (e.g., the pinch modification performed by the hand 705c and/or the dwell of the attention (e.g., gaze 723) for the threshold amount of time), the computer system 101 gradually increases a visual prominence of the visual indication 713 (e.g., darkens and/or increases an opacity of the visual indication 713) until the first set of criteria is satisfied in response to detecting the confirmation gesture, at which point the computer system 101 displays the selection refinement user interface object 711b in place of the visual indication 713 in FIG. 7D. In some embodiments, if the computer system 101 determines that the confirmation gesture fails to be completed and the first set of criteria is not satisfied (e.g., because the attention of the user is directed away from the virtual object 709 before the threshold amount of time elapses and/or the hand 705c of the user does not complete the pinch modification), the computer system 101 forgoes displaying the selection refinement user interface object 711b in FIG. 7D. In some embodiments, the computer system 101 replaces display of the visual indication 713 with the selection refinement user interface object 711b in response to detecting the confirmation gesture (e.g., without gradually changing the appearance of the visual indication 713 as discussed above).

In FIG. 7D, the computer system 101 detects the hand 703d provide an input directed to the virtual object 707 in the three-dimensional environment 702. For example, as shown in FIG. 7D, the computer system 101 detects the hand 703d perform an air pinch gesture, followed by movement of the hand 703d in an upward direction, while the attention (e.g., gaze 721) of the user is directed toward the virtual object 707. In some embodiments, the computer system 101 detects the movement of the hand 703d within a threshold amount of time (e.g., 0.25, 0.5, 0.75, 1, 1.5, 2, 3, or 4 seconds) of detecting the air pinch gesture.

In some embodiments, the computer system 101 performs a scrolling operation in the three-dimensional environment 702 in accordance with a determination that the input provided by the hand of the user satisfies a third set of criteria (e.g., and does not satisfy the first and second sets of criteria discussed above). In some embodiments, the third set of criteria includes a criterion that is satisfied when the input includes movement of the hand of the user (e.g., in an upward or downward direction relative to the three-dimensional environment 702) within the threshold amount (above) of detecting the air pinch gesture. In FIG. 7E, in accordance with the determination that the input provided by the hand 703d satisfies the third set of criteria because the above criterion is satisfied, the computer system 101 performs a scrolling operation on the virtual object 707 in the three-dimensional environment 702 in accordance with the input. For example, as shown in FIG. 7E, the computer system 101 scrolls the text 716 displayed in the virtual object 707 in an upward direction in accordance with the upward movement of the hand 703d in FIG. 7D. As shown in FIG. 7E, the scrolling operation includes displaying additional text 716 in the virtual object 707 (e.g., wherein an amount of the additional text displayed is based on a magnitude (e.g., of speed and/or distance) of the movement of the hand 703d in FIG. 7D).

In some embodiments, as similarly described previously above with reference to FIG. 7C, while the selection refinement user interface object 711b is displayed in the three-dimensional environment 702, the computer system 101 moves the selection refinement user interface object 711b based on movement of the hand of the user. For example, the computer system 101 forgoes moving the selection refinement user interface object 711b in response to detecting movement of the attention of the user. In FIG. 7E, the computer system 101 detects movement of the gaze 723 to a new location in the virtual object 709 (e.g., away from the location of the gaze 723 in FIG. 7D). As shown in FIG. 7E, the computer system 101 optionally does not move the selection refinement user interface object 711b in accordance with the movement of the gaze 723.

FIG. 7C1 illustrates similar and/or the same concepts as those shown in FIG. 7C (with many of the same reference numbers). It is understood that unless indicated below, elements shown in FIG. 7D-1 that have the same reference numbers as elements shown in FIGS. 7A-7H have one or more or all of the same characteristics. FIG. 7C1 includes computer system 101, which includes (or is the same as) display generation component 120. In some embodiments, computer system 101 and display generation component 120 have one or more of the characteristics of computer system 101 shown in FIGS. 7C and 7A-7E and display generation component 120 shown in FIGS. 1 and 3, respectively, and in some embodiments, computer system 101 and display generation component 120 shown in FIGS. 7A-7E have one or more of the characteristics of computer system 101 and display generation component 120 shown in FIG. 7D-1.

In FIG. 7C1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user’s left and right eyes. Display generation component 120 also includes external image sensors 314b and 314c facing outwards from the user to detect and/or capture the physical environment and/or movements of the user’s hands. In some embodiments, image sensors 314a, 314b, and 314c have one or more of the characteristics of image sensors 314 described with reference to FIGS. 7A-7E.

In FIG. 7C1, display generation component 120 is illustrated as displaying content that optionally corresponds to the content that is described as being displayed and/or visible via display generation component 120 with reference to FIGS. 7A-7E. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user’s brain) to create the view of the content shown in FIG. 7C1.

Display generation component 120 has a field of view (e.g., a field of view captured by external image sensors 314b and 314c and/or visible to the user via display generation component 120, indicated by dashed lines in the overhead view) that corresponds to the content shown in FIG. 7C1. Because display generation component 120 is optionally a head-mounted device, the field of view of display generation component 120 is optionally the same as or similar to the field of view of the user.

In FIG. 7C1, the user is depicted as performing an air pinch gesture (e.g., with Hand 1703c and/or Hand 2 705c) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 7A-7E.

In some embodiments, computer system 101 responds to user inputs as described with reference to FIGS. 7A-7E.

In the example of FIG. 7C1, because the user’s hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7A-7E and/or described with reference to the corresponding method(s) are optionally implemented on computer system 101 and display generation unit 120 in a manner similar or analogous to that shown in FIG. 7C1.

FIGS. 8A-8J is a flowchart illustrating an exemplary method 800 of displaying a selection refinement user interface object in a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4,) (e.g., a heads-up display, a display, a touchscreen, a projector, etc.) and one or more cameras (e.g., a camera (e.g., color sensors, infrared sensors, and other depth-sensing cameras) that points downward at a user’s hand or a camera that points forward from the user’s head). In some embodiments, the method 800 is governed by instructions that are stored in a non-transitory computer-readable storage medium and that are executed by one or more processors of a computer system, such as the one or more processing units 202 of computer system 101 (e.g., controller 110 in FIG. 1A). Some operations in method 800 are, optionally, combined and/or the order of some operations is, optionally, changed.

In some embodiments, method 800 is performed at a computer system (e.g., 101) in communication with a display generation component (e.g., 120) and one or more input devices (e.g., 314). For example, the computer system is or includes a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, and/or detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, while displaying, via the display generation component, a first object in an environment, such as object 707 or 709 in three-dimensional environment 702 in FIG. 7A, the computer system detects (802a), via the one or more input devices, a first air gesture performed by a first portion of a user of the computer system directed to the first object, such as an air gesture performed by hand 703a or hand 705a as shown in FIG. 7A. For example,

the computer system displays an environment that corresponds to a physical environment surrounding the display generation component and/or the computer system or a virtual environment. In some embodiments, the environment is a three-dimensional environment. In some embodiments, the three-dimensional environment is generated, displayed, or otherwise caused to be viewable by the computer system (e.g., an extended reality (XR) environment such as a virtual reality (VR) environment, a mixed reality (MR) environment, and/or an augmented reality (AR) environment). In some embodiments, the physical environment is visible through a transparent portion of the display generation component (e.g., true or real passthrough). In some embodiments, a representation of the physical environment is displayed in the three-dimensional environment via the display generation component (e.g., virtual or video passthrough). In some embodiments, the first object is or includes or is included in content, such as a window of a web browsing application displaying content (e.g., text, images, or video), as similarly shown in object 707 in FIG. 7A, a window displaying a photograph or video clip, a media player window for controlling playback of content items on the computer system, as similarly shown in object 709 in FIG. 7A, a contact card in a contacts application displaying contact information (e.g., phone number email address, and/or birthday) and/or a virtual boardgame of a gaming application. In some embodiments, the first object includes or is or corresponds to one or more selectable options that are selectable to perform one or more corresponding operations associated with the first object, as described in more detail below. In some embodiments, the first object is displayed at a first location in the three-dimensional environment. In some embodiments, while displaying the first object at the first location in the three-dimensional environment, the computer system detects a first air gesture performed by a hand of the user of the computer system directed to the first object. For example, the computer system detects the first air gesture while attention (e.g., gaze) of the user is directed toward the first object, such as gaze 721 or 723 in FIG. 7A. In some embodiments, the first air gesture is performed using two or more fingers of the user (e.g., the thumb, index, middle, ring, and/or pinky fingers of the user), as described in more detail herein below. In some embodiments, the first air gesture is directed to a respective location in the first object that includes a selectable option. For example, the computer system detects the first air gesture while the gaze of the user is directed to the respective location in the first object that includes the selectable option.

In some embodiments, in response to detecting the first air gesture (802b), in accordance with a determination that the first air gesture satisfies a first set of interaction criteria (e.g., based on a position and/or movement of the first portion of the user), the computer system concurrently displays (802c), via the display generation component, a selection refinement user interface object with the first object in the environment, such as selection refinement user interface object 711a in FIG. 7B, wherein the selection refinement user interface object indicates a respective object (e.g., a selectable option within the first object, such as selectable option 708a in FIG. 7B) that will be selected in response to further input (and without selecting the first object or another selectable object). In some embodiments, the first set of interaction criteria are satisfied in accordance with a determination that the first air gesture includes a first portion of a selection input, such as an air pinch gesture (e.g., in which the thumb and index finger of the hand of the user start more than a threshold distance (e.g., 0.1, 0.2, 0.5, 1, 2, or 5 cm) apart and come together and touch at the tips) directed to the first object, followed by a confirmation gesture. For example, the first interaction criteria are satisfied if the computer system detects the user perform the first portion of the selection input, followed by the confirmation gesture, before detecting a second portion of the selection input, such as a release (e.g., a de-pinch) of the air pinch shape (e.g., in which the thumb and index finger of the hand of the user are no longer touching). In some embodiments, as described in more detail below, the confirmation gesture includes a modification of the air pinch shape formed by the air pinch gesture (e.g., the first portion of the selection input). For example, as described below, the modification includes changing a shape of the air pinch shape (e.g., by moving one or more fingers of the user), and/or moving the tips of portions of the fingers of the user relative to the palm of the hand of the user. In some embodiments, the confirmation gesture includes the attention of the user directed toward the first object for a threshold amount of time (e.g., 0.5, 0.75, 1, 2, 3, 4, 5, 10, 12, or 15 seconds). In some embodiments, as described below, the first set of interaction criteria is satisfied if the computer system detects the hand of the user perform a first type of air gesture in a first pose. For example, the first type of air gesture in the first pose includes an air pinch gesture provided by at least a first portion of an index finger (e.g., a tip of the index finger) and thumb of the user. In some embodiments, if the computer system determines that the first set of interaction criteria are satisfied (e.g., in accordance with the above), the computer system displays a selection refinement user interface object in the first object in the three-dimensional environment without

performing a selection of the selectable option at the respective location of the first object, such as display of selection refinement user interface object 711a in virtual object 707 without selection of the selectable option 708a as shown in FIG. 7B. In some embodiments, the selection refinement user interface object includes or is a refinement cursor that is displayed over a surface of the first object. In some embodiments, the refinement cursor is displayed at a location that is based on the attention of the user in the first object. For example, the computer system displays the refinement cursor within 0, 0.5, 0.75, 1, 2, 3, or 5 cm of the location of the gaze of the user when the first air gesture is detected, such as display of the selection refinement user interface object 711a at location of the gaze 721 as shown in FIG. 7B. In some embodiments, the refinement cursor indicates a location in the first object at which a selection operation will be performed in response to further input. For example, as described in more detail below, the computer system performs a selection operation at a location of the first object at which the refinement cursor is located in response to detecting the second portion of the selection input discussed above (e.g., a de-pinch gesture). In some embodiments, the selection operation includes activation of the selectable option that is located at the location of the refinement cursor in the first object.

In some embodiments, in accordance with a determination that the first air gesture satisfies a second set of interaction criteria (e.g., based on a position and/or movement of the first portion of the user), different from the first set of interaction criteria (and/or does not satisfy the first set of interaction criteria), the computer system performs (802d) a selection directed to the first object in the environment, such as selection of selectable option 704a in virtual object 709 as shown in FIG. 7A, without displaying the refinement user interface object in the environment (e.g., without displaying the refinement cursor at a location in the first object that is based on the attention of the user when the first air gesture is detected). In some embodiments, the second set of interaction criteria are satisfied in accordance with a determination that the first air gesture includes the first portion of a selection input described above followed by second portion of the selection input described above. For example, the second set of interaction criteria are satisfied if the computer system detects the hand of the user perform an air pinch gesture, followed by a release of the air pinch gesture (e.g., in which the index finger and thumb of the user are no longer touching), without detecting a confirmation gesture between the first and second portions of the selection input discussed above. In some embodiments, as described below, the second set of interaction criteria are satisfied if the computer system detects the hand of the user perform a second type of air gesture in a second pose, different from the first pose above. For example, the second type of air gesture in the second pose includes an air pinch gesture provided by at least a second portion of the index finger (e.g., an inner/middle portion of the index finger) and thumb of the user. In some embodiments, the second type of air gesture in the second pose includes an air pinch gesture provided by a finger different from the index finger (e.g., the middle or ring finger) and the thumb of the user. In some embodiments, if the computer system detects that the second set of interaction criteria are satisfied, the computer system performs the selection operation directed to the first object in the three-dimensional environment. For example, the computer system activates the selectable option that is located at or near (e.g., within 0, 0.5, 1, 1.5, 2, 3, 5, or 10 cm of) the location of the attention of the user in the first object when the first air gesture is detected. In some embodiments, activating the selectable option includes controlling playback of content in the first object (e.g., initiating playback, scrubbing through content, and/or pausing the content), such as initiating playback of “Content A” in virtual object 709 as shown in FIG. 7B, initiating a process to transmit a message to a second user, different from the user of the computer system (e.g., displaying a soft keyboard with a text-entry field in the first object within a messaging user interface), displaying an image, a document, and/or other file, and/or initiating output of audio (e.g., audio corresponding to music, a podcast, and/or an audiobook), among other possibilities. Displaying a refinement user interface object that indicates a location at which a selection operation will be performed in response to further input in response to detecting an air gesture that satisfies a first set of criteria improves accuracy for performing the selection operation and/or reduces the number of inputs needed to display the refinement user interface object, thereby improving user-device interaction.

In some embodiments, the first set of interaction criteria includes a criterion that is satisfied when the first air gesture includes a first portion of a selection gesture (e.g., a beginning of an air pinch gesture), followed by a confirmation gesture (e.g., a modification of the air pinch gesture), before a second portion of the selection gesture (e.g., an end of the air pinch gesture) is detected (804), as similarly discussed with reference to FIGS. 7B-7C and 7C1. For example, the first air gesture satisfies the first set of interaction criteria if the computer system detects that the first air gesture includes the first portion of the air pinch gesture, followed by a modification of the air pinch gesture, before an end of the air pinch gesture. In some embodiments, the computer system detects the beginning of the air pinch gesture when a first finger (e.g., an index finger, such as index finger 712-2 of hand 705c in FIGS. 7C and 7C1) and a second finger (e.g., thumb, such as thumb 712-1 of hand 705c in FIGS. 7C and 7C1) of the hand of the user come together to form the air pinch gesture and remain in contact (e.g., the index finger and the thumb perform a pinch and hold), without detecting a separation of the first finger and the second finger of the hand. In some embodiments, the computer system detects the modification of the air pinch gesture when the first finger and the second finger of the hand that are in contact move to change a shape of the air pinch gesture (e.g., while remaining in contact), as described in more detail below with reference to steps 802a-802d. In some embodiments, the computer system detects the end of the air pinch gesture when the first finger and the second finger that are in contact separate such that the first finger and the second finger of the hand are no longer in contact. Accordingly, as outlined above, the first set of interaction criteria are optionally satisfied when the first air gesture includes the beginning of the air pinch gesture followed by a modification of the air pinch gesture, before the end of the air pinch gesture. In some embodiments, the first set of interaction criteria is not satisfied if the first air gesture includes the beginning of the air pinch gesture followed by the end of the air pinch gesture (e.g., without detecting a modification of the air pinch gesture). Displaying a refinement user interface object that indicates a location at which a selection operation will be performed in response to further input in response to detecting an air gesture that includes a first portion of a selection input followed by a confirmation gesture improves accuracy for performing the selection operation and/or reduces the number of inputs needed to display the refinement user interface object, thereby improving user-device interaction.

In some embodiments, the first portion of the user includes a hand of the user (806a), such as hand 703a or 705a in FIG. 7A. In some embodiments, the first portion of the selection gesture, the confirmation gesture, and the second portion of the selection gesture are performed with a same portion of the hand of the user (806b), such as the same fingers 710 or 712 of the hand of the user as shown in FIG. 7A. For example, as similarly described above with reference to step 804, the first portion of the selection gesture, the confirmation gesture, and the second portion of the selection gesture are performed with the fingers of the hand of the user. In some embodiments, the first portion of the selection gesture, the confirmation gesture, and the second portion of the selection gesture are performed with the same fingers of the hand of the user, such as the index finger (e.g., index finger 712-2 in FIGS. 7C and 7C1) and the thumb (e.g., thumb 712-1 in FIGS. 7C and 7C1) of the hand, as similarly described above with reference to step 804. Displaying a refinement user interface object that indicates a location at which a selection operation will be performed in response to further input in response to detecting an air gesture that includes a first portion of a selection input followed by a confirmation gesture performed by a hand of the user improves accuracy for performing the selection operation and/or reduces the number of inputs needed to display the refinement user interface object, thereby improving user-device interaction.

In some embodiments, the first portion of the selection gesture corresponds to an air pinch gesture (e.g., the index finger and the thumb of the user coming together and remaining in contact, such as contact between the index finger 712-2 and the thumb 712-1 of the hand 705b in FIG. 7B), the confirmation gesture corresponds to a modification of the air pinch gesture (e.g., moving the index finger and the thumb of the user while the index finger and the thumb maintain contact), and the second portion of the selection gesture corresponds to a release (e.g., an end) of the air pinch gesture (808) (e.g., as similarly described above with reference to step 804). Displaying a refinement user interface object that indicates a location at which a selection operation will be performed in response to further input in response to detecting an air gesture that includes a first portion of an air pinch gesture followed by a modification of the air pinch gesture improves accuracy for performing the selection operation and/or reduces the number of inputs needed to display the refinement user interface object, thereby improving user-device interaction.

In some embodiments, the modification of the air pinch gesture includes a change of a shape of the air pinch gesture (810), as similarly described with reference to FIGS. 7C and 7C1. For example, when the index finger and the thumb of the hand come together to perform the air pinch gesture and remain in contact, such as the index finger 712-2 and the thumb 712-1 of the hand 705b in FIG. 7B, the index finger and the thumb create a first shape (e.g., the index finger and the thumb form an “O-shape” as detected by the computer system). In some embodiments, the modification of the air pinch gesture includes changing the shape of the air pinch gesture, such that the index finger and the thumb create a second shape, different from the first shape (e.g., the index finger and the thumb move/shift to form an elliptical/oval shape). In some embodiments, the computer system detects the modification of the air pinch gesture while the first finger and the second finger of the hand of the user remain in contact. For example, the computer system detects the index finger and the thumb of the hand move to create the second shape while remaining in contact (e.g., at the fingertips). Displaying a refinement user interface object that indicates a location at which a selection operation will be performed in response to further input in response to detecting an air gesture that includes a first portion of an air pinch gesture followed by a modification of a shape of the air pinch gesture improves accuracy for performing the selection operation and/or reduces the number of inputs needed to display the refinement user interface object, thereby improving user-device interaction.

In some embodiments, the first portion of the user includes a hand of the user (812a), such as hand 703a or 705a in FIG. 7A. In some embodiments, the air pinch gesture is performed with at least a first finger (e.g., index finger, such as index finger 712-2 of the hand 705c in FIGS. 7C and 7C1) and a second finger (e.g., thumb, such as thumb 712-1 of the hand 705c in FIGS. 7C and 7C1) of the hand (812b). In some embodiments, the modification of the air pinch gesture includes movement of a first portion of the first finger (e.g., a tip of the index finger) and the first portion of the second finger (e.g., a tip of the thumb) toward a palm of the hand (812c), such as movement of the index finger 712-2 and the thumb 712-1 toward the palm of the hand 705c as similarly described with reference to FIGS. 7C and 7C1. For example, while the tip of the index finger and the tip of the thumb are in contact after performing the air pinch gesture, the computer system detects the tips of the index finger and the thumb curl toward the palm of the hand. In some embodiments, the computer system detects the tips of the index finger and the thumb curl toward the palm of the hand while the fingertips remain in contact. Displaying a refinement user interface object that indicates a location at which a selection operation will be performed in response to further input in response to detecting an air gesture that includes a first portion of an air pinch gesture followed by movement of the fingertips of the fingers of the hand performing the air pinch gesture improves accuracy for performing the selection operation and/or reduces the number of inputs needed to display the refinement user interface object, thereby improving user-device interaction.

In some embodiments, the movement of the first portion of the first finger (e.g., tip of index finger 712-2 of the hand 705c in FIGS. 7C and 7C1) and the first portion of the second finger (e.g., tip of thumb 712-1 of the hand 705c in FIGS. 7C and 7C1) toward the palm of the hand includes movement of a centroid (e.g., the distal interphalangeal joint) of the first portion of the first finger and the first portion of the second finger toward a predefined portion of the hand by more than a threshold amount (816) (e.g., of distance, such as 0.1, 0.25, 0.5, 0.75 1, 1.5, 2, 3, or 5 cm), as similarly described with reference to FIGS. 7C and 7C1. For example, while the tip of the index finger and the tip of the thumb are in contact after performing the air pinch gesture, the computer system detects the distal interphalangeal joint of the index finger of the hand move more than the threshold amount in space toward the palm of the hand of the user. In some embodiments, the computer system detects the distal interphalangeal joint of the index finger move toward the palm of the hand while the tip of the index finger remains in contact with the tip of the thumb of the hand. In some embodiments, the threshold amount is measured relative to a location in space at which the first finger and the second finger of the hand performed the air pinch gesture. For example, the starting location from which the movement of the distal interphalangeal joint of the index finger is measured (e.g., for determining the threshold amount of movement) is the location in space at which the tip of the index finger and the tip of the thumb came together to perform the air pinch gesture. Displaying a refinement user interface object that indicates a location at which a selection operation will be performed in response to further input in response to detecting an air gesture that includes a first portion of an air pinch gesture followed by movement of a centroid of a first finger of the hand performing the air pinch gesture improves accuracy for performing the selection operation and/or reduces the number of inputs needed to display the refinement user interface object, thereby improving user-device interaction.

In some embodiments, the confirmation gesture includes attention (e.g., gaze, such as gaze 723 in FIGS. 7C and 7C1) of the user directed to the first object in the environment for more than a threshold amount of time (816) (e.g., 0.5, 1, 2, 3, 4, 5, 8, 10, or 12 seconds), such as gaze 723 directed to the virtual object 709 for more than the threshold amount of time represented by time marker 714 as shown in FIG. 7D. For example, the first air gesture satisfies the first set of interaction criteria if the computer system detects the first finger (e.g., index finger) and the second finger (e.g., thumb) of the hand of the user perform an air pinch gesture, as similarly described above with reference to step 804, followed by the attention of the user directed to the first object for more than the threshold amount of time. In some embodiments, the first set of interaction criteria is satisfied if the computer system determines that the attention of the user is directed toward the first object in the three-dimensional environment for more than the threshold amount of time while the first finger and the second finger of the hand remain in contact. Displaying a refinement user interface object that indicates a location at which a selection operation will be performed in response to further input in response to detecting an air gesture that includes a first portion of an air pinch gesture followed by attention of the user directed to the location for a threshold amount of time improves accuracy for performing the selection operation and/or reduces the number of inputs needed to display the refinement user interface object, thereby improving user-device interaction.

In some embodiments, while concurrently displaying the selection refinement user interface object with the first object in the environment in accordance with the determination that the first air gesture satisfies the first set of interaction criteria, such as while displaying the selection refinement user interface object 711a in the virtual object 707 as shown in FIG. 7B, the computer system detects (818a), via the one or more input devices, a change in a location associated with the first air gesture from a first location to a respective location, different from the first location, such as movement of the hand 703b as shown in FIG. 7B. For example, as described in more detail below with reference to step 820, detecting the change in the location associated with the first air gesture includes detecting movement of the hand of the user in space. In some embodiments, the computer system moves the selection refinement user interface object to the respective location in the first object in accordance with the movement of the hand of the user, such as movement of the selection refinement user interface object 711a in the virtual object 707 in accordance with the movement of the hand 703b as shown in FIGS. 7C and 7C1. In some embodiments, changing the location associated with the first air gesture from the first location to the respective location is independent of changes in the attention of the user. For example, if the computer system detects that the attention of the user remains directed to the first location during the movement of the hand of the user, as similarly shown by gaze 721 in FIGS. 7C and 7C1, and/or that the attention of the user is directed to a second respective location, different from the respective location, the computer system moves the selection refinement user interface object to the respective location in accordance with the movement of the hand.

In some embodiments, after detecting the change in the location associated with the first air gesture and while the location associated with the first air gesture is at the respective location, the computer system detects (818b), via the one or more input devices, a release of the first air gesture, as similarly described with reference to FIGS. 7C and 7C1. For example, while the selection refinement user interface object is displayed at the respective location in the first object, the computer system detects an end of the first air gesture. The computer system optionally detects the index finger and the thumb of the hand of the user separate such that the index finger and the thumb are no longer in contact, such as separation of the index finger 710-2 and the thumb 710-1 of the hand 703c in FIGS. 7C and 7C1.

In some embodiments, in response to detecting the release of the first air gesture (818c), in accordance with a determination that the respective location is a second location, such as a location of selectable option 708b in FIGS. 7C and 7C1, the computer system performs (818d) a first operation associated with the first object based on the second location, such as activation of the selectable option 708b as shown in FIG. 7D. For example, the computer system detects the release of the first air gesture while the selection refinement user interface object is located (displayed) at the second location in the first object, the computer system performs the first operation associated with the first object at the second location in the first object. In some embodiments, performing the first operation includes performing a selection operation at the second location in the first object. For example, similarly described above with reference to steps 802a-802d, the computer system activates a selectable option that is displayed at the second location in the first object, such as activating the selectable option 708b, which causes the virtual object 707 to display text content 716 as shown in FIG. 7D. In some embodiments, the computer system performs the selection operation near the second location in the first object. For example, the computer system activates a selectable option that is within a threshold distance (e.g., 0.25. 0.75, 1, 2, 3, 4, 5, or 10 cm) of the second location in the first object if the selection refinement user interface object is located at the second location when the release of the first air gesture is detected.

In some embodiments, in accordance with a determination that the respective location is a third location, different from the second location, such as a location of selectable option 708c in FIGS. 7C and 7C1, the computer system performs (818e) a second operation associated with the first object based on the third location, such as activation of the selectable option 708c of the virtual object 707. For example, the computer system detects the release of the first air gesture while the selection refinement user interface object is located (displayed) at the third location in the first object, the computer system performs the first operation associated with the first object at the third location in the first object. In some embodiments, performing the first operation includes performing a selection operation at the third location in the first object. For example, similarly described above with reference to steps 802a-802d, the computer system activates a selectable option that is displayed at the third location in the first object. In some embodiments, the computer system performs the selection operation near the third location in the first object. For example, the computer system activates a selectable option that is within a threshold distance (e.g., 0.25. 0.75, 1, 2, 3, 4, 5, or 10 cm) of the third location in the first object if the selection refinement user interface object is located at the third location when the release of the first air gesture is detected. Performing a selection operation at a location that changes in response to a change in location associated with an air gesture in response to detecting a release of the air gesture improves accuracy for performing the selection operation and/or reduces the number of inputs needed to perform the selection operation, thereby improving user-device interaction.

In some embodiments, the change in the location associated with the first air gesture corresponds to movement of the first portion of the user relative to the environment (step 820), such as movement of the hand 703b as shown in FIG. 7B. For example, as described above with reference to steps 818a-818e, the computer system detects movement of the hand of the user in space relative to the three-dimensional environment. In some embodiments, the location associated with the first air gesture changes in accordance with a direction and/or a magnitude (e.g., of speed and/or direction) of the movement of the hand of the user. For example, if the computer system detects movement of the hand of the user in a first direction (e.g., rightward) in space with a respective magnitude, the computer system moves the selection refinement user interface object away from the first location in the first object in the first direction and with a first magnitude based on the respective magnitude. If the computer system detects the movement of the hand of the user in a second direction (e.g., leftward), different from the first direction, in space with the respective magnitude, the computer system optionally moves the selection refinement user interface object away from the first location in the first object in the second direction and with the first magnitude. In some embodiments, the computer system detects the movement of the hand of the user while the hand maintains the air pinch gesture (e.g., while the index finger and the thumb of the user remain in contact). Performing a selection operation at a location that changes in response to movement of the hand of the user in response to detecting a release of the air gesture improves accuracy for performing the selection operation and/or reduces the number of inputs needed to perform the selection operation, thereby improving user-device interaction.

In some embodiments, the first set of interaction criteria includes a criterion that is satisfied when the first air gesture corresponds to a first type of gesture with the first portion of the user in a first pose (822a), as similarly described with reference to FIG. 7A. For example, the first set of interaction criteria is satisfied if the computer system detects that the first air gesture is a first type of gesture performed while the hand of the user is in a first pose. In some embodiments, the first type of gesture is an air pinch gesture provided by the hand of the user. For example, the computer system detects a first finger (e.g., index finger, such as index finger 710-2 of the hand 703a) and a second finger (e.g., thumb, such as thumb 710-1 of the hand 703a in FIG. 7A) of the hand of the user come together and make contact to form the air pinch gesture. In some embodiments, the first set of interaction criteria is satisfied when the computer system detects the air pinch gesture while the hand of the user is in the first pose. For example, the first pose includes one or more variations of the air pinch gesture, as similarly described with reference to FIG. 7A. Additional details regarding the first pose are provided below with reference to steps 824a-832b.

In some embodiments, the second set of interaction criteria includes a criterion that is satisfied when the first air gesture corresponds to a second type of gesture, different from the first type, with the first portion of the user in a second pose, different from the first pose (822b), as similarly described with reference to FIG. 7A. For example, the second set of interaction criteria is satisfied if the computer system detects that the first air gesture is a second type of gesture performed while the hand of the user is in a second pose. In some embodiments, the second type of gesture is an air pinch gesture provided by the hand of the user. For example, the computer system detects a first finger (e.g., index finger or middle finger, such as index finger 712-2 or middle finger 712-3 of the hand 705a in FIG. 7A) and a second finger (e.g., thumb, such as thumb 712-1 of the hand 705a in FIG. 7A) of the hand of the user come together and make contact to form the air pinch gesture. In some embodiments, the second set of interaction criteria is satisfied when the computer system detects the air pinch gesture while the hand of the user is in the second pose. For example, the second pose includes one or more variations of the air pinch gesture, as similarly described with reference to FIG. 7A. Additional details regarding the second pose are provided below with reference to steps 824a-832b. Displaying a refinement user interface object that indicates a location at which a selection operation will be performed in response to further input in response to detecting an air gesture of a first type while the hand of the user is in a first pose improves accuracy for performing the selection operation and/or reduces the number of inputs needed to display the refinement user interface object, thereby improving user-device interaction.

In some embodiments, the first pose corresponds to a pinch pose in which a first portion (e.g., tip) of a first finger of a hand of the user is in contact with a first portion (e.g., tip) of a second finger of the hand of the user (824a), such as contact between index finger 710-2 and thumb 710-1 of the hand 703a in FIG. 7A. For example, the first set of interaction criteria is satisfied if the computer system determines that the air pinch gesture provided by the hand of the user is detected while the hand is in a pinch pose. In some embodiments, detecting the pinch pose includes detecting the first finger of the hand and the second finger of the hand described above with reference to steps 822a-822b are curled and in contact while the remaining fingers of the hand are uncurled/relaxed and are not in contact with the second finger, as similarly described with reference to FIG. 7A. For example, while the index finger and the thumb of the hand are curled and in contact to perform the air pinch gesture, the computer system detects that the middle finger (e.g., middle finger 710-3), the ring finger (e.g., ring finger 710-4), and/or the pinky finger (e.g., pinky finger 710-5 of the hand 703a in FIG. 7A) of the hand are uncurled/relaxed (e.g., outstretched/pointed or resting against the palm of the hand) and are not also in contact with the thumb of the hand.

In some embodiments, the second pose corresponds to a clicker pose in which the first portion of the second finger of the hand of the user is in contact with a second portion, different from the first portion, of the first finger of the hand of the user (824b), such as contact between thumb 712-1 and index finger 712-2 of the hand 705a in FIG. 7A. For example, the second set of interaction criteria is satisfied if the computer system determines that the air pinch gesture provided by the hand of the user is detected while the hand is in a clicker pose. In some embodiments, detecting the clicker pose includes detecting that the second finger (e.g., thumb) of the hand contacts a portion of the first finger (e.g., index finger) of the hand described above with reference to steps 822a-822b while the first finger is curled (e.g., in a “C-shape”). Additional details regarding the clicker pose are described below with reference to steps 826a-826f. Displaying a refinement user interface object that indicates a location at which a selection operation will be performed in response to further input in response to detecting an air gesture of a first type while the hand of the user is in a pinch pose improves accuracy for performing the selection operation and/or reduces the number of inputs needed to display the refinement user interface object, thereby improving user-device interaction.

In some embodiments, the second pose corresponds to the clicker pose when (826a) a first axis (e.g., a vertical axis) aligned with a palm of the hand (e.g., the palm of the hand 705a in FIG. 7A) is within an angular threshold (e.g., 0, 1, 2, 5, 8, 10, 12, 15, 20, or 30 degrees) of being perpendicular to a second axis (e.g., a horizontal axis) that is within an angular threshold (e.g., 0, 1, 2, 5, 8, 10, 12, 15, 20, or 30 degrees) of being horizontal relative to a viewpoint of the user (826b). For example, the palm of the hand is oriented vertical in space relative to the viewpoint of the user. In some embodiments, a first finger of the hand (e.g., thumb of the hand, such as thumb 712-1 of the hand 705a in FIG. 7A) is positioned within a threshold distance (e.g., 0.1, 0.25, 0.5, 0.75, 0.9, 1, 1.5, 2, 3, 5, or 8 cm) of a second finger (e.g., index finger, such as index finger 712-2 of the hand 705a in FIG. 7A) of the hand (826c). For example, the thumb of the hand of the user is positioned the threshold distance away from (e.g., above) the index finger of the hand. In some embodiments, the computer system detects the first finger of the hand positioned within the threshold distance of (e.g., above) a medial portion of the second finger of the hand. For example, the computer system detects the thumb positioned above the portion of the index finger of the hand that includes the medial phalange.

In some embodiments, the first finger (e.g., thumb 712-1 of the hand 705a in FIG. 7A) is positioned within the threshold distance (e.g., 0.1, 0.25, 0.5, 0.75, 0.9, 1, 1.5, 2, 3, 5, or 8 cm) of the second finger (e.g., index finger 712-2 in FIG. 7A) for at least a threshold amount of time (826d) (e.g., 0.25, 0.5, 0.75, 1, 1.5, 2, 3, 4, or 5 seconds). For example, the thumb of the hand of the user is positioned the threshold distance away from (e.g., above) the index finger of the hand for the threshold amount of time. In some embodiments, the computer system detects the first finger of the hand positioned within the threshold distance of (e.g., above) a medial portion of the second finger of the hand for the threshold amount of time. For example, the computer system detects the thumb positioned above the portion of the index finger of the hand that includes the medial phalange for the threshold amount of time.

In some embodiments, the first finger contacts the second finger a respective number of times (826e) (e.g., 1, 2, 3, 4, or 5 times), such as tapping of the thumb 712-1 onto the index finger 712-2 the respective number of times in FIG. 7A. For example, starting from the threshold distance above the index finger of the hand, the thumb contacts the index finger the respective number of times. In some embodiments, as similarly discussed above, the computer system detects the first finger contact a medial portion (e.g., spanning the medial phalange) of the second finger the predefined number of times.

In some embodiments, a first subset of one or more fingers, other than the first finger, of the hand are curled by more than a threshold amount (826f) (e.g., of angular offset and/or distance), such as curling of index finger 712-2, middle finger 712-3, ring finger 712-4, and/or pinky finger 712-5 of the hand 705a in FIG. 7A. For example, the index finger, the middle finger, the ring finger, and/or the pinky finger of the hand are curled (e.g., in a “C-shape” with the palm) more than the threshold amount, while the thumb (e.g., thumb 712-1 of the hand 705a in FIG. 7A) of the hand is not curled (e.g., the thumb is positioned above the index finger as discussed above). In some embodiments, the first subset of the one or more fingers of the hand are curled more than the threshold amount if the first subset of the one or more fingers are curled more than a threshold angle relative to first axis above aligned with the palm of the hand. For example, one or more axes aligned with the first subset of the one or more fingers is offset from the first axis by more than 10, 15, 20, 30, 40, 45, 60, 75, 90, or 110 degrees. In some embodiments, as similarly described above with reference to steps 802a-802d, if the computer system determines that the second set of interaction criteria is satisfied because the first air gesture is provided while the hand of the user is in the clicker pose (defined by one or more of the above conditions), the computer system performs a selection directed to the first object in the three-dimensional environment. Performing a selection operation directed to an object in the three-dimensional in response to detecting an air gesture of a second type while the hand of the user is in a clicker pose helps avoid unintentional performance of the selection operation and/or reduces the number of inputs needed to perform the selection operation, thereby improving user-device interaction.

In some embodiments, the first pose includes an air pinch gesture in which a first portion of a first finger (e.g., a tip of the index finger) of a hand of the user is contacting a second finger (e.g., thumb) of the hand (828a), such as contact between a tip of index finger 710-2 and thumb 710-1 of the hand 703a in FIG. 7A. For example, the first set of interaction criteria is satisfied if the computer system detects the air pinch gesture that includes the tip of the index finger of the hand contacting the thumb of the hand.

In some embodiments, the second pose includes an air pinch gesture in which a second portion, different from the first portion, of the first finger (e.g., medial and/or side portion (excluding the tip) of the index finger) of the hand is contacting the second finger of the hand (828b), such as contact between a side portion of index finger 712-2 and thumb 712-1 of the hand 705a in FIG. 7A. For example, the second set of interaction criteria is satisfied if the computer system detects the air pinch gesture that includes the thumb of the hand contacting the medial and/or side portion of the index finger. The computer system optionally detects the thumb of the hand contact the portion of the index finger that includes the medial phalanx and does not detect the thumb contact the tip of the index finger. Displaying a refinement user interface object that indicates a location at which a selection operation will be performed in response to further input in response to detecting an air gesture of a first type in which a first portion of a first finger is contacting a second finger of the hand of the user improves accuracy for performing the selection operation and/or reduces the number of inputs needed to display the refinement user interface object, thereby improving user-device interaction.

In some embodiments, the first pose includes an air pinch gesture in which a first finger (e.g., index finger) of a hand of the user is contacting a second finger (e.g., thumb) of the hand (830a), such as contact between index finger 710-2 and thumb 710-1 of the hand 703a in FIG. 7A. For example, the first set of interaction criteria is satisfied if the computer system detects the air pinch gesture that includes the index finger of the hand contacting the thumb of the hand. In some embodiments, the computer system detects the tip of the index finger contact the tip of the thumb of the hand.

In some embodiments, the second pose includes an air pinch gesture in which a third finger (e.g., middle finger or ring finger), different from the first finger and the second finger, is contacting the second finger of the hand (830b), such as contact between middle finger 712-3 or ring finger 712-4 and thumb 712-1 of the hand 705a in FIG. 7A. For example, the second set of interaction criteria is satisfied if the computer system detects the air pinch gesture that includes the middle finger or the ring finger of the hand contacting the thumb. In some embodiments, the computer system detects the middle finger or the ring finger contact the thumb at the fingertips. Displaying a refinement user interface object that indicates a location at which a selection operation will be performed in response to further input in response to detecting an air gesture of a first type in which a first finger is contacting a second finger of the hand of the user improves accuracy for performing the selection operation and/or reduces the number of inputs needed to display the refinement user interface object, thereby improving user-device interaction.

In some embodiments, the first pose includes an air pinch gesture in which a first finger (e.g., index finger) of a hand of the user is detected as contacting a second finger (e.g., thumb) of the hand and fingers other than the first finger and the second finger of the hand are positioned in a first shape (832a) (e.g., in an out-stretched and/or pointed shape in which the fingers other than the first finger and the second finger are pointed away from the palm of the hand), such as contact between index finger 710-2 and thumb 710-1 of the hand 703a in FIG. 7A while middle finger 710-3, ring finger 710-4, and/or pinky finger 710-5 are pointed away from the palm of the hand 703a. For example, the first set of interaction criteria is satisfied if the computer system detects an air pinch gesture that includes the index finger of the hand contacting the thumb of the hand, while the remaining fingers (e.g., the middle finger, ring finger, and/or pinky finger) are pointed/angled away from the palm of the hand. In some embodiments, the computer system detects the fingers other than the first finger and the second finger are positioned in the first shape prior to and after detecting the first finger and the second finger of the hand are in contact.

In some embodiments, the second pose includes an air pinch gesture in which the first finger (e.g., index finger) of the hand is detected as contacting the second finger (e.g., the thumb) and the fingers other than the first finger and the second finger of the hand are positioned in a second shape (e.g., in a curled shape in which the fingers other than the first finger and the second finger are resting against the palm of the hand), different from the first shape (832b), such as contact between index finger 712-2 and thumb 712-1 of the hand 705a in FIG. 7A while middle finger 712-3, ring finger 712-4, and/or pinky finger 712-5 are resting against the palm of the hand 705a. For example, the second set of interaction criteria is satisfied if the computer system detects an air pinch gesture that includes the index finger of the hand contacting the thumb of the hand, while the remaining fingers (e.g., the middle finger, ring finger, and/or pinky finger) are curled toward the palm of the hand (and are optionally rested against the palm of the hand). In some embodiments, the computer system detects the fingers other than the first finger and the second finger are positioned in the second shape prior to and after detecting the first finger and the second finger of the hand are in contact. Displaying a refinement user interface object that indicates a location at which a selection operation will be performed in response to further input in response to detecting an air gesture of a first type in which a first finger is contacting a second finger of the hand while the other fingers are positioned in a first shape improves accuracy for performing the selection operation and/or reduces the number of inputs needed to display the refinement user interface object, thereby improving user-device interaction.

In some embodiments, in response to detecting the first air gesture (834a) (e.g., air gesture performed by hand 703d as shown in FIG. 7D), in accordance with a determination that the first air gesture satisfies a third set of interaction criteria, different from the first set of interaction criteria and the second set of interaction criteria, the computer system performs (834b) a scrolling operation directed to the first object in the environment, such as scrolling the text content 716 of the virtual object 707 as shown in FIG. 7E, without displaying the selection refinement user interface object in the environment. For example, the third set of interaction criteria is satisfied if the first air gesture includes an air pinch gesture followed by movement of the hand of the user in space, as discussed in more detail below with reference to step 836. In some embodiments, performing the scrolling operation directed to the first object includes displaying additional content (e.g., text, images, video, and/or charts) in the first object in accordance with the movement of the hand of the user, such as display of additional text content 716 in the virtual object 707 as shown in FIG. 7E. For example, if the movement of the hand of the user is in a first direction (e.g., upward) in space, such as the movement of the hand 703d upward in space as shown in FIG. 7D, the computer system scrolls the content of the first object in the first direction in accordance with the movement of the hand and displays additional content starting toward a bottom portion of the first object. If the movement of the hand of the user is in a second direction (e.g., downward) in space, the computer system scrolls the content of the first object in the second direction in accordance with the movement of the hand and displays additional content starting toward a top portion of the first object. In some embodiments, the computer system scrolls the content of the first object in accordance with the movement of the hand without displaying the selection refinement user interface object in the first object (e.g., because the first air gesture does not satisfy the first set of interaction criteria), such as forgoing display of the selection refinement user interface object 711a in the virtual object 707 as shown in FIG. 7E. Performing a scrolling operation directed to an object in the three-dimensional environment, without displaying a refinement user interface object that indicates a location at which a selection operation will be performed in response to further input, in response to detecting an air gesture that satisfies a third set of criteria improves accuracy for performing the selection operation and/or enables the scrolling operation to be performed independently of the selection operation, thereby improving user-device interaction.

In some embodiments, the third set of interaction criteria includes a criterion that is satisfied when the first air gesture includes movement of the first portion of the user within a threshold amount of time (e.g., 0.1, 0.25, 0.5, 0.75, 0.9, 1, 2, 3, 4, or 5 seconds) of detecting the first air gesture (step 836), such as movement of the hand 703d within the threshold amount of time of detecting an air pinch gesture as shown in FIG. 7D. For example, the first air gesture satisfies the third set of interaction criteria if the first air gesture includes movement of the hand of the user in space within the threshold amount of time of detecting the index finger and thumb of the user contact to perform the air pinch gesture. In some embodiments, if the computer system does not detect the movement of the hand of the user in space within the threshold amount of time of detecting the first air gesture, the computer system forgoes performing the scrolling operation directed to the first object in the three-dimensional environment. For example, the computer system does not scroll through the content of the first object in accordance with the movement of the hand because the first air gesture does not satisfy the third set of interaction criteria. Performing a scrolling operation directed to an object in the three-dimensional environment, without displaying a refinement user interface object that indicates a location at which a selection operation will be performed in response to further input, in response to detecting an air gesture that includes movement of the hand of the user within a threshold amount of time of detecting the air gesture improves accuracy for performing the selection operation and/or enables the scrolling operation to be performed independently of the selection operation, thereby improving user-device interaction.

In some embodiments, the first air gesture is detected while attention (e.g., gaze) of the user is directed to a respective location relative to the first object in the environment (838a), such as the location of the gaze 721 in the virtual object 707 as shown in FIG. 7A. In some embodiments, in response to detecting the first air gesture (838b), in accordance with the determination that the first air gesture satisfies the first set of interaction criteria and that the respective location is a first location, the computer system displays (838b) the selection refinement user interface object at a second location based on the first location in the first object, such as display of the selection refinement user interface object 711a at the location of the gaze 721 in the virtual object 707 as shown in FIG. 7B. For example, if the computer system determines that the first air gesture satisfies the first set of interaction criteria and that the attention of the user is directed to the first location in the first object, the computer system displays the selection refinement user interface in the first object based on the first location. In some embodiments, the computer system displays the selection refinement user interface at the first location in the first object (e.g., the second location corresponds to the first location in the first object) in response to detecting the first air gesture. In some embodiments, the computer system displays the selection refinement user interface in the first object within a threshold distance (e.g., 0.25. 0.75, 1, 2, 3, 4, 5, or 10 cm) of the first location in response to detecting the first air gesture. For example, the second location is within the threshold distance of the first location in the first object.

In some embodiments, in accordance with the determination that the first air gesture satisfies the first set of interaction criteria and that the respective location is a third location, different from the first location, such as the location of the gaze 723 in the virtual object 709 as shown in FIG. 7D, the computer system displays (838d) the selection refinement user interface object at a fourth location, different from the second location, based on the third location in the first object, such as display of the selection refinement user interface object 711b at the location of the gaze 723 in the virtual object 709 as shown in FIG. 7D. For example, if the computer system determines that the first air gesture satisfies the first set of interaction criteria and that the attention of the user is directed to the third location in the first object, the computer system displays the selection refinement user interface in the first object based on the third location. In some embodiments, the computer system displays the selection refinement user interface at the third location in the first object (e.g., the fourth location corresponds to the third location in the first object) in response to detecting the first air gesture. In some embodiments, the computer system displays the selection refinement user interface in the first object within a threshold distance (e.g., 0.25. 0.75, 1, 2, 3, 4, 5, or 10 cm) of the third location in response to detecting the first air gesture. For example, the fourth location is within the threshold distance of the third location in the first object. Displaying a refinement user interface object that indicates a location at which a selection operation will be performed in response to further input based on the attention of the user in response to detecting an air gesture that satisfies a first set of criteria improves accuracy for performing the selection operation and/or reduces the number of inputs needed to display the refinement user interface object, thereby improving user-device interaction.

In some embodiments, while concurrently displaying the selection refinement user interface object with the first object in the environment in accordance with the determination that the first air gesture satisfies the first set of interaction criteria, such as while displaying the selection refinement user interface object 711a in the virtual object 707 as shown in FIG. 7B, the computer system detects (840a), via the one or more input devices, movement of the first portion of the user, such as movement of the hand 703b as shown in FIG. 7B. For example, after the computer system displays the selection refinement user interface object in the first object based on the location of the attention of the user, the computer system detects movement of the hand of the user in space. In some embodiments, the computer system detects the hand of the user move in space in a respective direction (e.g., downward as shown in FIG. 7B) and/or with a respective magnitude (e.g., of speed and/or distance) relative to the three-dimensional environment.

In some embodiments, while detecting the movement of the first portion of the user, the computer system moves (840b) the selection refinement user interface object within the first object in accordance with the movement of the first portion of the user, such as movement of the selection refinement user interface object 711a in the virtual object 707 in accordance with the movement of the hand 703b as shown in FIGS. 7C and 7C1. For example, while the selection refinement user interface object is displayed in the first object in the three-dimensional environment, the computer system moves the selection refinement user interface object within the first object in accordance with the movement of the hand of the user. For example, if the computer system detects the hand of the user move in a first direction (e.g., rightward or leftward) with a respective magnitude while the selection refinement user interface object is displayed at the second location or the fourth location discussed above with reference to steps 838a-838d, the computer system moves the selection refinement user interface object in the first direction away from the second location or the fourth location in accordance with the movement of the hand and with a first magnitude based on the respective magnitude. If the computer system detects the hand of the user move in a second direction (e.g., upward or downward), different from the first direction, such as the downward movement of the hand 703b as shown in FIG. 7B, with the respective magnitude, the computer system moves the selection refinement user interface object in the second direction away from the second location or the fourth location in accordance with the movement of the hand and with the first magnitude, such as the downward movement of the selection refinement user interface object 711a in the virtual object 707 as shown in FIGS. 7C and 7C1. In some embodiments, the computer system moves the selection refinement user interface object within the first object independently of a location of and/or changes in the location of the attention of the user in the three-dimensional environment. For example, if the computer system detects the attention of the user or move away from the first location or the third location discussed above with reference to steps 838a-838din the first object while the selection refinement user interface object is displayed in the first object, the computer system forgoes moving the selection refinement user interface object based on the movement of the attention of the user. If the computer system detects the attention of the user remain directed to the first location or the third location in the first object while detecting the hand of the user move in space as discussed above, such as the gaze 721 remaining directed to the selectable option 708a in the virtual object 707 as shown in FIGS. 7C and 7C1, the computer system moves the selection refinement user interface object in accordance with the movement of the hand. Moving a refinement user interface object that indicates a location at which a selection operation will be performed in response to further input in response to detecting movement of the hand of the user improves accuracy for moving the refinement user interface object and/or reduces the number of inputs needed to move the refinement user interface object, thereby improving user-device interaction.

In some embodiments, the first air gesture is detected while attention (e.g., gaze) of the user is directed to a first location relative to the first object in the environment (842a), such as gaze 723 directed to the virtual object 709 as shown in FIG. 7B. In some embodiments, while detecting the first air gesture (e.g., air gesture performed by hand 705b in FIG. 7B), the computer system displays (842b), via the display generation component, a visual indication at the first location relative to the first object, such as display of the visual indication 713 at the location of the gaze 723 in the virtual object 709 as shown in FIGS. 7C and 7C1. For example, while detecting the first air gesture and before determining that the first air gesture satisfies the first set of interaction criteria discussed above with reference to steps 802a-802d, the computer system displays the visual indication at the first location in the first object in the three-dimensional environment based on the location of the attention of the user. In some embodiments, the visual indication indicates the location at which the selection refinement user interface object described above with reference to steps 802a-802d will be displayed in the first object in accordance with the determination that the first air gesture satisfies the first set of interaction criteria. In some embodiments, the visual indication is a deemphasized representation (e.g., a shadow) of the selection refinement user interface object, as similarly shown in FIGS. 7C and 7C1. In some embodiments, the visual indication indicates a progression of the first air gesture toward meeting the first set of interaction criteria (e.g., after detecting the first air gesture (e.g., after detecting the index finger and the thumb of the hand make contact), as described in more detail below with reference to steps 844a-844c. In some embodiments, if the computer system determines that the first air gesture does not satisfy the first set of interaction criteria and determines that the first air gesture satisfies the second set of interaction criteria discussed above with reference to steps 802a-802d, the computer system forgoes displaying the selection refinement user interface object at the location of the visual indication and performs a selection at the location of the visual indication. For example, if the computer system detects an end of the first air gesture while the visual indication is displayed, the computer system activates a selectable option located at the location of the visual indication in the first object in the three-dimensional environment. Displaying a visual indication that indicates a location at which a refinement user interface object will be displayed in response to detecting an air gesture facilitates discovery that the refinement user interface object will be displayed at the location of the visual indication if the air gesture satisfies a first set of criteria and/or reduces the number of inputs needed perform a selection operation at the location, thereby improving user-device interaction.

In some embodiments, before the first air gesture satisfies the first set of interaction criteria (e.g., before detecting that the first air gesture includes a first portion of a selection input, followed by a confirmation gesture, as similarly discussed above with reference to step 804), the visual indication (e.g., visual indication 713 in FIGS. 7C and 7C1) is displayed at the first location with a first visual appearance (844a) (e.g., the visual indication is displayed with first values of color, brightness, saturation, and/or opacity relative to the first object in the three-dimensional environment). In some embodiments, in response to detecting the first air gesture (844b), in accordance with the determination that the first air gesture satisfies the first set of interaction criteria, the computer system displays (844c), via the display generation component, the visual indication at the first location with a second visual appearance, different from the first visual appearance, such as replacing display of the visual indication 713 with the selection refinement user interface object 711b in the virtual object 709 as shown in FIG. 7D. For example, if the computer system determines that the first air gesture satisfies the first set of interaction criteria, the computer system displays the visual indication at the first location with second values of color, brightness, saturation, and/or opacity relative to the first object in the three-dimensional environment. In some embodiments, displaying the visual indication with the second visual appearance includes increasing the opacity of the visual indication in the first object. In some embodiments, displaying the visual indication with the second visual appearance includes changing the color of the visual indication, such that the visual indication becomes darker and/or more visually prominent in the first object, as similarly shown in FIG. 7D. In some embodiments, displaying the visual indication with the second visual appearance includes displaying the selection refinement user interface object at the first location in the first object. For example, the computer system changes the values of the color, brightness, saturation, and/or opacity of the visual indication to transition the display of the visual indication to the selection refinement user interface object at the first location in the first object, as similarly shown in FIG. 7D. Changing an appearance of a visual indication that indicates a location at which a refinement user interface object will be displayed in response to detecting an air gesture facilitates discovery that the air gesture satisfies a first set of criteria and/or improves accuracy for performing a selection operation at the location of the refinement user interface object, thereby improving user-device interaction.

In some embodiments, while detecting the first air gesture and after displaying the visual indication (e.g., visual indication 713 in FIGS. 7C and 7C1) at the first location with the first visual appearance (e.g., before determining that the first air gesture satisfies the first set of interaction criteria), the computer system displays (846), via the display generation component, a visual appearance of the visual indication changing from the first visual appearance to the second visual appearance in accordance with a progression of the first air gesture satisfying the first set of interaction criteria, as similarly described with reference to FIG. 7D. For example, while the visual indication is displayed with the first visual appearance at the first location in the first

object, such as while displaying the visual indication 713 in the virtual object 709 as shown in FIGS. 7C and 7C1, the computer system gradually changes the appearance of the visual indication from the first visual appearance to the second visual appearance as the first air gesture progresses toward satisfying the first set of interaction criteria. In some embodiments, the progress toward satisfying the first set of interaction criteria corresponds to the progress of the hand of the user performing the confirmation gesture discussed above with reference to step 804 or the first type of gesture with the hand in the first pose discussed above with reference to steps 822a-822b. For example, the progression of the hand of the user toward performing the confirmation gesture begins when the computer system detects the first portion of the selection input (e.g., the initial air pinch gesture), and continues as the fingers of the hand change the shape of the air pinch gesture, as similarly described above with reference to steps 810-814, such as the progress of the hand 705c in FIGS. 7C and 7C1 toward performing the confirmation gesture. The progression of the hand of the user toward performing the first pose optionally begins when a first finger (e.g., index finger) and a second finger (e.g., thumb) of the hand are positioned apart, and continues as the first finger and the second finger come together to make contact, as similarly described above with reference to steps 828a-832b. In some embodiments, if the computer system detects that the first air gesture provided by the hand of the user stops progressing toward satisfying the first set of interaction criteria, the computer system would stop changing the appearance of the visual indication from the first visual appearance to the second visual appearance. For example, the computer ceases animating the change in appearance of the visual indication in the first object (e.g., but maintains display of the visual indication in the first object, such as maintaining display of the visual indication 713 in the virtual object 709). In some embodiments, if the computer system detects a reversal in the progression of the first air gesture toward satisfying the first set of interaction criteria, the computer system would change the visual appearance back toward the first visual appearance in accordance with the reversal. In some embodiments, if the first air gesture does not satisfy the first set of interaction criteria, the computer system does not display the visual indication with the second visual appearance. For example, the computer system forgoes displaying the selection refinement user interface object at the first location in the first object in the three-dimensional environment. Gradually changing an appearance of a visual indication that indicates a location at which a refinement user interface object will be displayed in accordance with a determination of a progression of an air gesture toward satisfying a first set

of criteria facilitates discovery of the progression of the air gesture toward satisfying the first set of criteria and/or improves accuracy for performing a selection operation at the location of the refinement user interface object, thereby improving user-device interaction.

In some embodiments, while concurrently displaying the selection refinement user interface object with the first object in the environment in accordance with the determination that the first air gesture satisfies the first set of interaction criteria, such as while displaying the selection refinement user interface object 711a in the virtual object 707 as shown in FIGS. 7C and 7C1, the computer system detects (848a), via the one or more input devices, a release (e.g., an end) of the first air gesture, such as an end of the selection input provided by the hand 703c in FIGS. 7C and 7C1. For example, the computer system detects that the fingers of the hand of the user performing the first air gesture are no longer in contact. The computer system optionally detects the index finger (e.g., index finger 710-2 of the hand 703c in FIGS. 7C and 7C1) and the thumb (e.g., thumb 710-1 of the hand 703c in FIGS. 7C and 7C1) of the hand separate to release the air pinch gesture while the selection refinement user interface object is displayed in the first object in the three-dimensional environment.

In some embodiments, in response to detecting the release of the first air gesture, the computer system performs a selection directed to the first object in the environment (848b) (e.g., based on a location of the selection refinement user interface object), such as selecting selectable option 708b in the virtual object 707 as shown in FIG. 7D. For example, the computer system performs a selection operation directed to a selectable option in the first object. In some embodiments, the computer system performs the selection of the selectable option because the location of the selection refinement user interface object corresponds to a location of the selectable option in the first object. For example, the selection refinement user interface object is partially displayed over the selectable option when the release of the first air gesture is detected, such as display of the selection refinement user interface object 711a over the selectable object 708b in the virtual object 707. In some embodiments, if the selection refinement user interface object is not displayed over the selectable option when the release of the first air gesture is detected, the computer system activates the selectable option because the selectable option is located within a threshold distance (e.g., 0.25. 0.75, 1, 2, 3, 4, 5, or 10 cm) of the location of the selection refinement user interface object in the first object. Performing a selection based on a location of a selection refinement user interface object in the three-dimensional environment in response to detecting a release of an air gesture that caused the selection refinement user interface object to be displayed enables the selection to be performed automatically based on the location of the refinement user interface object and/or reduces the number of inputs needed to perform the selection once the refinement user interface object is displayed, thereby improving user-device interaction.

In some embodiments, the selection refinement user interface object is not displayed when the first air gesture is detected (850), such as not displaying the selection refinement user interface object 711a in the virtual object 707 before the air gesture is detected as shown in FIG. 7A. For example, as discussed above with reference to steps 802a-802d, the computer system displays the selection refinement user interface object in the first object in the three-dimensional environment in response to detecting the first air gesture if the first gesture satisfies the first set of interaction criteria. Accordingly, in some embodiments, the selection refinement user interface object is not displayed in the first object in the three-dimensional environment before the computer system detects the first air gesture. Displaying a selection refinement user interface object that indicates a location at which a selection operation will be performed in response to further input in response to detecting an air gesture that satisfies a first set of criteria improves accuracy for performing the selection operation and/or reduces the number of inputs needed to display the refinement user interface object, thereby improving user-device interaction.

In some embodiments, the selection refinement user interface object includes a cursor (852), as similarly described with reference to FIG. 7B. For example, the computer system displays a selection cursor in the first object in the three-dimensional environment in accordance with the determination that the first air gesture satisfies the first set of interaction criteria. As similarly discussed above with reference to steps 802a-802d, in some embodiments, the cursor indicates a location in the first object at which a selection operation will be performed in response to further input, such as in response to detecting an end (e.g., a release) of the air pinch gesture. Displaying a cursor that indicates a location at which a selection operation will be performed in response to further input in response to detecting an air gesture that satisfies a first set of criteria improves accuracy for performing the selection operation and/or reduces the number of inputs needed to display the refinement user interface object, thereby improving user-device interaction.

In some embodiments, the selection refinement user interface object includes displaying a respective object (e.g., a selectable option) in the environment with visual emphasis relative to the environment (854) (e.g., without displaying a cursor in the environment), such as displaying selectable option 708a in the virtual object 707 with visual emphasis (e.g., shading/highlighting) as shown in FIG. 7B. For example, the first object in the three-dimensional environment includes one or more selectable options. In some embodiments, if the computer system determines that the first air gesture satisfies the first set of interaction criteria, the computer system visually emphasizes a selectable option in the first object based on the attention (e.g., gaze) of the user. For example, as similarly described above with reference to steps 802a-802d, the computer system displays the selection refinement user interface object in the first object based on (e.g., at) the location of the gaze of the user. Accordingly, in some embodiments, the computer system visually emphasizes a selectable option that is at or near (e.g., within a threshold distance of, such as 0.1, 0.25. 0.75, 1, 2, 3, 4, or 5 cm) the location of the attention of the user when the first air gesture is detected (and if the first air gesture satisfied the first set of interaction criteria), such as at the location of the gaze 721 in the virtual object 707 in FIG. 7B. In some embodiments, visually emphasizing the respective object (e.g., the selectable option) relative to the three-dimensional environment includes highlighting, bolding, changing a color of, and/or changing a size of the respective object in the first object in the three-dimensional environment, without displaying a selection cursor in the first object in the three-dimensional environment. In some embodiments, visually emphasizing the respective object indicates that the respective object will be activated (e.g., selected) in response to further input directed to the respective object, such as a release of the air pinch gesture as similarly described above with reference to steps 848a-848b. In some embodiments, if the computer system detects input corresponding to a request to move the selection refinement user interface object within the first object, such as the input(s) similarly discussed above with reference to steps 840a-840b, such as movement of the hand 703b as shown in FIG. 7B, the computer system visually emphasizes a second respective object, such as a second selectable option, in the three-dimensional environment based on the input, such as visually emphasizing selectable option 708b in the virtual object 707 as shown in FIGS. 7C and 7C1. For example, the computer system no longer visually emphasizes the respective object in the first object when the selection refinement user interface object is moved within the first object. Visually emphasizing a respective object to

which a selection operation will be performed in response to further input in response to detecting an air gesture that includes a first portion of an air pinch gesture followed by movement of a centroid of a first finger of the hand performing the air pinch gesture improves accuracy for performing the selection operation and/or reduces the number of inputs needed to display the refinement user interface object, thereby improving user-device interaction.

It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9E illustrate examples of a computer system facilitating user input for activating a selection refinement mode while displaying a three-dimensional environment in accordance with some embodiments.

FIG. 9A illustrates a computer system (e.g., an electronic device) 101 displaying, via a display generation component (e.g., display generation component 120 of FIG. 1), a three-dimensional environment 902 from a viewpoint of a user (e.g., facing the back wall of the physical environment in which computer system 101 is located). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user’s hands (e.g., external sensors facing outwards from the user), and/or attention (e.g., gaze) of the user (e.g., internal sensors facing inwards towards the face of the user).

As shown in FIG. 9A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 902. For example, three-dimensional environment 902 includes a representation 922 of a coffee table, which is optionally a representation of a physical coffee table in the physical environment, and three-dimensional environment 902 includes a representation 924 of sofa, which is optionally a representation of a physical sofa in the physical environment.

In FIG. 9A, three-dimensional environment 902 also includes virtual objects 907 (“Window 1”), 909 (“Window 2”), and 911 (“Window 3”). In some embodiments, virtual objects 907, 909, and 911 are optionally one or more of user interfaces of applications containing content (e.g., a plurality of selectable options), three-dimensional objects (e.g., virtual clocks, virtual balls, and/or virtual cars) or any other element displayed by computer system 101 that is not included in the physical environment of display generation component 120. In FIG. 9A, virtual object 907 is optionally a user interface of an audio playback application. For example, as shown in FIG. 9A, virtual object 907 includes a list 908 of selectable categories of music and a plurality of selectable user interface objects corresponding to a plurality of albums of music. As an example, the list 908 of selectable categories of music is selectable to display albums, songs, and/or artists in an alphabetized manner, a first user interface object (e.g., corresponding to “Album A”) 910a that is selectable to cause the computer system 101 to display one or more songs belonging to “Album A”, and a second user interface object (e.g., corresponding to “Album B”) 910B that is selectable to cause the computer system 101 to display one or more songs belonging to “Album B”. Additionally, in FIG. 9A, virtual object 909 is optionally a user interface of a media browsing application. For example, as shown in FIG. 9A, virtual object 909 includes a plurality of selectable options corresponding to a plurality of content items (e.g., movie content and/or episodic content). As shown in FIG. 9A as an example, the virtual object 909 includes a first selectable option 904a that is selectable to cause the computer system 101 to initiate playback of a first content item (“Content A”), a second selectable option 904b that is selectable to cause the computer system 101 to initiate playback of a second content item (“Content B”), and/or a third selectable option 904c that is selectable to cause the computer system 101 to initiate playback of a third content item (“Content C”). In FIG. 9A, virtual object 911 is optionally a user interface of a web-browsing application. For example, as shown in FIG. 9A, virtual object 911 includes a plurality of selectable search results (e.g., hyperlinks) from the website “www.Search.com”. As shown in FIG. 9A as an example, the virtual object 911 includes a first search result 908a that is selectable to cause the computer system 101 to display content (e.g., text, images, video, and/or audio) associated with a first website (“www.URL1.com”), a second search result 908b that is selectable to cause the computer system 101 to display content associated with a second website (“www.URL2.com”), a third search result 908c that is selectable to cause the computer system 101 to display content associated with a third website (“www.URL3.com”), and/or a fourth search result 908d that is selectable to cause the computer system 101 to display content associated with a fourth website (“www.URL4.com”).

In some embodiments, as discussed herein, the computer system 101 provides for enhanced and precise selection of selectable options in three-dimensional environment 902. As discussed above, in FIG. 9A, the virtual objects 907, 909, and 911 optionally include a plurality of selectable options. In some embodiments, the computer system 101 activates a respective selectable option in response to detecting an air gesture provided by the hand of the user while attention (e.g., gaze) of the user is directed toward the respective selectable option in the three-dimensional environment 902. In some embodiments, the respective selectable option is proximate to (e.g., 0.5, 1, 2, 3, 4, 5, 6, 8, or 10 cm from) one or more other selectable options, such as selectable options 908a-908d, 910a-910c, and/or 904a-904c in FIG. 9A, which could result in an unintentional selection of a selectable option that is different from the respective selectable option to which the air gesture is directed in the three-dimensional environment 902. Accordingly, in some embodiments, as discussed below, in response to detecting an air gesture that corresponds to a refinement gesture, the computer system 101 activates a selection refinement mode during which a selection refinement user interface object (e.g., a cursor) is displayed in the three-dimensional environment 902 that indicates a location at which a selection operation will be performed in response to further input.

In FIG. 9A, the computer system 101 detects a first air gesture provided by hand 903a (“Hand 1”). For example, as shown in FIG. 9A, the computer system 101 detects hand 903a provide the first air gesture while a first gaze 921 of the user is directed to the virtual object 907 in the three-dimensional environment 902. Additionally, in FIG. 9A, the computer system 101 detects a second air gesture provided by hand 905a (“Hand 2”). For example, as shown in FIG. 9A, the computer system 101 detects the hand 905a provide the second air gesture while a second gaze 923 of the user is directed to the virtual object 909 in the three-dimensional environment 902. It should be understood that while multiple hands and corresponding inputs are illustrated in FIGS. 9A-9E, such hands and inputs need not be detected by computer system 101 concurrently; rather, in some embodiments, computer system 101 independently responds to the hands and/or inputs illustrated and described in response to detecting such hands and/or inputs independently. Additionally, it should be understood that, while multiple gaze points are illustrated in FIGS. 9A-9E, such gaze points need not be detected by computer system 101 concurrently; rather, in some embodiments, computer system 101 independently responds to the gaze points illustrated and described in response to detecting such gaze points independently.

As mentioned above, in some embodiments, the computer system 101 activates a selection refinement mode that facilitates precise selection of a respective selectable option in the three-dimensional environment 902 in response to detecting an air gesture that corresponds to a refinement gesture. In some embodiments, if the computer system 101 determines that the air gesture corresponds to a refinement gesture, the computer system 101 activates the selection refinement mode, which includes displaying a selection refinement user interface object at a location in the three-dimensional environment 902 that is based on the location of the attention (e.g., gaze) of the user when the air gesture is detected, as discussed below. In some embodiments, the computer system 101 forgoes activating the selection refinement mode (e.g., and thus displaying the selection refinement user interface object in the three-dimensional environment 902) if the air gesture corresponds to an activation gesture (e.g., and does not correspond to a refinement gesture). Rather, the computer system 101 optionally performs a selection operation in the three-dimensional environment 902 at a location that is based on the location of the attention of the user when the air gesture is detected, as discussed in more detail below.

From FIGS. 9A-9B, the computer system 101 determines that the first air gesture provided by the hand 903a corresponds to a refinement gesture. In some embodiments, the refinement gesture corresponds to an air gesture performed with two or more fingers of the hand of the user. In some embodiments, the air gesture is a hand claw gesture. For example, in FIG. 9A, the computer system 101 detects that the palm of the hand 903a is parallel to a first axis that is normal to a second axis horizontally aligned relative to the viewpoint of the user and that thumb 910-1, index finger 910-2, middle finger 910-3, ring finger 910-4, and/or pinky finger 910-5 of the hand 903a are arranged/curled in a C-shape (e.g., resembling a “claw”). In some embodiments, the air gesture is a pincer pump gesture. For example, in FIG. 9A, the computer system 101 detects the palm of the hand 903a is parallel to the first axis that is normal to the second axis that is horizontal relative to the viewpoint of the user and that the thumb 910-1 and the index finger 910-2 are arranged/curled in a C-shape (e.g., a pincer shape resembling a “pincer”) without touching (e.g., at the fingertips), while the middle finger 910-3, the ring finger 910-4, and/or the pinky finger 910-5 are arranged in an uncurled state (e.g., pointed/straightened away from the palm). While the index finger 910-2 and the thumb 910-1 are curled and arranged in the pincer shape, the computer system 101 optionally detects a change in position of the index finger 910-2 and the thumb 910-1 of the hand 903a (e.g., a “pump” of the fingers). For example, the computer system 101 detects the index finger 910-2 and the thumb 910-1 straighten away from the palm of the hand 903a such that the index finger 910-2 and the thumb 910-1 are no longer curled. In some embodiments, the computer system detects changes in position of the index finger 910-2 and the thumb 910-1 (e.g., curled and/or uncurled arrangements of the fingers) based on detected changes to angles between portions of the fingers corresponding to individual bones of the fingers. For example, in FIG. 7A, the computer system 101 detects that the angle between the portion of the finger that includes the distal phalanx bone and the portion of the finger that includes the intermediate phalanx of the index finger 910-2 and the thumb 910-1, and/or between the portion of the finger that includes the intermediate phalanx bone and the portion of the finger that includes the proximal phalanx bone of the index finger 910-2 and the thumb 910-1 corresponds to a curled orientation (e.g., if the detected angle is more than a threshold angle (e.g., 5, 10, 15, 20, 30, or 45 degrees) of 180 degrees) and/or an uncurled orientation (e.g., if the detected angle is less than the threshold angle of 180 degrees). In some embodiments, the computer system 101 detects the index finger 910-2 and the thumb 910-1 change position within a threshold amount of time (e.g., 0.25, 0.5, 0.75, 1, 2, 3, 4, or 5 seconds) of detecting the index finger 910-2 and the thumb 910-1 of the hand 903a curl to form the pincer shape.

In some embodiments, the air gesture above is a pincer claw gesture. For example, in FIG. 9A, the computer system 101 detects the palm of the hand 903a is parallel to the first axis that is normal to the second axis that is horizontal relative to the viewpoint of the user and that the thumb 910-1 and the index finger 910-2 are arranged/curled in a C-shape (e.g., resembling a “pincer”) without touching (e.g., at the fingertips), while the middle finger 910-3, the ring finger 910-4, and/or the pinky finger 910-5 are arranged in an uncurled state (e.g., are pointed/straightened away from the palm). In some embodiments, the air gesture is a pinch slide gesture. For example, in FIG. 9A, the computer system 101 detects the palm of the hand 903a is parallel to the first axis that is normal to the second axis that is horizontal relative to the viewpoint of the user, the fingers other than the thumb 910-1 (e.g., the index 910-2, middle 910-3, ring 910-4, and/or pinky 910-5 fingers) are arranged in a curled shape, and the thumb 910-1 is positioned above and/or atop a medial portion (e.g., spanning the intermediate phalange) of the index finger 910-2 of the hand 903a. While the thumb 910-1 is positioned above and/or atop the medial portion of the curled index finger 910-2, the computer system 101 optionally detects the thumb 910-1 slide in a respective direction across the index finger 910-2 (e.g., leftward or rightward along the surface of the curled index finger 910-2). In some embodiments, the computer system 101 detects the thumb 910-1 slide in a first direction across the surface of the curled index finger 910-2. For example, the refinement gesture includes movement of the thumb 910-1 rightward (or leftward) across the surface of the curled index finger 910-2. In some embodiments, as described in more detail below, movement of the thumb 910-1 in a second direction, opposite the first direction, causes the computer system 101 to deactivate the selection refinement mode (e.g., if the selection refinement mode is active). Additional details regarding the refinement gesture are provided below with reference to method 1000.

Additionally, from FIGS. 9A-9B, the computer system 101 determines that the second air gesture provided by the hand 905a corresponds to an activation gesture. In some embodiments, the activation gesture corresponds to an air pinch gesture performed with two or more fingers of the hand of the user. In some embodiments, the two or more fingers used to perform the activation gesture are the same two or more finger used to perform the refinement gesture discussed above. For example, in FIG. 9A, the computer system 101 detects index finger 912-2 and thumb 912-1 of the hand 905a come together and make contact, followed by a release of the air pinch gesture (e.g., a de-pinch), such that the index finger 912-2 and the thumb 912-1 are no longer touching. In some embodiments, the air pinch gesture is performed using fingers other than the index finger 912-1. For example, the computer system 101 detects the air pinch gesture provided by the thumb 912-1 and the middle finger 912-3, ring finger 912-4, or pinky finger 912-5 of the hand 905a in FIG. 9A. Additional details regarding the activation gesture are provided below with reference to method 1000.

In some embodiments, as mentioned above, in response to detecting a refinement gesture, the computer system 101 activates the selection refinement mode. For example, as shown in FIG. 9B, in response to detecting the refinement gesture provided by the hand 903a in FIG. 9A, the computer system 101 activates the selection refinement mode, which includes displaying a selection refinement user interface object 912a in the three-dimensional environment 902. In some embodiments, the computer system 101 displays the selection refinement user interface object 912a at a location in the three-dimensional environment 902 that is based on the location of the attention of the user when the refinement gesture is detected. For example, as shown in FIG. 9B, the computer system 101 displays the selection refinement user interface object 912a at a location in the virtual object 907 that corresponds to the location of the gaze 921 when the refinement gesture is detected in FIG. 9A. In some embodiments, the selection refinement user interface object 912a represents an interaction point (e.g., indicates a location) in the three-dimensional environment 902 at which a selection operation will be performed in response to detecting further input (e.g., in response to detecting an activation gesture), as discussed in more detail below.

In some embodiments, the selection refinement mode remains active at the computer system 101 for a duration of which the refinement gesture detected in FIG. 9A is maintained. For example, the computer system 101 maintains display of the selection refinement user interface object 912a in the three-dimensional environment 902 as long as the refinement gesture (e.g., described above) provided by the hand 903a in FIG. 9A is maintained. In some embodiments, if the computer system 101 detects an end of the refinement gesture (e.g., a release and/or relaxation of the fingers forming the refinement gesture as discussed above), the computer system 101 deactivates the selection refinement mode and ceases display of the selection refinement user interface object 912a in the three-dimensional environment 902. In some embodiments, as discussed in more detail below, if the computer system detects a subsequent air gesture (e.g., an activation gesture or a repeat of the refinement gesture), the computer system 101 deactivates the selection refinement mode and ceases display of the selection refinement user interface object 912a in the three-dimensional environment 902 (e.g., and optionally performs an additional operation (e.g., a selection operation), as discussed in more detail below with reference to FIG. 9E).

In some embodiments, the selection refinement mode remains active at the computer system 101 for a threshold amount of time (e.g., 1, 2, 3, 4, 5, 8, 10, 12, 15, or 20 seconds) after detecting the refinement gesture in FIG. 9A. For example, the selection refinement user interface object 912a remains displayed in the virtual object 907 for the threshold amount of time. In some embodiments, as discussed in more detail below with reference to FIG. 9E, while the selection refinement mode is active and the selection refinement user interface object 912a is displayed in the virtual object 907 in the three-dimensional environment 902, if the computer system 101 detects a selection input (e.g., an activation gesture) performed by the hand of the user before the threshold amount of time elapses, the computer system 101 will perform a selection operation based on the location of the selection refinement user interface object 912a in the virtual object 909. In some embodiments, if the threshold amount of time elapses without the computer system 101 detecting further input, the computer system 101 will automatically deactivate the selection refinement mode. For example, the computer system 101 will cease display of the selection refinement user interface object 912a in the virtual object 907 in the three-dimensional environment 902.

Additionally, in some embodiments, as shown in FIG. 9B, when the computer system 101 determines that the second air gesture provided by hand 905a in FIG. 7A corresponds to an activation gesture, the computer system 101 performs a selection operation based on the location of the attention of the user in the three-dimensional environment 902. For example, as discussed above with reference to FIG. 9A, the gaze 923 is directed toward the selectable option 904b in the virtual object 909 when the second air gesture provided by the hand 905a is detected. Accordingly, as shown in FIG. 9B, the computer system 101 optionally activates the selectable option 904b and initiates playback of the second content item (“Content B”) in the virtual object 909 in the three-dimensional environment 902. Further, as shown in FIG. 9B, the computer system 101 optionally forgoes displaying a selection refinement user interface object in the virtual object 909 in the three-dimensional environment 902. For example, as shown in FIG. 9B, the computer system 101 initiates playback of the second content item in the virtual object 909 in response to detecting the second air gesture provided by the hand 905a without displaying a selection user interface object at the location of the gaze 923 in the virtual object 909.

In some embodiments, while the selection refinement user interface object is displayed in the three-dimensional environment 902, the computer system 101 moves the selection refinement user interface object based on movement of the hand of the user. In FIG. 9B, the computer system 101 detects the hand 903b move in space while the selection refinement user interface object 912a is displayed in the virtual object 907. For example, as shown in FIG. 9B, the computer system 101 detects the hand 903b move in a leftward and upward direction with a respective magnitude relative to the three-dimensional environment 902 while the fingers of the hand 903b maintain the refinement gesture detected in FIG. 9A. In some embodiments, as discussed below, the computer system 101 moves the selection refinement user interface object 912a irrespective of a location of and/or movement of the attention (e.g., gaze 921) of the user in the virtual object 907.

Further, in FIG. 7B, the computer system 101 detects the attention of the user move to a new location in the three-dimensional environment 902. For example, as shown in FIG. 9B, the computer system 101 detects the gaze 923 move away from the location of the gaze 923 in FIG. 9A to selectable option 913 in the virtual object 909. In some embodiments, the selectable option 913 is selectable to cause the computer system 101 to cease playback of the second content item in the virtual object 909. Additionally, in FIG. 7B, the computer system 101 detects the hand 905b provide an air gesture directed to the virtual object 909 in the three-dimensional environment 902. For example, as shown in FIG. 9B, the computer system 101 detects the hand 905b perform the air gesture while the gaze 923 of the user is directed to the selectable option 913 in the virtual object 909 in the three-dimensional environment 902. As described previously above, in some embodiments, the computer system 101 performs a selection operation in the three-dimensional environment 902 based on the location of the attention of the user in response to detecting an air gesture that corresponds to an activation gesture.

In some embodiments, as shown in FIG. 9C, in response to detecting the movement of the hand 903b in FIG. 9B, the computer system 101 moves the selection refinement user interface object 912a within the virtual object 907 in accordance with the movement of the hand of the user. For example, as shown in FIG. 9C, the computer system 101 moves the selection refinement user interface object 912a leftward and upward in the virtual object 907 in accordance with the movement of the hand of the user. In some embodiments, when the movement of the hand of the user corresponds to movement of the selection refinement user interface object 912a beyond a boundary of the virtual object 907 in the three-dimensional environment 902, the computer system 101 clips the selection refinement user interface object 912a to the boundary of the virtual object 907. For example, in FIG. 9B, the respective magnitude (e.g., of speed and/or distance) of the movement of the hand 903b corresponds to movement of the selection refinement user interface object 912a beyond the left edge of the virtual object 907 in the three-dimensional environment 902. Accordingly, in FIG. 9C, the computer system 101 optionally moves the selection refinement user interface object 912a leftward in the virtual object 907 to the left edge of the virtual object 907 by a horizontal component (e.g., of distance) that is less than the corresponding horizontal component of the movement of the hand 903b of the user, and moves the selection refinement user interface object 912a upward along the left edge of the virtual object 907 by a vertical component (e.g., of distance) that is greater than the corresponding vertical component of the movement of the hand 903b in FIG. 9B.

Additionally, from FIGS. 9B-9C, the computer system 101 determines that the air gesture provided by the hand 905b corresponds to an activation gesture. For example, the computer system 101 detects that the air gesture includes an air pinch gesture as similarly discussed previously above. In some embodiments, as shown in FIG. 9C, in response to detecting the activation gesture provided by the hand 905b in FIG. 9A, the computer system 101 performs a selection operation in the three-dimensional environment 902 based on the location of the attention of the user in the three-dimensional environment 902. For example, as discussed above, in FIG. 9B, the gaze 923 is directed to the selectable option 913 when the activation gesture provided by the hand 905b is detected. Accordingly, as shown in FIG. 9C, the computer system 101 performs a selection operation directed to the selectable option 913, which ceases playback of the second content item (“Content B”) in the virtual object 909 in the three-dimensional environment 902. Accordingly, as outlined above with reference to FIG. 9C, the interaction point (e.g., represented by the selection refinement user interface object 912a) at which a selection operation will be performed is moved based on movement of the hand of the user while the selection refinement mode is active, and the interaction point at which the selection operation will be performed is moved based on the movement of the attention of the user while the selection refinement mode is not active. Additional details regarding the interaction point are provided below with reference to method 1000.

In some embodiments, as discussed above, the computer system 101 performs a selection operation in the three-dimensional environment 902 in response to detecting an activation gesture performed by the hand of the user. In some embodiments, the computer system 101 performs the selection operation in the three-dimensional environment 902 in response to detecting the activation gesture irrespective of whether a refinement gesture is detected prior to detecting the activation gesture. For example, as discussed above, the computer system 101 activates the selectable option 913 in the virtual object 909 in FIG. 9B in response to detecting the activation gesture provided by the hand 905c after previously detecting an activation gesture.

FIG. 9B1 illustrates similar and/or the same concepts as those shown in FIG. 9B (with many of the same reference numbers). It is understood that unless indicated below, elements shown in FIG. 7D-1 that have the same reference numbers as elements shown in FIGS. 7A-7H have one or more or all of the same characteristics. FIG. 9B1 includes computer system 101, which includes (or is the same as) display generation component 120. In some embodiments, computer system 101 and display generation component 120 have one or more of the characteristics of computer system 101 shown in FIGS. 9B and 9A-9E and display generation component 120 shown in FIGS. 1 and 3, respectively, and in some embodiments, computer system 101 and display generation component 120 shown in FIGS. 9A-9E have one or more of the characteristics of computer system 101 and display generation component 120 shown in FIG. 9B1.

In FIG. 9B1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user’s left and right eyes. Display generation component 120 also includes external image sensors 314b and 314c facing outwards from the user to detect and/or capture the physical environment and/or movements of the user’s hands. In some embodiments, image sensors 314a, 314b, and 314c have one or more of the characteristics of image sensors 314 described with reference to FIGS. 9A-9E.

In FIG. 9B1, display generation component 120 is illustrated as displaying content that optionally corresponds to the content that is described as being displayed and/or visible via display generation component 120 with reference to FIGS. 9A-9E. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user’s brain) to create the view of the content shown in FIG. 9B1.

Display generation component 120 has a field of view (e.g., a field of view captured by external image sensors 314b and 314c and/or visible to the user via display generation component 120, indicated by dashed lines in the overhead view) that corresponds to the content shown in FIG. 9B1. Because display generation component 120 is optionally a head-mounted device, the field of view of display generation component 120 is optionally the same as or similar to the field of view of the user.

In FIG. 9B1, the user is depicted as performing an air pinch gesture (e.g., with hand 780-2) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 9A-9E.

In some embodiments, computer system 101 responds to user inputs as described with reference to FIGS. 9A-9E.

In the example of FIG. 9B1, because the user’s hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 9A-9E and/or described with reference to the corresponding method(s) are optionally implemented on computer system 101 and display generation unit 120 in a manner similar or analogous to that shown in FIG. 9B1.

In some embodiments, the computer system 101 moves the selection refinement user interface object 912a from one virtual object to another in response to detecting input directed toward the other virtual object while the selection refinement mode is active. In FIG. 9C, the computer system 101 detects movement of the attention (e.g., gaze 921) from the virtual object 907 (in which the selection refinement user interface object 912a is currently displayed) to virtual object 911 in the three-dimensional environment. Additionally, in FIG. 9C, the computer system 101 optionally detects an activation gesture provided by the hand 903c directed to the virtual object 911 in the three-dimensional environment 902. For example, as shown in FIG. 9C, the computer system 101 detects the hand 903c provide an air pinch gesture, as similarly discussed above with reference to FIG. 9A, while the gaze 921 is directed toward the virtual object 911 in the three-dimensional environment 902.

Additionally, in FIG. 9C, the computer system 101 detects a refinement gesture provided by the hand 903c directed toward the virtual object 909 in the three-dimensional environment 902. For example, as shown in FIG. 9C, the computer system 101 detects the hand 905c provide the refinement gesture while the gaze 923 is directed toward the virtual object 909 in the three-dimensional environment 902. In some embodiments, the refinement gesture performed by the hand 905c in FIG. 9C has one or more characteristics of the refinement gesture discussed above with reference to FIG. 9A.

In some embodiments, as shown in FIG. 9D, in response to detecting the movement of the location of the attention of the user in the three-dimensional environment 902 in FIG. 9C, the computer system 101 moves the selection refinement user interface object 912a based on the new location of the attention of the user. For example, as shown in FIG. 9D, the computer system 101 displays the selection refinement user interface object 912a at the location of the gaze 921 in the virtual object 911 in the three-dimensional environment 902 after the gaze 921 is directed to the virtual object 911 as discussed above. In some embodiments, the computer system 101 moves the selection refinement user interface object 912a to the location of the attention (e.g., gaze 921) in the virtual object 911 in response to detecting the refinement gesture provided by the hand 903c in FIG. 9C. For example, as shown in FIG. 9D, the computer system 101 displays the selection refinement user interface object 912a at the location of the gaze 921 in the virtual object 911 in response to detecting the refinement gesture provided by the hand 903c in FIG. 9C.

In some embodiments, while the selection refinement mode is active and while the selection refinement user interface object is displayed in a virtual object in the three-dimensional environment 902, the computer system 101 restricts movement of the selection refinement user interface object beyond a boundary of the virtual object. For example, as discussed previously above with reference to FIG. 9C, the computer system 101 clips the movement of the selection refinement user interface object 912a within the virtual object 907 in response to movement of the hand 903b of the user that corresponds to movement of the selection refinement user interface object 912a beyond the boundary of the virtual object 907. Similarly, in some embodiments, rather than move the selection refinement user interface object 912a to the virtual object 911 in response to detecting movement of the location of the attention (e.g., gaze 921) of the user to the virtual object 911 and/or the refinement gesture provided by the hand 903c in FIG. 9C, the computer system 101 moves the selection refinement user interface object 912a to the virtual object 911 after the selection refinement mode is deactivated and subsequently reactivated while the attention of the user is directed to the virtual object 911. For example, as similarly discussed in more detail below, the computer system 101 deactivates the selection refinement mode and ceases display of the selection refinement user interface object 912a in response to detecting a subsequent air gesture (e.g., a refinement gesture or an activation gesture, discussed herein above). While the selection refinement user interface object 912a is no longer displayed in the virtual object 907 in the three-dimensional environment 902, the computer system 101 optionally reactivates the selection refinement mode in response to detecting a refinement gesture provided by the hand of the user, such as the refinement gesture discussed above with reference to FIG. 9A, and redisplays the selection refinement user interface object 912a at the current location of the gaze 921, which is optionally located in the virtual object 911, as shown in FIG. 9D.

Additionally, as shown in FIG. 9D, in some embodiments, in response to detecting the refinement gesture provided by the hand 905c in FIG. 9C, the computer system 101 activates the selection refinement mode for the virtual object 909 and displays a second selection refinement user interface object 912b in the virtual object 909 in the three-dimensional environment 902. For example, as similarly described above, the computer system 101 displays the second selection refinement user interface object 912b at the location of the gaze 923 of the user in the virtual object 909.

In FIG. 9D, the computer system 101 detects an activation gesture provided by the hand 903d of the user. For example, as shown in FIG. 9D, the computer system 101 detects an air pinch gesture while the selection refinement user interface object 912a is displayed in the virtual object 911. In some embodiments, the activation gesture has one or more characteristics of the activation gesture described above with reference to FIG. 9A. Additionally, in FIG. 9D, the computer system 101 detects a refinement gesture provided by the hand 905d of the user. For example, as shown in FIG. 9D, the computer system 101 detects the refinement gesture while the second selection refinement user interface object 912b is displayed in the virtual object 909 in the three-dimensional environment 902. In some embodiments, the refinement gesture has one or more characteristics of the refinement gesture discussed above with reference to FIG. 9A.

In some embodiments, as shown in FIG. 9E, in response to detecting the activation gesture provided by the hand 903d in FIG. 9D, the computer system 101 performs a selection operation in the three-dimensional environment 902 based on the interaction point indicated by the selection refinement user interface object 912a in FIG. 9D. For example, in FIG. 9D, the selection refinement user interface object 912a is located at a location of the third selectable search result 908c in the virtual object 911 in the three-dimensional environment 902. Accordingly, in response to detecting the activation gesture provided by the hand 903d in FIG. 9D, the computer system 101 activates the third selectable search result 908c. For example, the computer system 101 navigates to a website (“www.URL3.com”) associated with the third selectable search result 908c and displays content (e.g., text, video, images, and/or audio) 914 associated with the website. In some embodiments, in response to detecting the activation gesture provided by the hand 903d in FIG. 9D, the computer system 101 deactivates the selection refinement mode for the virtual object 911 in the three-dimensional environment 902. For example, after performing the selection operation discussed above, the computer system 101 ceases display of the selection refinement user interface object 912a in the virtual object 911, as shown in FIG. 9E.

Additionally, as shown in FIG. 9E, in some embodiments, in response to detecting the refinement gesture provided by the hand 905d in FIG. 9D, the computer system 101 deactivates the selection refinement mode for the virtual object 909 in the three-dimensional environment 902. For example, the computer system 101 ceases display of the second selection refinement user interface object 912b in the virtual object 909 and forgoes performing a selection operation in the three-dimensional environment 902. As shown in FIG. 9E, the computer system 101 optionally does not perform a selection operation based on the location of the second selectable user interface object 912b in the virtual object 909 in FIG. 9D. For example, in FIG. 9D, the second selection user interface object 912b is located at a location of selectable option 916 in the virtual object 909. In some embodiments, the selectable option 916 is selectable to cause the computer system 101 to navigate backward in the user interface of virtual object 909 (e.g., and cease displaying the selectable options 904a-904c in the virtual object 909). As shown in FIG. 9E, in response to detecting the refinement gesture provided by the hand 905d in FIG. 9D, the computer system 101 optionally forgoes activating the selectable option 916 in the virtual object 909 when the selection refinement mode is deactivated for the virtual object 909 in the three-dimensional environment 902.

FIGS. 10A-10J is a flowchart illustrating a method 1000 of activating a selection refinement mode while displaying a three-dimensional environment in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user’s hand or a camera that points forward from the user’s head). In some embodiments, the method 1000 is governed by instructions that are stored in a non-transitory computer-readable storage medium and that are executed by one or more processors of a computer system, such as the one or more processing units 202 of computer system 101 (e.g., control unit 110 in FIG. 1A). Some operations in method 1000 are, optionally, combined and/or the order of some operations is, optionally, changed.

In some embodiments, method 1000 is performed at a first computer system (e.g., computer system 101) in communication with a display generation component (e.g., 120) and one or more input devices (e.g., 314). In some embodiments, the computer system is or includes an electronic device. In some embodiments, the computer system has one or more of the characteristics of the computer system(s) in method 800. In some embodiments, the display generation component has one or more of the characteristics of the display generation component(s) in method 800. In some embodiments, the one or more input devices have one or more of the characteristics of the one or more input devices in method 800.

In some embodiments, while displaying, via the display generation component, a first object in an environment (e.g., an environment having one or more of the characteristics of

the environment of method 800), such as virtual object 907, 909, or 911 in three-dimensional environment 902 in FIG. 9A, the computer system detects (1002a), via the one or more input devices, a first input performed by a first portion of a user of the computer system, such as hand 903a or 905a in FIG. 9A, wherein the first input is associated with an interaction point directed to the first object, and wherein the interaction point corresponds to a location to which a respective input performed by the first portion of the user is directed. In some embodiments, the environment corresponds to a physical environment surrounding the display generation component and/or the computer system or a virtual environment. In some embodiments, the computer system displays a three-dimensional environment, such as a three-dimensional environment as described with reference to method 800. In some embodiments, the first object is in a field of view of the three-dimensional environment from a viewpoint of a user of the computer system. For example, the first object is located at a first location in the three-dimensional environment. In some embodiments, the first object is or includes content, such as website content of virtual object 911, audio content of virtual object 907, and/or video content of virtual object 909 in FIG. 9A. In some embodiments, the first object has one or more of the characteristics of the objects (e.g., the first object) in method 800. In some embodiments, while displaying the first object in the three-dimensional environment, the computer system detects a first input performed by a hand of the user of the computer system directed to the first object. For example, the computer system detects an air gesture performed by a hand of the user of the computer system. In some embodiments, the computer system detects the first input while attention (e.g., gaze) of the user is directed toward the first object in the three-dimensional environment, such as gaze 921 or gaze 923 in FIG. 9A. In some embodiments, the first input has one or more characteristics of the inputs (e.g., air gestures) in method 800. In some embodiments, the interaction point corresponds to a location in the first object at which a selection operation will be performed in response to a respective input performed by the hand of the user. For example, as described in more detail below, the selection operation includes activation of a selectable option that is displayed at or near (e.g., within 0.25, 0.5, 1, 1.5, 2, 3, 4, 5, or 10 cm of) the interaction point directed toward the first object, such as selectable option 904b in virtual object 909 in FIG. 9A. In some embodiments, the interaction point is determined based on a location of the attention of the user directed to the first object when the first input is

detected (e.g., the location of the interaction point is the same as the location of the attention of the user).

In some embodiments, in response to detecting the first input, in accordance with a determination that the first input is an input of a first type and that the interaction point is directed to a first location in the first object when the first input is detected, the computer system activates (1002b) a selection refinement mode in which the interaction point corresponds to the first location in the first object, which optionally includes displaying selection refinement user interface object 912a at the location of the gaze 921 as shown in FIGS. 9B and 9B1. For example, the input of the first type is a refinement air gesture performed by the hand of the user, such as the refinement gesture performed by the hand 903a in FIG. 9A. In some embodiments, as described in more detail below, the refinement air gesture is performed by two or more fingers of the hand of the user, such as the thumb of the user and the index, middle, ring, and/or pinky fingers, such as thumb 910-1 and index finger 910-2, middle finger 910-3, ring finger 910-4, and/or pinky finger 910-5 of the hand 905a in FIG. 9A. In some embodiments, performing the refinement air gesture includes bending and/or arranging the two or more fingers of the hand into a respective shape and/or arrangement, as described in more detail below. In some embodiments, performing the refinement air gesture includes performing an air pinch gesture (e.g., in which the thumb and index finger of the hand of the user start more than a threshold distance (e.g., 0.1, 0.2, 0.5, 1, 2, or 5 cm) apart and come together and touch at the tips) after bending and/or arranging the two or more fingers of the hand into the respective shape and/or arrangement. In some embodiments, if the computer system determines that the first input includes the refinement air gesture and that the attention of the user is directed to the first object when the first input is detected, the computer system activates the selection refinement mode. In some embodiments, activating the selection refinement mode includes displaying a selection refinement cursor (e.g., a hover point) at the first location of the interaction point in the first object, such as the selection refinement user interface object 912a in FIGS. 9B and 9B1. For example, the selection refinement cursor is displayed at the location of the gaze of the user in the first object after and/or when the computer system detects the refinement air gesture, such as display of the selection refinement user interface object 912a at the location of the gaze 921 as shown in FIGS. 9B and 9B1. In some embodiments, the refinement cursor indicates a location in the first object at which a selection operation will be performed in response to further input (e.g., from the hand of the user). In some embodiments, the refinement cursor has one or more characteristics of the refinement cursor in method 800.

In some embodiments, while the selection refinement mode is active and the interaction point is directed to the first location in the first object, such as while the selection refinement user interface object 912a is displayed in the virtual object 907 as shown in FIGS. 9B and 9B1, the computer system detects (1002c), via the one or more input devices, movement of the first portion of the user relative to the first object, such as movement of the hand 903b as shown in FIGS. 9B and 9B1. For example, while the selection refinement cursor is displayed at the first location in the first object, the computer system detects movement of the hand of the user in space relative to the first object in the three-dimensional environment. In some embodiments, the computer system detects the hand of the user move in a respective direction (e.g., in a leftward direction as similarly shown in FIGS. 9B and 9B1) and with a respective magnitude relative to the first object. In some embodiments, the computer system detects the hand of the user move while the two or more fingers of the hand of the user remain in the respective shape and/or arrangement described above. In some embodiments, the computer system detects the hand of the user move while the hand of the user is in the air pinch shape (e.g., while the index finger and thumb of the user are touching, such as the index finger 910-2 and the thumb 910-1 of the hand 903b).

In some embodiments, in response to detecting the movement of the first portion of the user, the computer system associates (1002d) the interaction point with a second location, different from the first location, in the first object in accordance with the movement of the first portion of the user, which optionally includes moving the selection refinement user interface object 912a within the virtual object 907 in accordance with the movement of the hand 903b as shown in FIG. 9C. For example, the computer system moves the interaction point from the first location to the second location based on the movement of the hand of the user in space. In some embodiments, the computer system moves the interaction input to the second location in the first object in accordance with the direction and/or magnitude of the movement of the hand of the user. In some embodiments, the computer system moves the selection refinement cursor in the first object based on the movement of the hand of the user in space. For example, the computer system moves the selection refinement cursor within the first object and displays the selection refinement cursor at the second location in accordance with the movement of the hand. In some embodiments, if the hand of the user moves in a first direction (e.g., rightward or leftward) in space, the computer system moves the interaction point (e.g., and the selection refinement cursor) in the first direction in the first object in accordance with the movement, such as the leftward movement of the selection refinement user interface object 912a within the virtual object 907 as shown in FIG. 9C. In some embodiments, if the hand of the user moves in a second direction (e.g., upward or downward) in space, the computer system moves the interaction point (e.g., and the selection refinement cursor) in the second direction in the first object in accordance with the movement. In some embodiments, if the hand of the user moves with a first magnitude (e.g., of speed and/or distance) in space, the computer system moves the interaction point (e.g., and the selection refinement cursor) a first respective magnitude in the first object that is based on the first magnitude of the movement of the hand. In some embodiments, if the hand of the user moves with a second magnitude (e.g., of speed and/or distance), different from the first magnitude, the computer system moves the interaction point a second respective magnitude, different from the first respective magnitude, in the first object that is based on the second magnitude of the movement of the hand. In some embodiments, the computer system moves the interaction point irrespective of a current location of the attention of the user while the selection refinement mode is active. For example, if the computer system detects the movement of the hand of the user while the attention of the user remains directed toward the first location, such as maintaining the location of the gaze 921 in the virtual object 907 as shown in FIGS. 9B and 9B1, and/or while the attention of the user is directed toward another location (e.g., optionally different from the second location) in the first object, the computer system still moves the interaction point to the second location in accordance with the movement of the hand.

In some embodiments, while the selection refinement mode is active and the interaction point is directed to the second location, such as while the selection refinement user interface object 912a is displayed in the virtual object 911 as shown in FIG. 9D, the computer system detects (1002e), via the one or more input devices, a second input performed by the first portion of the user, such as an air gesture provided by the hand 903d as shown in FIG. 9D. For example, while the selection refinement cursor is displayed at the second location in the first object, the computer system detects a second input performed by the hand of the user. In some embodiments, the second input includes a respective air gesture that is different from that of the first input. In some embodiments, the respective air gesture of the second input has one or more characteristics of the air gestures in method 800.

In some embodiments, in response to detecting the second input, in accordance with a determination that the second input is an input of a second type, different from the first type, the computer system performs (1002f) a first operation associated with the second location in the first object in accordance with the second input, such as selecting selectable option 908c of the virtual object 911 as shown in FIG. 9E. For example, the input of the second type is an activation air gesture performed by the hand of the user. In some embodiments, as described in more detail below, the activation air gesture is performed using the same two or more fingers used to perform the refinement air gesture above. In some embodiments, the activation air gesture corresponds to an air pinch gesture previously described above. In some embodiments, if the computer system determines that the second input includes the activation air gesture, the computer system performs a selection operation at the second location in the first object. For example, the computer system performs the selection operation at the location of the interaction point (e.g., the location at which the selection refinement cursor is displayed) in the first object, such as at the location of the selection refinement user interface object 912a in the virtual object 911 in FIG. 9D. In some embodiments, the computer system activates a selectable option that is located at or near (e.g., within 0, 0.5, 1, 1.5, 2, 3, 5, or 10 cm of) the second location, such as the selectable option 908c located at the location of the selection refinement user interface object 912a in FIG. 9D, which optionally causes the computer system to perform one or more operations corresponding to the selectable option, such as displaying content corresponding to the selectable option 908c as shown in FIG. 9E. In some embodiments, performing the selection operation has one or more characteristics of performing selection operations as described in method 800. In some embodiments, if the computer system determines that the second input is not an input of the second type (e.g., the input is an input of the first type), the computer system performs an alternative operation (e.g., without performing the first operation). For example, if the computer system determines that the second input is an input of the first type (e.g., is a refinement air gesture) discussed above, the computer system deactivates the selection refinement mode (e.g., ceases display of the selection refinement cursor in the first object in the three-dimensional environment) without performing the first operation. Activating a selection refinement mode in response to detecting a first input of a first type that provides an interaction point in an object at which a selection will be performed in response to further input of a second type improves accuracy for performing the selection operation at the interaction point and/or enables the interaction point to be moved without displaying additional controls, thereby improving user-device interaction.

In some embodiments, in response to detecting the first input (1004a), in accordance with a determination that the first input is an input of the second type and that the interaction point is directed to the first location in the first object when the first input is detected, such as while the gaze 923 is directed to the virtual object 909 as shown in FIG. 9A, the computer system performs (1004b) a second operation (e.g., a selection or activation operation) associated with the first location in accordance with the first input, such as selecting the selectable option 904b of the virtual object 909 in FIG. 9A. For example, if the computer system determines that the first input is an input of the second type (e.g., an activation gesture) discussed above with reference to steps 1002a-1002f, the computer system performs the selection operation at the first location in the first object in the three-dimensional environment, such as displaying video content in the virtual object 909 that is associated with the selectable option 904b as shown in FIGS. 9B and 9B1, as similarly described above with reference to steps 1002a-1002f. In some embodiments, the computer system performs the second operation associated with the first location without activating the selection refinement mode discussed above with reference to steps 1002a-1002f. For example, because the first input is an input of the second type, and not the first type, the computer system forgoes activating the selection refinement mode in response to detecting the first input. Performing a selection operation at an interaction point in the three-dimensional environment in response to detecting an input of a second type reduces the number of inputs needed for performing the selection operation at the interaction point and/or helps avoid unintentional activation of a selection refinement mode that is activated in response to detecting an input of a first type, thereby improving user-device interaction.

In some embodiments, the first portion of the user includes a hand of the user (1006a), such as the hand 903a or 905a in FIG. 9A. In some embodiments, the input of the first type and the input of the second type are performed by a same portion of the hand of the user (1006b), such as the fingers 910 or 912 in FIG. 9A. For example, as similarly described above with reference to steps 1002a-1002f, the input of the first type (e.g., the refinement gesture) and the input of the second type (e.g., the activation gesture) are performed with fingers of the hand of the user. In some embodiments, the input of the first type and the input of the second type are performed with the same fingers of the hand of the user, such as the index finger and the thumb of the hand of the user, as similarly described above with reference to steps 1002a-1002f. Activating a selection refinement mode in response to detecting a first input of a first type performed by a hand of the user that provides an interaction point in an object at which a selection will be performed in response to further input of a second type provided by the hand of the user improves accuracy for performing the selection operation at the interaction point and/or enables the interaction point to be moved without displaying additional controls, thereby improving user-device interaction.

In some embodiments, the same portion of the hand of the user includes at least a first finger (e.g., index finger, such as index finger 910-2 in FIG. 9A) and a second finger (e.g., thumb, such as thumb 910-1 in FIG. 9A) of the hand of the user (1008). In some embodiments, the input of the first type and the input of the second type are performed by additional fingers of the user other than the first finger and the second finger. For example, the input of the first type and the input of the second type are also performed using the middle finger (e.g., middle finger 910-3 in FIG. 9A) and/or ring finger (e.g., ring finger 910-4 in FIG. 9A) of the same hand of the user. Activating a selection refinement mode in response to detecting a first input of a first type performed by fingers of a hand of the user that provides an interaction point in an object at which a selection will be performed in response to further input of a second type provided by the fingers of the hand of the user improves accuracy for performing the selection operation at the interaction point and/or enables the interaction point to be moved without displaying additional controls, thereby improving user-device interaction.

In some embodiments, the input of the first type includes an air gesture in which fingers of the hand of the user are arranged in a first shape (1010a) (e.g., a “C-shape” or another hand pose), as similarly described with reference to FIG. 9A. For example, the input of the first type includes a “hand claw” air gesture in which the fingers of the hand of the user are arranged/curled in a C-shape (e.g., resembling a claw), such as the fingers 910-1 – 910-5 of the hand 903a in FIG. 9A. In some embodiments, detecting the input of the first type includes detecting the hand claw air-gesture without detecting any of fingers of the hand contact the thumb. For example, the computer system detects the fingers of the hand are arranged in the C-shape without detecting the index finger, middle finger, ring finger, and/or pinky finger contact the thumb (e.g., at the fingertips).

In some embodiments, the input of the second type includes an air pinch gesture performed by two or more of the fingers (e.g., index finger and thumb) of the hand of the user after the fingers of the hand of the user are arranged in the first shape (1010b), as similarly described with reference to FIG. 9A. For example, the input of the second type includes a hand claw air gesture, followed by an air pinch gesture performed by the index finger and the thumb of the hand. In some embodiments, the computer system detects the index finger (e.g., index finger 912-2 of the hand 905a in FIG. 9A) and thumb (e.g., thumb 912-1 of the hand 905a in FIG. 9A) of the hand make contact while the remaining fingers of the hand are arranged in the first shape, such as the middle finger 912-3, ring finger 912-4, and pinky finger 912-5 of the hand 905a in FIG. 9A. For example, the middle finger, the ring finger, and/or the pinky finger remain curled in the C-shape before and during the contact between the index finger and the thumb of the hand. Activating a selection refinement mode in response to detecting a hand claw air gesture that provides an interaction point in an object at which a selection will be performed in response to an air pinch gesture improves accuracy for performing the selection operation at the interaction point and/or enables the interaction point to be moved without displaying additional controls, thereby improving user-device interaction.

In some embodiments, while the selection refinement mode is active and the interaction point is directed to the second location, the computer system detects (1012a), via the one or more input devices, an end of the first input before detecting the second input, such as a release of the air gesture provided by the hand 903a in FIG. 9A. For example, the computer system detects a release of the refinement gesture. In some embodiments, detecting the end of the first input includes detecting that the fingers of the hand of the user are no longer arranged in one of the gestures described below with reference to steps 1028a-1044b. In some embodiments, detecting the end of the first input includes repositioning and/or moving the fingers of the hand to provide the second input discussed above with reference to steps 1002a-1002f.

In some embodiments, in response to detecting the second input (1012b), in accordance with a determination that the second input is detected within a threshold amount of time (e.g., 0.05, 0.1, 0.2, 0.5, 1, 2, 3, 4, 5, 10, 15, 20, or 30 seconds) of detecting the end of the first input and that the second input is an input of the second type (e.g., an activation gesture, as similarly described above with reference to steps 1002a-1002f), the computer system performs (1012c) the first operation associated with the second location in the first object in accordance with the second input, such as selecting the selectable option 908c of the virtual object 911 in FIG. 9D. For example, as similarly described above with reference to steps 1002a-1002f, if the computer system determines that the second input is detected within the threshold amount of time of detecting the end of the first input, the computer system performs a selection or activation operation directed to the second location in the first object (e.g., activates a selectable option at the second location in the first object) in the three-dimensional environment. In some embodiments, if the second input is detected within the threshold amount of time of detecting the end of the first input but the second input is not an input of the second type (e.g., is an input of the first type described above with reference to steps 1002a-1002f), the computer system deactivates the selection refinement mode. For example, the computer system forgoes performing the first operation associated with the second location (e.g., a selection operation directed to the second location) in the first object in the three-dimensional environment.

In some embodiments, in accordance with a determination that the second input is not detected within the threshold amount of time (e.g., 0.05, 0.1, 0.2, 0.5, 1, 2, 3, 4, 5, 10, 15, 20, or 30 seconds) of detecting the end of the first input, the computer system forgoes (1012d) performing the first operation associated with the second location in the first object, such as forgoing selection of selectable option 916 in virtual object 909 in FIG. 9D. For example, if the computer system determines that the second input is not detected within the threshold amount of time of detecting the end of the first input, the computer system forgoes performing a selection or activation operation directed to the second location in the first object in the three-dimensional environment. In some embodiments, the computer system deactivates the selection refinement mode when the threshold amount of time has elapsed since detecting the end of the first input without detecting the second input, which optionally includes ceasing display of the selection refinement user interface object 912b in the virtual object 909 as shown in FIG. 9E. In some embodiments, the computer system alternatively performs a selection operation or activation operation based on a location of the attention of the user in the three-dimensional environment in response to detecting the second input after the threshold amount of time has elapsed since detecting the end of the first input. For example, the computer system performs the selection operation directed to a third location, optionally different from the second location, in the first object to which the gaze of the user is directed when the second input is detected, such as selecting selectable option 904b based on the location of the gaze 923 in the virtual object t909 in FIG. 9A, rather than performing the selection operation directed to the second location with which the interaction point is associated, as discussed above with reference to steps 1002a-1002f, in response to detecting the second input after the threshold amount of time elapses. Maintaining a selection refinement mode, which provides an interaction point in an object at which a selection will be performed in response to further input, active for a threshold amount of time improves accuracy for performing the selection operation at the interaction point and/or facilitates user input for providing the further input for performing the selection operation, thereby improving user-device interaction.

In some embodiments, the determination that the second input is an input of the second type is independent of whether the first input is an input of the first type (1014a) (e.g., the computer system classifies an input as being an input of the second type irrespective of whether an input of the first type is detected prior to detecting the input of the second type), such as determining that the input provided by the hand 905a is an input of the second type irrespective of whether the hand 905a provided an input of the first type first as similarly described with reference to FIG. 9A. In some embodiments, in response to detecting the first input (1014b), in accordance with a determination that the first input is an input of the second type, the computer system performs (1014c) the first operation (e.g., the selection operation) associated with the first location in accordance with the first input, such as selecting the selectable option 904b in the virtual object 909 in FIG. 9A. For example, if the computer system determines that the first input is an input of the second type (e.g., an activation gesture) discussed above with reference to steps 1002a-1002f, the computer system performs the selection operation at the first location in the first object in the three-dimensional environment, as similarly described above with reference to steps 1002a-1002f. In some embodiments, the computer system performs the second operation associated with the first location without activating the selection refinement mode discussed above with reference to steps 1002a-1002f. For example, because the first input is an input of the second type, and not the first type, the computer system forgoes activating the selection refinement mode in response to detecting the first input. Performing a selection operation at an interaction point in the three-dimensional environment in response to detecting an input of a second type reduces the number of inputs needed for performing the selection operation at the interaction point and/or helps avoid unintentional activation of a selection refinement mode that is activated in response to detecting an input of a first type, thereby improving user-device interaction.

In some embodiments, after performing the first operation associated with the second location in accordance with the second input, such as after selecting the selectable option 904b of the virtual object 909 in FIG. 9A, the computer system detects (1016a), via the one or more input devices, a third input performed by the first portion of the user, such as an air gesture provided by the hand 905b in FIGS. 9B and 9B1. For example, the computer system detects an air gesture provided by the hand of the user, as similarly described above with reference to steps 1002a-1002f). In some embodiments, the attention of the user is directed to the first object in the three-dimensional environment when the third input is detected.

In some embodiments, in response to detecting the third input (1016b), in accordance with a determination that the third input is an input of the second type (e.g., an activation gesture) and that the interaction point is directed to a respective location in the first object when the third input is detected, the computer system performs (1016c) a second operation (e.g., a selection operation or activation operation) associated with the respective location in accordance with the third input, such as selecting selectable option 913 of the virtual object 909 in FIGS. 9B and 9B1. For example, if the computer system detects an activation gesture while the attention of the user is directed to the respective location in the first object, the computer system performs a selection operation directed to the respective location in the first object (e.g., activates a selectable option at the respective location in the first object). In some embodiments, the computer system performs the second operation without activating the selection refinement mode (e.g., because the third input is an input of the second type, and not an input of the first type, as similarly discussed above with reference to steps 1002a-1002f), such as without displaying the selection refinement user interface object in the virtual object 909 as shown in FIG. 9C. In some embodiments, as mentioned above with reference to steps 1014a-1014c, the computer system performs the selection operation in response to detecting an activation gesture irrespective of whether an activation gesture or a refinement gesture was detected before detecting the activation gesture. For example, as discussed above, the computer system performs the selection operation in response to detecting the third input irrespective of whether the first input (e.g., discussed above with reference to steps 1002a-1002f and 1014a-1014c) is an input of the first type (e.g., a refinement gesture) or an input of the second type (e.g., an activation gesture). Performing a selection operation at an interaction point in the three-dimensional environment in response to detecting an input of a second type irrespective of whether an input of a first type was detected prior to the input of the second type reduces the number of inputs needed for performing the selection operation at the interaction point and/or helps avoid unintentional activation of a selection refinement mode that is activated in response to detecting the input of a first type, thereby improving user-device interaction.

In some embodiments, activating the selection refinement mode in which the interaction point corresponds to a respective location in the first object includes displaying, via the display generation component, a selection refinement user interface object (e.g., a cursor) at the respective location in the first object (1018), such as the selection refinement user interface object 912a in FIGS. 9B and 9B1. For example, as similarly discussed above with reference to steps 1002a-1002f, activating the selection refinement mode includes displaying the selection refinement user interface object at the interaction point in the first object in the three-dimensional environment. In some embodiments, because the interaction point corresponds to a location at which a selection operation will be performed in response to detecting further input (e.g., an activation gesture), the selection refinement user interface object functions as a visual indication of the interaction point in the three-dimensional environment. In some embodiments, as similarly described above with reference to steps 1002a-1002f, the computer system moves the selection refinement user interface object in accordance with movement of the hand of the user while the selection refinement mode is active. Displaying a selection refinement user interface object that indicates an interaction point in an object at which a selection will be performed in response to further input when a selection refinement mode is active facilitates discovery that the selection refinement mode is active, thus improving accuracy for performing the selection operation at the interaction point, and/or provides visual feedback for movement of the interaction point in the object, thereby improving user-device interaction.

In some embodiments, in response to detecting the movement of the first portion of the user, associating the interaction point with the second location in the first object in accordance with the movement of the first portion of the user includes displaying the selection refinement user interface object at the second location (1020a) (e.g., the computer system moves

the selection refinement user interface to the second location in the first object in accordance with the movement of the hand, as similarly described above with reference to steps 1002a-1002f), such as displaying the selection user interface object 912a in the virtual object 907 as shown in FIG. 9C. In some embodiments, in accordance with a determination that the movement of the first portion of the user corresponds to movement of the interaction point beyond a boundary of the first object (1020b) (e.g., an edge or corner of the first object), such as an edge of the virtual object 907 in FIG. 9C, the second location is within the boundary of the first object, such as displaying the selection user interface object 912a at the left edge of the virtual object 907 as shown in FIG. 9C. For example, as similarly discussed above with reference to steps 1002a-1002f, the computer system detects the movement of the hand of the user in a respective direction and/or with a respective magnitude (e.g., of speed and/or distance), such as the movement of the hand 903b as shown in FIGS. 9B and 9B1. In some embodiments, if the movement of the hand of the user in the respective direction (e.g., leftward or rightward, upward or downward) and with the respective magnitude corresponds to movement of the interaction point beyond the boundary of the first object, the computer system prevents movement of the interaction point beyond the boundary of the first object. For example, the computer system moves the selection refinement user interface object from the first location in the first object to the second location in the first object in accordance with the movement of the hand of the user, until the movement of the hand corresponds to movement of the selection refinement user interface object beyond the boundary of the first object, such as beyond the left edge of the virtual object 907 in FIGS. 9B and 9B1. In some embodiments, the computer system moves the selection refinement user interface object along the boundary of the first object based on a portion of the movement of the hand. For example, if the computer system has moved the selection refinement user interface object to a left edge of the first object, in accordance with leftward movement of the hand of the user, and the hand of the user moves in space with a vertical component relative to the first object (e.g., diagonally leftward or upward), the computer system moves the selection refinement user interface object vertically along with left edge of the first object based on the vertical component of the movement of the hand in space, such as movement of the selection refinement user interface object 912a vertically along the left edge of the virtual object 907 as shown in FIG. 9C.

In some embodiments, in accordance with a determination that the movement of the first portion of the user corresponds to movement of the interaction point within the boundary of the first object, the second location is within the boundary of the first object (1020c), such as display of the selection refinement user interface object 912a within the virtual object 907 in FIG. 9C. For example, if the movement of the hand of the user in the respective direction and with the respective magnitude corresponds to movement of the interaction point within the boundary of the first object, the computer system moves the interaction point in accordance with the movement of the hand. In some embodiments, the computer system moves the selection refinement user interface object to the second location in accordance with the movement of the hand of the user. Limiting movement of a selection refinement user interface object, which indicates an interaction point in an object at which a selection will be performed in response to further input, based on movement of a hand of the user reduces the number of inputs needed to move the interaction point in the first object and/or avoids unintentional movement of the interaction point to a second object in the three-dimensional environment, thereby improving user-device interaction.

In some embodiments, while the selection refinement mode is active and the selection refinement user interface object is displayed at the first location in the first object, such as while the selection refinement user interface object 912a is displayed in the virtual object 907 in FIG. 9C, the computer system detects (1022a), via the one or more input devices, a third input performed by the first portion of the user, such as an air gesture provided by the hand 903c as shown in FIG. 9C. For example, the computer system detects an air gesture provided by the hand of the user, as similarly described above with reference to steps 1002a-1002f. In some embodiments, the attention of the user is directed to a respective location in the three-dimensional environment when the third input is detected.

In some embodiments, in response to detecting the third input (1022b), in accordance with a determination that the third input is an input of the first type (e.g., a refinement gesture) and attention (e.g., gaze) of the user is directed to a third location in a second object in the environment, such as the gaze 921 directed to the virtual object 911 as shown in FIG. 9C, the computer system associates (1022c) the interaction point with the third location in the second object and displays, via the display generation component, the selection refinement user interface object at the third location, such as displaying the selection refinement user interface object 912a at the location of the gaze 921 in the virtual object 911 as shown in FIG. 9D. For example, if the computer system determines that the third input is a refinement gesture and that the attention of the user is directed to a second object (e.g., separate from the first object) in the three-dimensional environment when the third input is detected, the computer system moves the interaction point to the second object and displays the selection refinement user interface object in the second object at the location of the attention of the user. In some embodiments, the computer system ceases display of the selection refinement user interface object at the first location in the first object when the interaction point is moved to the third location in the second object in response to detecting the third input, such as ceasing display of the selection refinement user interface object 912a in the virtual object 907 as shown in FIG. 9D. For example, the computer system ceases display of the selection refinement user interface object in the first object and redisplays the selection refinement user interface object in the second object in response to detecting the third input. Moving a selection refinement user interface object, which indicates an interaction point in a first object at which a selection will be performed in response to further input, from the first object to a second object in response to detecting an input of a first type while attention of the user is directed to the second object reduces the number of inputs needed to move the interaction point to the first object and/or helps avoid unintentional movement of the interaction point to the second object, thereby improving user-device interaction.

In some embodiments, attention (e.g., gaze) of the user is directed to the first location in the first object when the first input is detected (1024a), such as the gaze 921 directed to the virtual object 907 as shown in FIG. 9A. In some embodiments, while the selection refinement mode is active and the selection refinement user interface object is displayed at the first location in the first object, such as while the selection refinement user interface object is displayed in the virtual object 907 as shown in FIGS. 9B and 9B1, the computer system detects (1024b), via the one or more input devices, the attention of the user directed to a third location in a second object in the environment, such as movement of the gaze 921 to the virtual object 911 as shown in FIG. 9C. For example, the computer system detects a location of the attention of the user move from the first location in the first object to the third location in the second object in the three-dimensional environment. In some embodiments, the computer system detects the movement of the attention of the user without detecting input from a hand of the user, such as without detecting an air gesture provided by the hand 903c in FIG. 9C. For example, the computer system does not detect an air gesture provided by a hand of the user when the attention of the user is directed to the third location in the second object in the three-dimensional environment.

In some embodiments, in response to detecting the attention of the user directed to the third location, the computer system associates (1024c) the interaction point with the third location in the second object and displays, via the display generation component, the selection refinement user interface object at the third location, such as displaying the selection refinement user interface object 912a at the location of the gaze 921 in the virtual object 911 as shown in FIG. 9D. For example, in response to detecting the attention of the user is directed from the first location in the first object to the third location in the second object in the three-dimensional environment, the computer system moves the interaction point to the second object and displays the selection refinement user interface object in the second object at the location of the attention of the user. In some embodiments, the computer system ceases display of the selection refinement user interface object at the first location in the first object when the interaction point is moved to the third location in the second object in response to detecting the movement of the attention of the user, such as ceasing display of the selection refinement user interface object 912a in the virtual object 907 as shown in FIG. 9D. For example, the computer system ceases display of the selection refinement user interface object in the first object and redisplays the selection refinement user interface object in the second object in response to detecting the attention directed to the third location in the second object. Moving a selection refinement user interface object, which indicates an interaction point in a first object at which a selection will be performed in response to further input, from the first object to a second object in response to detecting attention of the user directed to the second object reduces the number of inputs needed to move the interaction point to the first object and/or enables the interaction point to be moved to the second object automatically, thereby improving user-device interaction.

In some embodiments, while the interaction point is directed to a respective location in the first object (e.g., because the attention of the user is directed to the respective location in the first object), the computer system detects (1026a), via the one or more input devices, movement of attention of the user directed within the first object in the environment, such as movement of the gaze 923 in the virtual object 909 as shown in FIGS. 9B and 9B1. For example, the computer system detects a location of the attention of the user move from the respective location in the first object to a second respective location in the first object in the three-dimensional environment. In some embodiments, the computer system detects the movement of the attention of the user without detecting input from a hand of the user. For example, the computer system does not detect an air gesture provided by a hand of the user when the attention of the user is directed away from the respective location in the first object in the three-dimensional environment.

In some embodiments, while detecting the movement of the attention of the user within the first object (1026b), in accordance with a determination that the selection refinement mode is not active when the movement of the attention of the user is detected, the computer system moves (1026c) the interaction point away from the respective location in the first object in accordance with the movement of the attention of the user, such as associating the interaction point with the location of the gaze 923 in the virtual object 909 in FIGS. 9B and 9B1. For example, the computer system detects the attention of the user move in the first object in a respective direction and/or with a respective magnitude (e.g., of speed and/or distance). In some embodiments, if the selection refinement mode is not active when the movement of the attention is detected, the computer system moves the interaction point in accordance with the respective direction and/or the respective magnitude of the movement of the attention of the user. For example, if the computer system detects an input of the second type (e.g., an activation gesture, as previously discussed above with reference to steps 1002a-1002f) after the movement of the attention of the user, the computer system performs a selection operation based on the new location of the interaction point in the first object (e.g., activates a selectable option at the new location of the interaction point determined based on the movement of the attention of the user).

In some embodiments, in accordance with a determination that the selection refinement mode is active when the movement of the attention of the user is detected, the computer system maintains (1026d) the interaction point directed to the respective location in the first object, such as maintaining the interaction point at the location of the selection refinement user interface object 912a in the virtual object 907 in FIG. 9C. For example, if the selection refinement mode is active when the movement of the attention is detected, the computer system forgoes moving the interaction point in accordance with the respective direction and/or the respective magnitude of the movement of the attention of the user. For example, if the computer system detects an input of the second type (e.g., an activation gesture) after the movement of the attention of the user, the computer system performs a selection operation directed to the respective location in the first object (e.g., activates a selectable option at the respective location in the first object determined based on the interaction point), rather than performing a selection operation based on the new location of the attention of the user in the first object.

In some embodiments, while the selection refinement mode is active and the interaction point is directed to the respective location in the first object, the computer system detects (1026e), via the one or more input devices, movement of the first portion of the user relative to the first object, such as movement of the hand 903b as shown in FIGS. 9B and 9B1. For example, as similarly described above with reference to steps 1002a-1002f, the computer system detects movement of the hand of the user in space. In some embodiments, the computer system detects the movement of the hand relative to the first object while the attention of the user is directed to the respective location in the first object. In some embodiments, the computer system detects the movement of the hand relative to the first object without detecting movement of the attention of the user within the first object.

In some embodiments, in response to detecting the movement of the first portion of the user, the computer system moves (1026f) the interaction point away from the respective location in the first object in accordance with the movement of the first portion of the user, such as moving the selection refinement user interface object 912a in the virtual object 907 in accordance with the movement of the hand 903b as shown in FIG. 9C. For example, as similarly described above with reference to steps 1002a-1002f, the computer system detects the hand of the user move in a respective direction and/or with a respective magnitude (e.g., of speed and/or distance). In some embodiments, while the selection refinement mode is active, the computer system moves the interaction point within the first object in accordance with the movement of the hand of the user. For example, the computer system moves the interaction in the respective direction and/or with the respective magnitude. In some embodiments, the computer system moves the interaction point irrespective of the attention of the user. For example, the computer system moves the interaction point away from the respective location in the first object in accordance with the movement of the hand of the user irrespective of whether the attention of the user moves (or does not move) in the first object. As similarly discussed above, if the computer system detects an input of the second type (e.g., an activation gesture) after the movement of the hand of the user, the computer system optionally performs a selection operation based on the new location of the interaction point in the first object (e.g., activates a selectable option at the new location of the interaction point determined based on the movement of the hand of the user). Moving an interaction point in an object at which a selection will be performed in response to further input based on movement of attention of the user or movement of a hand of the user depending on whether a selection refinement mode is active reduces the number of inputs needed to move the interaction point in the object and/or helps avoid unintentional movement of the interaction point in the object, thereby improving user-device interaction.

In some embodiments, the first portion of the user includes a hand of the user (1028a), such as the hand 903a in FIG. 9A. In some embodiments, the input of the first type corresponds to an air gesture in which fingers of the hand are arranged in a first shape (1028b) (e.g., a “C-shape” or other hand pose), such as the fingers 910-1 to 910-5 of the hand 903a in FIG. 9A. For example, the input of the first type includes a “hand claw” air gesture in which the fingers of the hand of the user are arranged/curled in a C-shape (e.g., resembling a claw). In some embodiments, detecting the input of the first type includes detecting the hand claw air-gesture without detecting any of fingers of the hand contact the thumb. For example, the computer system detects the fingers of the hand are arranged in the C-shape without detecting the index finger, middle finger, ring finger, and/or pinky finger contact the thumb (e.g., at the fingertips). Activating a selection refinement mode in response to detecting a hand claw air gesture that provides an interaction point in an object at which a selection will be performed in response to further input improves accuracy for performing the selection operation at the interaction point and/or helps avoid unintentional activation of the selection refinement mode, thereby improving user-device interaction.

In some embodiments, the first portion of the user includes a hand of the user (1030a), such as the hand 903a in FIG. 9A. In some embodiments, the input of the first type corresponds to an air gesture in which fingers (e.g., index finger and thumb, such as index finger 910-2 and thumb 910-1 in FIG. 9A) of the hand are arranged in a first shape (e.g., curled in a “C-shape” or other hand pose), and includes movement of the fingers relative to a palm of the hand (e.g., movement of the index finger and the thumb away from the palm of the hand) after the fingers are arranged in the first shape (1030b), such as movement of the index finger 910-2 and the thumb 910-1 away from the palm of the hand 903a in FIG. 9A. For example, the computer system detects the hand of the user perform a “pincer pump air gesture” using the fingers of the hand. The pincer pump air gesture optionally includes the index finger and the thumb of the hand of the user arranged/curled in the C-shape, while the remaining fingers of the hand (e.g., the middle finger, ring finger, and/or pinky finger) are not curled in the C-shape and/or are pointed away from the palm of the hand (e.g., upright relative to the palm of the hand). In some embodiments, the computer system detects the index finger and the thumb of the hand are arranged in the first shape without detecting contact between the index finger and the thumb. For example, the index finger and the thumb of the hand are curled into the C-shape but do not contact (e.g., do not perform an air pinch gesture), such that the index finger and the thumb remain at least a threshold distance apart (e.g., 0.05, 0.1, 0.25, 0.5, 0.75, 1, 1.5, 2, 3, 4, or 5 cm apart) while in the C-shape. While the index finger and the thumb of the hand are arranged in the first shape, the computer system optionally detects the index finger and the thumb perform a “pumping” motion relative to the palm of the hand. For example, the index finger and the thumb uncurl and extend/point outwardly away from the palm of the hand in space while remaining at least the threshold distance apart. Activating a selection refinement mode in response to detecting a pincer pump air gesture that provides an interaction point in an object at which a selection will be performed in response to further input improves accuracy for performing the selection operation at the interaction point and/or helps avoid unintentional activation of the selection refinement mode, thereby improving user-device interaction.

In some embodiments, detecting the fingers of the hand are arranged in the first shape is based on a detected angle between a first finger portion (e.g., a finger portion corresponding to a first finger bone such as a distal phalanx bone) and a second finger portion (e.g., a finger portion corresponding to a second finger bone such as a medial phalanx bone) of the fingers of the hand (1032), such as between bones of the index finger 910-2 and thumb 910-1 of the hand 903a in FIG. 9A. For example, when the computer system detects an input provided by the hand of the user, the computer system determines whether the input corresponds to the pincer pump air gesture (e.g., an input of the first type) based on the angle between the portions of the index finger and the thumb corresponding to the distal phalanges and the medial phalanges of the index finger and the thumb of the hand of the user. In some embodiments, the computer system determines that the fingers of the hand are arranged in the first shape if the detected angle between the first finger portion and the second finger portion is less than a predefined angle (e.g., 180 degrees). For example, when the index finger (e.g., index finger 910-2 in FIG. 9A) and the thumb (e.g., thumb 910-1 in FIG. 9A) are pointed away from the palm of the hand of the user, the angle between the finger portion corresponding to the distal phalanx and the finger portion corresponding to the medial phalanx of the index finger and the thumb is equal to the predefined angle (e.g., equal to approximately 180 degrees). When the index finger and the thumb are arranged in the first shape (e.g., curled in the C-shape), the angle between the finger portion corresponding to the distal phalanx and the finger portion corresponding to the medial phalanx of the index finger and the thumb is optionally less than the predefined angle (e.g., less than approximately 180 degrees). Activating a selection refinement mode in response to detecting a pincer pump air gesture, based on an angle between finger bones of the fingers of the hand of the user, that provides an interaction point in an object at which a selection will be performed in response to further input improves accuracy for performing the selection operation at the interaction point and/or helps avoid unintentional activation of the selection refinement mode, thereby improving user-device interaction.

In some embodiments, the movement of the fingers relative to the palm of the hand includes movement of a first finger (e.g., index finger, middle finger, ring finger, and/or pinky finger) and a second finger (e.g., thumb) of the hand relative to the palm of the hand (1034), such as movement of the index finger 910-2, middle finger 910-3, ring finger 910-4, or pinky finger 910-5 and the thumb 910-1 relative to the palm of the hand 903a in FIG. 9A. For example, as similarly discussed above with reference to steps 1030a-1030b, the computer system detects the index finger and the thumb of the hand uncurl and extend/point outwardly away from the palm of the hand in space. Activating a selection refinement mode in response to detecting a pincer pump air gesture that includes movement of a first finger and a second finger relative to the palm of the hand of the user and that provides an interaction point in an object at which a selection will be performed in response to further input improves accuracy for performing the selection operation at the interaction point and/or helps avoid unintentional activation of the selection refinement mode, thereby improving user-device interaction.

In some embodiments, the movement of the fingers relative to the palm of the hand (e.g., of the hand 903a in FIG. 9A) is detected within a threshold amount of time (e.g., 0.05, 0.1, 0.2, 0.5, 0.75, 1, 1.5, 2, 3, 4, 5, 8, or 10 seconds) of detecting the fingers (e.g., the index finger 910-2 and the thumb 910-1 in FIG. 9A) of the hand are arranged in the first shape (1036). For example, after the computer system detects that the index finger and the thumb of the hand of the user are arranged in the first shape (e.g., curled in the C-shape), the computer system detects the movement of the index finger and the thumb away from the palm of the hand discussed above with reference to steps 1030a-1030b within the threshold amount of time of detecting the fingers arranged in the first shape. In some embodiments, if the computer system does not detect the movement of the fingers relative to the palm of the hand within the threshold distance of detecting the fingers of the hand are arranged in the first shape, the computer system forgoes activating the selection refinement mode, as similarly described above with reference to steps 1002a-1002f. Activating a selection refinement mode in response to detecting a pincer pump air gesture that includes movement of a first finger and a second finger relative to the palm of the hand within a threshold amount of time and that provides an interaction point in an object at which a selection will be performed in response to further input improves accuracy for performing the selection operation at the interaction point and/or helps avoid unintentional activation of the selection refinement mode, thereby improving user-device interaction.

In some embodiments, the first portion of the user includes a hand of the user (1038a), such as the hand 903a in FIG. 9A. In some embodiments, the input of the first type corresponds to an air gesture that includes movement of a first finger (e.g., thumb, such as thumb 910-1 in FIG. 9A) of the hand relative to a second finger (e.g., index finger, middle finger, ring finger, or pinky finger) of the hand while the first finger of the hand is in contact with the second finger of the hand (1038b), such as index finger 910-2, middle finger 910-3, ring finger 910-4, or pinky finger 910-5 in FIG. 9A. For example, the computer system detects the hand of the user perform a “pinch slide air gesture” in which the index finger and the thumb of the hand of the user make contact. While the thumb is contacting the index finger of the hand of the user, the computer system optionally detects the thumb of the user move relative to the index finger, such as movement of the thumb 910-1 relative to the index finger 910-2 in FIG. 9A. For example, the computer system detects the thumb slide across a side portion of the index finger of the hand. In some embodiments, the computer system detects the thumb move relative to the index finger of the hand in a respective direction. For example, when the thumb and the index finger of the hand contact at the fingertips, the computer system detects the thumb slide from the fingertip of the index finger along the index finger (e.g., along the portions of the index finger spanning the distal phalanx and/or the medial phalanx) towards the knuckle of the index finger. In some embodiments, the direction of the movement of the thumb relative to the index finger of the hand of the user is in the opposite direction than that described above for detecting the pinch slide air gesture. For example, the computer system detects the thumb slide across a side portion of the index finger of the hand (e.g., along the portions of the index finger spanning the medial phalanx and/or the distal phalanx) toward the fingertip of the index finger. Activating a selection refinement mode in response to detecting a pinch slide air gesture that provides an interaction point in an object at which a selection will be performed in response to further input improves accuracy for performing the selection operation at the interaction point and/or helps avoid unintentional activation of the selection refinement mode, thereby improving user-device interaction.

In some embodiments, while the selection refinement mode is active and the interaction point is directed to the first location in the first object, such as while the selection refinement user interface object 912b is displayed in the virtual object 909 in FIG. 9D, the computer system detects (1040a), via the one or more input devices, a third input performed by the hand of the user, such as an air gesture provided by the hand 905d as shown in FIG. 9D. For example, the computer system detects an air gesture provided by the hand of the user, as similarly described above with reference to steps 1002a-1002f. In some embodiments, the attention of the user is directed to the first object in the three-dimensional environment when the third input is detected.

In some embodiments, in response to detecting the third input (1040b), in accordance with a determination that the third input is an input of the first type (e.g., a refinement gesture) because the third input corresponds to an air gesture (e.g., a pinch slide air gesture, as discussed above with reference to steps 1038a-1038b) that includes movement of the first finger of the hand relative to the second finger of the hand while the first finger of the hand is in contact with the second finger of the hand, such as movement of the thumb 910-1 relative to the index finger 910-2 in FIG. 9A, the computer system deactivates (1040c) the selection refinement mode, such as ceasing display of the selection refinement user interface object 912b in the virtual object 909 as shown in FIG. 9E. For example, in response to determining that the first input includes a pinch slide air gesture, the computer system activates the selection refinement mode in which the interaction point is directed to the first location in the first object. In some embodiments, if the computer system determines that the third input includes an input of the first type because the third input is another pinch slide air gesture, the computer system deactivates the selection refinement mode. For example, as similarly described above with reference to steps 1002a-1002f, the computer system ceases display of the selection user interface object in the first object. Further, as similarly described above with reference to steps 1002a-1002f, when the computer system deactivates the selection refinement mode, the computer system optionally moves the interaction point away from the first location in the first object (e.g., optionally to a location of the attention of the user when the third input is detected, such as the location of the gaze 923 in the virtual object 909 in FIG. 9E). Deactivating a selection refinement mode in response to detecting a pinch slide air gesture while the selection refinement mode is active reduces the number of inputs needed to deactivate the selection refinement mode and/or enables the selection refinement mode to be deactivated without displaying additional controls, thereby improving user-device interaction.

In some embodiments, the air gesture includes movement of the first finger (e.g., thumb 910-1 in FIG. 9A) in a first direction relative to the second finger (e.g., index finger 910-2 in FIG. 9A) of the hand while the first finger of the hand is in contact with the second finger of the hand (1042a) (e.g., movement of the thumb toward or away from the fingertip of the index finger and along a side portion of the index finger (e.g., along the portions of the index finger spanning the distal phalanx and/or the medial phalanx)). In some embodiments, while the selection refinement mode is active and the interaction point is directed to the first location in the first object, such as while the selection refinement user interface object 912b is displayed in the virtual object 909 in FIG. 9D, the computer system detects (1042b), via the one or more input devices, a third input performed by the hand of the user, such as an air gesture provided by the hand 905d as shown in FIG. 9D. For example, the computer system detects an air gesture provided by the hand of the user, as similarly described above with reference to steps 1002a-1002f. In some embodiments, the attention of the user is directed to the first object in the three-dimensional environment when the third input is detected.

In some embodiments, in response to detecting the third input (1042c), in accordance with a determination that the third input corresponds to an air gesture (e.g., a pinch slide air gesture) that includes movement of the first finger in a second direction, within a directional threshold (e.g., 0, 1, 2, 5, 8, 10, 15, 20, 25, 30, or 40 degrees) of being opposite to the first direction, relative to the second finger of the hand while the first finger of the hand is in contact with the second finger of the hand, the computer system deactivates (1042d) the selection refinement mode, such as ceasing display of the selection refinement user interface object 912b in the virtual object 909 as shown in FIG. 9E. For example, in response to determining that the first input includes a pinch slide air gesture in which the thumb of the hand slides in a first direction across the index finger (e.g., away from the fingertip of the index finger), the computer system activates the selection refinement mode in which the interaction point is directed to the first location in the first object. In some embodiments, if the computer system determines that the third input includes a pinch slide air gesture in which the thumb of the hand slides in the second direction across the index finger (e.g., toward the fingertip of the index finger), the computer system deactivates the selection refinement mode. For example, after the computer system detects the first input that caused the activation of the selection refinement mode, the thumb is located away from the fingertip of the index finger (e.g., is contacting a portion of the index finger that includes the medial phalanx or the proximal phalanx). When the computer system detects the third input, the computer system optionally detects the thumb slide across the index finger back toward the fingertip of the index finger (e.g., in the second direction across the side portion of the index finger toward the fingertip of the index finger). In some embodiments, as similarly described above with reference to steps 1002a-1002f, when the computer system deactivates the selection refinement mode, the computer system ceases display of the selection user interface object in the first object. Further, as similarly described above with reference to steps 1002a-1002f, when the computer system deactivates the selection refinement mode, the computer system optionally moves the interaction point away from the first location in the first object (e.g., optionally to a location of the attention of the user when the third input is detected, such as the location of the gaze 923 in the virtual object 909 in FIG. 9E). Deactivating a selection refinement mode in response to detecting a pinch slide air gesture that includes movement of a first finger in a respective direction relative to a second finger of the hand while the selection refinement mode is active reduces the number of inputs needed to deactivate the selection refinement mode and/or enables the selection refinement mode to be deactivated without displaying additional controls, thereby improving user-device interaction.

In some embodiments, the first portion of the user includes a hand of the user (1044a), such as the hand 903a in FIG. 9A. In some embodiments, the input of the first type corresponds to an air gesture in which a first finger (e.g., index finger, middle finger, ring finger, and/or pinky finger) and a second finger (e.g., thumb) of the hand, such as the index finger 910-2 and the thumb 910-1 of the hand 903a in FIG. 9A, are arranged in a first shape (e.g., curled in a “C-shape” or other hand pose), and a subset of one or more fingers, other than the first finger and the second finger, such as the middle finger 910-3, ring finger 910-4, and/or pinky finger 910-5 in FIG. 9A, of the hand are arranged in a second shape (e.g., outstretched/pointed (away from the palm of the hand)), different from the first shape (1044b). For example, the computer system detects the hand of the user perform a “pincer claw air gesture” using the fingers of the hand. The pincer claw air gesture optionally includes the index finger and the thumb of the hand of the user arranged/curled in the C-shape, while the remaining fingers of the hand (e.g., the middle finger, ring finger, and/or pinky finger) are not curled in the C-shape and/or are pointed away from the palm of the hand (e.g., upright relative to the palm of the hand). In some embodiments, the computer system detects the first finger (e.g., index finger 910-2 in FIG. 9A) and the second finger (e.g., thumb 910-1 in FIG. 9A) of the hand are arranged in the first shape without detecting contact between the first finger and the second finger. For example, the index finger and the thumb of the hand are curled into the C-shape but do not contact (e.g., do not perform an air pinch gesture), such that the index finger and the thumb remain at least a threshold distance apart (e.g., 0.05, 0.1, 0.25, 0.5, 0.75, 1, 1.5, 2, 3, 4, or 5 cm apart) while in the C-shape. Activating a selection refinement mode in response to detecting a pincer claw air gesture that provides an interaction point in an object at which a selection will be performed in response to further input improves accuracy for performing the selection operation at the interaction point and/or enables the interaction point to be moved without displaying additional controls, thereby improving user-device interaction.

In some embodiments, while the selection refinement mode is active and the interaction point is directed to the first location in the first object, such as while the selection refinement user interface object 912b is displayed in the virtual object 909 in FIG. 9D, the computer system detects (1046a), via the one or more input devices, an end of the first input, such as a release of an air gesture provided by the hand 905d in FIG. 9D. For example, the computer system detects a release of the refinement gesture provided by the hand of the user), such that the hand of the user is no longer performing any of the gestures described above with reference to steps 1028a-1044b. In some embodiments, detecting the end of the first input includes detecting that the fingers of the hand (e.g., the index finger and the thumb of the hand) of the user are no longer touching.

In some embodiments, in response to detecting the end of the first input, the computer system deactivates (1046c) the selection refinement mode in which the interaction point corresponds to the first location in the first object, such as ceasing display of the selection refinement user interface object 912b in the virtual object 909 as shown in FIG. 9E. For example, the selection refinement mode remains active for a duration that the refinement gesture is maintained (e.g., before detecting the end of the first input). In some embodiments, if the computer system detects the end of the first input (e.g., a release of the refinement gesture), the computer system deactivates the selection refinement mode. In some embodiments, if the computer system does not detect an input of the second type (e.g., an activation gesture) before detecting the end of the first input (or within a threshold amount of time (e.g., 0.05, 0.1, 0.2, 0.5, 0.75, 1, 1.5, 2, 3, 4, 5, 8, or 10 seconds) of detecting the end of the first input as described with reference to steps 1012a-1012d), the computer system deactivates the selection refinement mode without performing the first operation (e.g., the selection operation) directed toward the first object in the three-dimensional environment. In some embodiments, if the computer system detects movement of the first portion of the user (e.g., the hand of the user) after the end of the first input is detected, the computer system forgoes performing selection refinement operations. For example, as similarly described above with reference to steps 1002a-1002f, the computer system forgoes associating the interaction point with a different location (e.g., a second location) in the first object based on the movement of the hand of the user because the selection refinement mode is no longer active. Deactivating a selection refinement mode in response to detecting an end of an input of a first type while the selection refinement mode is active reduces the number of inputs needed to deactivate the selection refinement mode and/or enables the selection refinement mode to be deactivated without displaying additional controls, thereby improving user-device interaction.

In some embodiments, in response to detecting the second input (1048a) (e.g., and while the selection refinement user interface object 912b is displayed in the virtual object 909 in FIG. 9D), in accordance with a determination that the second input is an input of the first type (e.g., a refinement gesture, as similarly described above with reference to steps 1002a-1002f), the computer system deactivates (1048b) the selection refinement mode in which the interaction point corresponds to the second location in the first object, such as ceasing display of the selection refinement user interface object 912b in the virtual object 909 as shown in FIG. 9E. For example, after the selection refinement mode is activated in response to detecting the first input, as similarly described above with reference to steps 1002a-1002f, if the computer system determines that the second input is an input of the first type (e.g., a repeat of the refinement gesture provided by the hand of the user in the first input), the computer system deactivates the selection refinement mode in response to detecting the second input. In some embodiments, while the selection refinement mode is active, the computer system detects the repeat of the refinement gesture without first detecting an activation gesture (e.g., which causes the computer system to perform a selection operation, as similarly discussed above with reference to steps 1002a-1002f). Accordingly, as outlined above, in some embodiments, detecting a refinement gesture causes the computer system to activate the selection refinement mode and detecting a repeat of the refinement gesture causes the computer system to deactivate the selection refinement mode. In some embodiments, in response to detecting the second input, in accordance with a determination that the second input is not an input of the first type (e.g., is not a refinement gesture), the computer system forgoes deactivating the selection refinement mode. For example, the interaction point continues to correspond to the second location in the first object, such as the location of the selection refinement user interface object 912a in the virtual object 907 in FIG. 9E. In some embodiments, if the second input is an input of the second type (e.g., an activation gesture), as similarly described above with reference to steps 1002a-1002f, the computer system performs the first operation (e.g., the selection operation) directed to the second location in the first object. Deactivating a selection refinement mode in response to detecting an input of a first type while the selection refinement mode is active reduces the number of inputs needed to deactivate the selection refinement mode and/or enables the selection refinement mode to be deactivated without displaying additional controls, thereby improving user-device interaction.

It should be understood that the particular order in which the operations in method 1000 have been described is merely exemplary and is not intended to indicate that the described order is the only order in which the operations could be performed. One of ordinary skill in the art would recognize various ways to reorder the operations described herein. In some embodiments, aspects/operations of methods 800 and/or 1000 may be interchanged, substituted, and/or added between these methods. For example, the three-dimensional environments of methods 800 and/or 1000, the selection inputs and confirmation gestures in methods 800 and/or 1000, the refinement and activation gestures in methods 800 and/or 1000, and/or the selection operations in methods 800 and/or 1000 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with a display generation component and one or more input devices:
while displaying, via the display generation component, a first object in an environment, detecting, via the one or more input devices, a first input performed by a first portion of a user of the computer system, wherein the first input is associated with an interaction point directed to the first object, and wherein the interaction point corresponds to a location to which a respective input performed by the first portion of the user is directed;
in response to detecting the first input, in accordance with a determination that the first input is an input of a first type and that the interaction point is directed to a first location in the first object when the first input is detected, activating a selection refinement mode in which the interaction point corresponds to the first location in the first object;
while the selection refinement mode is active and the interaction point is directed to the first location in the first object, detecting, via the one or more input devices, movement of the first portion of the user relative to the first object;
in response to detecting the movement of the first portion of the user, associating the interaction point with a second location, different from the first location, in the first object in accordance with the movement of the first portion of the user;
while the selection refinement mode is active and the interaction point is directed to the second location, detecting, via the one or more input devices, a second input performed by the first portion of the user; and
in response to detecting the second input, in accordance with a determination that the second input is an input of a second type, different from the first type, performing a first operation associated with the second location in the first object in accordance with the second input.

2. The method of claim 1, further comprising:
in response to detecting the first input:
in accordance with a determination that the first input is an input of the second type and that the interaction point is directed to the first location in the first object when the first input is detected, performing a second operation associated with the first location in accordance with the first input.

3. The method of claim 1, wherein:
the first portion of the user includes a hand of the user; and
the input of the first type and the input of the second type are performed by a same portion of the hand of the user.

4. The method of claim 3, wherein the same portion of the hand of the user includes at least a first finger and a second finger of the hand of the user.

5. The method of claim 3 wherein:
the input of the first type includes an air gesture in which fingers of the hand of the user are arranged in a first shape; and
the input of the second type includes an air pinch gesture performed by two or more of the fingers of the hand of the user after the fingers of the hand of the user are arranged in the first shape.

6. The method of claim 3, further comprising:
while the selection refinement mode is active and the interaction point is directed to the second location, detecting, via the one or more input devices, an end of the first input before detecting the second input; and
in response to detecting the second input:
in accordance with a determination that the second input is detected within a threshold amount of time of detecting the end of the first input and that the second input is an input of the second type, performing the first operation associated with the second location in the first object in accordance with the second input; and
in accordance with a determination that the second input is not detected within the threshold amount of time of detecting the end of the first input, forgoing performing the first operation associated with the second location in the first object.

7. The method of claim 1, wherein the determination that the second input is an input of the second type is independent of whether the first input is an input of the first type, the method further comprising:
in response to detecting the first input:
in accordance with a determination that the first input is an input of the second type, performing the first operation associated with the first location in accordance with the first input.

8. The method of claim 7, further comprising:
after performing the first operation associated with the second location in accordance with the second input, detecting, via the one or more input devices, a third input performed by the first portion of the user; and
in response to detecting the third input:
in accordance with a determination that the third input is an input of the second type and that the interaction point is directed to a respective location in the first object when the third input is detected, performing a second operation associated with the respective location in accordance with the third input.

9. The method of claim 1, wherein activating the selection refinement mode in which the interaction point corresponds to a respective location in the first object includes displaying, via the display generation component, a selection refinement user interface object at the respective location in the first object.

10. The method of claim 9, wherein, in response to detecting the movement of the first portion of the user, associating the interaction point with the second location in the first object in accordance with the movement of the first portion of the user includes displaying the selection refinement user interface object at the second location, wherein:
in accordance with a determination that the movement of the first portion of the user corresponds to movement of the interaction point beyond a boundary of the first object, the second location is within the boundary of the first object; and
in accordance with a determination that the movement of the first portion of the user corresponds to movement of the interaction point within the boundary of the first object, the second location is within the boundary of the first object.

11. The method of claim 9, further comprising:
while the selection refinement mode is active and the selection refinement user interface object is displayed at the first location in the first object, detecting, via the one or more input devices, a third input performed by the first portion of the user; and
in response to detecting the third input:
in accordance with a determination that the third input is an input of the first type and attention of the user is directed to a third location in a second object in the environment, associating the interaction point with the third location in the second object and displaying, via the display generation component, the selection refinement user interface object at the third location.

12. The method of claim 9, wherein attention of the user is directed to the first location in the first object when the first input is detected, the method further comprising:
while the selection refinement mode is active and the selection refinement user interface object is displayed at the first location in the first object, detecting, via the one or more input devices, the attention of the user directed to a third location in a second object in the environment; and
in response to detecting the attention of the user directed to the third location, associating the interaction point with the third location in the second object and displaying, via the display generation component, the selection refinement user interface object at the third location.

13. The method of claim 1, the method further comprising:
while the interaction point is directed to a respective location in the first object, detecting, via the one or more input devices, movement of attention of the user directed within the first object in the environment;
while detecting the movement of the attention of the user within the first object:
in accordance with a determination that the selection refinement mode is not active when the movement of the attention of the user is detected, moving the interaction point away from the respective location in the first object in accordance with the movement of the attention of the user; and
in accordance with a determination that the selection refinement mode is active when the movement of the attention of the user is detected, maintaining the interaction point directed to the respective location in the first object;
while the selection refinement mode is active and the interaction point is directed to the respective location in the first object, detecting, via the one or more input devices, movement of the first portion of the user relative to the first object; and
in response to detecting the movement of the first portion of the user, moving the interaction point away from the respective location in the first object in accordance with the movement of the first portion of the user.

14. The method of claim 1, wherein:
the first portion of the user includes a hand of the user; and
the input of the first type corresponds to an air gesture in which fingers of the hand are arranged in a first shape.

15. The method of claim 1, wherein:
the first portion of the user includes a hand of the user; and
the input of the first type corresponds to an air gesture in which fingers of the hand are arranged in a first shape, and includes movement of the fingers relative to a palm of the hand after the fingers are arranged in the first shape.

16. The method of claim 15, wherein detecting the fingers of the hand are arranged in the first shape is based on a detected angle between a first finger portion and a second finger portion of the fingers of the hand.

17. The method of claim 15, wherein the movement of the fingers relative to the palm of the hand includes movement of a first finger and a second finger of the hand relative to the palm of the hand.

18. The method of claim 15, wherein the movement of the fingers relative to the palm of the hand is detected within a threshold amount of time of detecting the fingers of the hand are arranged in the first shape.

19. The method of claim 1, wherein:
the first portion of the user includes a hand of the user; and
the input of the first type corresponds to an air gesture that includes movement of a first finger of the hand relative to a second finger of the hand while the first finger of the hand is in contact with the second finger of the hand.

20. The method of claim 19, further comprising:
while the selection refinement mode is active and the interaction point is directed to the first location in the first object, detecting, via the one or more input devices, a third input performed by the hand of the user; and
in response to detecting the third input:
in accordance with a determination that the third input is an input of the first type because the third input corresponds to an air gesture that includes movement of the first finger of the hand relative to the second finger of the hand while the first finger of the hand is in contact with the second finger of the hand, deactivating the selection refinement mode.

21. The method of claim 19, wherein the air gesture includes movement of the first finger in a first direction relative to the second finger of the hand while the first finger of the hand is in contact with the second finger of the hand, the method further comprising:
while the selection refinement mode is active and the interaction point is directed to the first location in the first object, detecting, via the one or more input devices, a third input performed by the hand of the user; and
in response to detecting the third input:
in accordance with a determination that the third input corresponds to an air gesture that includes movement of the first finger in a second direction, within a directional threshold of being opposite to the first direction, relative to the second finger of the hand while the first finger of the hand is in contact with the second finger of the hand, deactivating the selection refinement mode.

22. The method of claim 1, wherein:
the first portion of the user includes a hand of the user; and
the input of the first type corresponds to an air gesture in which a first finger and a second finger of the hand are arranged in a first shape, and a subset of one or more fingers, other than the first finger and the second finger, of the hand are arranged in a second shape, different from the first shape.

23. The method of claim 1, further comprising:
while the selection refinement mode is active and the interaction point is directed to the first location in the first object, detecting, via the one or more input devices, an end of the first input; and
in response to detecting the end of the first input:
deactivating the selection refinement mode in which the interaction point corresponds to the first location in the first object.

24. The method of claim 1, further comprising:
in response to detecting the second input:
in accordance with a determination that the second input is an input of the first type, deactivating the selection refinement mode in which the interaction point corresponds to the second location in the first object.

25. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while displaying, via the display generation component, a first object in an environment, detecting, via the one or more input devices, a first input performed by a first portion of a user of the computer system, wherein the first input is associated with an interaction point directed to the first object, and wherein the interaction point corresponds to a location to which a respective input performed by the first portion of the user is directed;
in response to detecting the first input, in accordance with a determination that the first input is an input of a first type and that the interaction point is directed to a first location in the first object when the first input is detected, activating a selection refinement mode in which the interaction point corresponds to the first location in the first object;
while the selection refinement mode is active and the interaction point is directed to the first location in the first object, detecting, via the one or more input devices, movement of the first portion of the user relative to the first object;
in response to detecting the movement of the first portion of the user, associating the interaction point with a second location, different from the first location, in the first object in accordance with the movement of the first portion of the user;
while the selection refinement mode is active and the interaction point is directed to the second location, detecting, via the one or more input devices, a second input performed by the first portion of the user; and
in response to detecting the second input, in accordance with a determination that the second input is an input of a second type, different from the first type, performing a first operation associated with the second location in the first object in accordance with the second input.

26. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the display generation component, a first object in an environment, detecting, via the one or more input devices, a first input performed by a first portion of a user of the computer system, wherein the first input is associated with an interaction point directed to the first object, and wherein the interaction point corresponds to a location to which a respective input performed by the first portion of the user is directed;
in response to detecting the first input, in accordance with a determination that the first input is an input of a first type and that the interaction point is directed to a first location in the first object when the first input is detected, activating a selection refinement mode in which the interaction point corresponds to the first location in the first object;
while the selection refinement mode is active and the interaction point is directed to the first location in the first object, detecting, via the one or more input devices, movement of the first portion of the user relative to the first object;
in response to detecting the movement of the first portion of the user, associating the interaction point with a second location, different from the first location, in the first object in accordance with the movement of the first portion of the user;
while the selection refinement mode is active and the interaction point is directed to the second location, detecting, via the one or more input devices, a second input performed by the first portion of the user; and
in response to detecting the second input, in accordance with a determination that the second input is an input of a second type, different from the first type, performing a first operation associated with the second location in the first object in accordance with the second input.
